(19) United States
(12) Patent Application Publication
(10) Pub. No.: US 2011/0079427 A1
(43) Pub. Date: Apr. 7, 2011

(54) INSULATED NON-HALOGENATED COVERED ALUMINUM CONDUCTOR AND WIRE HARNESS ASSEMBLY

(76) Inventors: Lakshmikant Suryakant Powale, Maharashtra (IN); Amit Chakrabarti, West Bengal (IN); Vitthal Sawant, Maharashtra (IN)

(21) Appl. No.: 12/574,893

(22) Filed: Oct. 7, 2009

(51) Int. Cl. H02G 3/04; H01B 7/00

(52) U.S. Cl. 174/72 A; 174/120 R; 174/113 R

(57) ABSTRACT

Disclosed herein a covered conductor comprising a conductor and a covering, wherein the covering is disposed over the conductor, wherein the conductor comprises aluminum or an alloy comprising aluminum, wherein the covering comprises a poly(arylene ether) composition, wherein optionally, the covering comprises a poly(arylene ether) composition selected from the group consisting of Noryl resins from SABIC Innovative Plastics, Xyron resins from Asahi Kasei Chemicals Corporation, Iupiace resins from Mitsubishi, Lemalloy resins from Mitsubishi, Polyphenyl Ether resins from Bluestar, Acnor resins from Aquafil Technopolymers, Ashlene resins from Ashley Polymers, Vestoran resins from Evonik Degussa. Further disclosed herein is a wire harness assembly comprising the covered conductor, and an end use equipment comprising the wire harness assembly.

### BACKGROUND OF THE INVENTION

Copper wires or copper wires with tin plating or the like are widely used as electric wires and wire harnesses due to their excellent conductivity, and ease of working in the form of rod and wire. These electric wires and wire harnesses are used in widespread applications, e.g., for vehicle and automobiles, aircrafts, building and construction, transport, consumer electronics and other equipments and devices.

In recent years, total volume of wiring increases with further mounting of number of control circuits and more features on various electrical, electronic devices to achieve better performance, high functionality and miniaturization for automobiles, aircraft, naval ships and submarines, medical diagnostic equipments and so on. Accordingly, advanced vehicles, electrical and electronic equipments became heavier.

Furthermore, the entire length of the wiring to a vehicle increases in an electric vehicle or a hybrid car in which a battery is mounted behind the vehicle in terms of balance of the center of gravity or the like, Therefore, it is also desired to decrease the weight of wiring materials.

In addition, in the light of demand for improvement in fuel consumption for advanced vehicles, weight saving of automotive components is promoted heavily. The demand for weight saving of the covered conductor and wire harness is therefore crucial.

Reduction in weight of the core conducting wire and optimization of thickness of covering materials are essentially required to fulfill the demand for economical, flexible and lightweight coated conductor and wire harness. Above all, this approach will further support the miniaturization mission of advanced vehicles.

For complying with these above requirements, and the scope of recyclability of the conductor, it is therefore desirable to replace commonly used conductor, copper or copper alloy or coated copper or coated copper alloy by other metals to achieve high electrical conductivity to weight ratio at comparatively lower cost. The recyclability is accomplished by lead free soldering in the connector region. Accordingly, aluminum based conductor is considered as a potential substitute for copper based conductor in wire coating for its higher electrical conductivity to weight ratio, as the aluminum is one third times lighter than copper (density of aluminum is 2.70 g/cc; and the density of copper is 8.89 g/cc); and International Annealed Copper Standard (IACS) conductivity is 61% to that of copper on volume basis; and for the scope of lead free soldering for Aluminum based conductor. Aluminum is good in malleability and ductility and can consequently be drawn into wire of different dimensions with relative ease. Further, much lighter means, easier installations, fewer injuries, and pound-for-pound more conductivity.

Aluminum is also less heat sensitive than copper; heat capacity of aluminum 897 J/Kg-K to that of copper 385 J/Kg-K, imparting less thermal shock to the covering materials during continuous service and could assist in enhancement of thermal life of covering materials.

Further different thermoplastic compositions are used as a covering material for the conductors. Poly(vinyl chloride) (PVC) containing resins have long been used commercially as flame retardant coating material in the covered wire and cable industry. However, currently Poly(vinyl chloride) may be rated to use at 105° C., which limits its usage for some of the application where operating temperature is more than 100° C. Insulation covering made of poly(vinyl chloride) needs to be thick in order to achieve desired toughness, and abrasion protection, and other mechanical properties. Also, poly(vinyl chloride) is a halogenated material. There is mounting concern over the environmental impact of halogenated materials, and non-halogenated alternatives are being sought. There is therefore a strong desire, and in some places a legislative mandate, to replace poly(vinyl chloride) with non-halogenated polymer compositions.

Crosslinked polyethylene (XLPE) is another commercial material used for flame retardant wire and cable insulation, and it is the dominant material used for some of the wire and cable applications, such as automotive wire harness. However, crosslinked polyethylene requires high levels of inorganic flame-retardants to achieve the requisite flame retardancy, which results in deterioration of some mechanical properties and additional challenges in processability. Moreover, for crosslinked polyethylene the thinner insulation layer may result in shorter thermal life when aged at oven temperatures between 150° C. and 180° C. This limits their thermal rating, which is essential for wire and cable application. The higher loading of inorganic fillers and poor mechanical and thermal properties results into relatively thick and heavy cable insulation.

Therefore, there is a need for insulation compositions exhibiting an improved balance of chemical resistance, thermal resistance, electrical resistance per unit weight, and electrical resistance per unit volume, while maintaining other required properties.

### BRIEF DESCRIPTION OF THE INVENTION

The disclosure relates to a covered conductor having a metal conductor, preferably aluminum or an alloy comprising aluminum, and a covering made of a thermoplastic or thermosetting resin composition, preferably a poly(arylene ether) composition. A wire harness assembly comprising the covered conductor, and an end-use-equipment comprising the wire harness assembly are also in the scope of this disclosure. More particularly, the present invention relates to a conductor made of aluminum or an alloy comprising aluminum for making covered conductor and wire harness assembly that can provide lighter weight, improved connecting characteristics, superior corrosion resistance while having excellent electrical conductivity to weight ratio and strength.

### BRIEF DESCRIPTION OF THE FIGURES

Further objects and advantages of the invention will be apparent from the following description and appended claims, reference being made to the accompanying drawings forming a part of the specification, wherein like reference characters designate corresponding parts in several views.

FIG. 1 is an exemplary covered conductor having a conductor.

FIG. 2 is an exemplary covered conductor having a plurality of conductors, stranded together.

FIG. 3 is an exemplary covered conductor having a conductor and a plurality of coverings.

FIG. 4 is an exemplary wire harness having set of conductors wrapped in a tape.

FIG. 5 is an exemplary wire harness assembly for automotive vehicle.

As used in the Figures, the following characters note the designated features:
2 & 12—covering
22a—inner covering
22b—outer covering
4 & 14 & 24—conductor
14A-14G—plurality of conductors
3—covered conductors
15—wrapping tape
5—joint-terminal
6—terminal fitting
7—connector housing
8—connectors
10—wire harness assembly

### DETAILED DESCRIPTION OF THE INVENTION

In some embodiments, the conductor comprising aluminum or an alloy comprising aluminum is annealed or strain hardened with or without subsequent heat treatment or solution heat treated with or without strain hardened or intermediate tempered or hard tempered to stabilize the electrical conductivity and mechanical properties.

In some embodiments, the conductor is solid conductor, or round strand or compressed or compact stranded conductor essentially meeting or exceeding the performance requirements set forth by UL 83 (revised in 2008), or UL 44 (revised in 2008), or UL 854 (revised in 2007), or ISO 6722 (as of second edition, 2006-08-01), or ISO 14572 (as of second edition, 2006-11-15), or ASTM B256-02 (revised in 2002), or ASTM B800-05 (revised in 2005), or ASTM B566-04a (revised in 2004), or ASTM B609M-04 (revised in 2004).

In some embodiments, the conductor is solid conductor, or round strand or compressed or compact stranded conductor essentially meeting or exceeding the test method requirements set forth by UL1581 (revised in 2008), or UL 2556 (revised in 2007).

In some embodiments, the conductor may comprise a single conductor, a single strand, a plurality of single conductors, or a plurality of strands or a combination thereof.

In some embodiments, a plurality of single conductor, or a plurality of strands may be bundled, twisted, or braided to form a conductor. The single individual conductor used in making up a stranded conductor are either drawn to the same diameter or to the different diameters and need not made to be the diameter of any AWG or other standard gauge number. Additionally, the conductor may have various shapes such as round, or square, or oblong, or, trapezoidal. The conductor may be any type of conductor used to transmit a signal. Exemplary signals include optical, electrical, and electromagnetic. Suitable electrical conductors include, but are not limited to metals, such as coated conductor comprising aluminum or alloy comprising aluminum, or a claded conductor comprising aluminum or an alloy comprising aluminum. In some embodiments, the coated conductor comprising copper or an alloy comprising copper, or a claded conductor comprising copper or an alloy comprising copper. In some embodiments, the coated conductor comprising stainless steel or an alloy comprising stainless steel, or a claded conductor comprising stainless steel or an alloy comprising stainless steel. In some embodiments, the coated conductor comprising silver or an alloy comprising silver, or a claded conductor comprising silver or an alloy comprising silver. In some embodiments, the coated conductor comprising gold or an alloy comprising gold, or a claded conductor comprising gold or an alloy comprising gold. In some embodiments, the coated conductor comprising platinum or an alloy comprising platinum, or a claded conductor comprising platinum or an alloy comprising platinum.

In one embodiment, a covered conductor comprising aluminum, comprising a single conductor, or a stranded conductor which are formed by stranding single conductors of pure aluminum, wherein the aluminum comprises at least 99.5 percent by weight of aluminum; maximum 0.4 percent by weight of Fe, maximum 0.1 percent by weight of Cu, maximum of 0.1 percent by weight of Si, maximum 0.05 percent by weight of Zn, maximum 0.02 percent by weight of Mn, maximum 0.03 percent by weight of Ga, maximum 0.03 percent by weight of B, maximum 0.02 percent by of V and Ti, maximum 0.03 percent by weight of others. Examples include AA-1000 series aluminum.

In another embodiment, the covered conductor comprising alloy comprising aluminum, comprising a single conductor, or a stranded conductor, which are formed by stranding an alloy comprising aluminum, wherein the aluminum comprising 0.1 to 1.0 percent by weight of Fe, 0.05 to 0.5 percent by weight of Cu, and 0.05 to 0.4 percent by weight of Mg, in which the total amount of Cu and Mg is 0.3 to 0.8 percent by weight, with the balance being aluminum and inevitable impurities. Aluminum-nickel based alloy conductor contains from about 0.45 to about 0.55 weight percent nickel, the remainder aluminum with associated trace elements including no more than 0.15 weight percent iron, no more than 0.001 weight percent magnesium and no more than 0.05 weight percent copper is also in use as conductor. Alloy comprising aluminum shall comply with the requirements of AA-8000 series alloy, section 10 of UL 1581 (revised in 2008).

In another embodiment, the covered conductor comprising aluminum, comprising a single conductor, or a stranded conductor which are formed by stranding a copper claded alloy comprising aluminum, wherein the alloy comprising copper claded aluminum comprising class 10A, class 15A, class 10H and class 15H according to ASTM B566-4a (revised in 2004). Copper cladded aluminum shall comply further with requirements described in section 11 of UL 1581 (revised 2008).

In some embodiments, an other layer comprising at least one member selected from the group consisting of tin, lead, silver, gold, zinc, nickel, poly(arylene ether), polyetherimide, polyimide, polybenzimidazole, epoxy resin, polyurethane resin, phenol formaldehyde resin, urea formaldehyde resin, melamine formaldehyde resin, or one or more of the foregoing materials, is disposed between the covering and the conductor comprising aluminum or an alloy comprising aluminum. In some embodiments, the other layer described herein is disposed over the conductor comprising aluminum or an alloy comprising aluminum, wherein the conductor is in the form of a single conductor, or the stranded conductor described herein. The thickness of the other layer may be in the range of 0.1 micron to 50 micron, wherein the coating of the material to form the other layer is done by dipping, by electro-deposition, or by co-deposition. In some embodiments, wherein the other layer comprises any one of the metals described herein, may be passivated from oxidation by treating the other layer with chromate, molybdate, or phosphate. In some embodiments, wherein the other layer comprises any one of the polymers described herein, may be passivated from oxidation by crosslinking the other layer.

The aluminum conductor as described above, wherein a tensile strength of the aluminum is 75 MPa or more when tempered; an electrical conductivity is 37.8 *10 6 S/m or more; elastic modulus 140 GN/m2 or more; stress fatigue endurance limit 35 MN/m2 or more; thermal conductivity 230 W/m-K at 25 C or more; heat capacity 897 J/Kg-K or less; coefficient of electrical resistivity 0.0040 per degree C. or less, thermal coefficient of expansion 23×10⁻⁶ or less.

The aluminum conductor according to the present invention is made of metal comprising pure aluminum, or an alloy comprising aluminum, or an aluminum compromising coating or coated alloy comprising aluminum to reduce the weight thereof, and is excellent in workability at wire drawing, electrical conductivity, stranding property, bending resistance, flexibility, joint property and heat resistance. In addition, reusing of the aluminum conductor is largely facilitated as compared with wire harness conductors made of copper or the like, and clean reusing is possible without generating substances harmful to the environment. Accordingly, the aluminum conductor is quite favorable in industries and for the environment.

The quantity of Fe to be added in the alloy comprising aluminum is hold in the range from 0.1 to 1.0 percent by weight, because bending resistance of alloy comprising aluminum at a high level required for the electric wire for automobiles, or vehicles cannot be achieved when the content is less than 0.1 percent by weight, while not only electrical conductivity requirement for the conducting wire for automobiles is not attained but also bending resistance reduces due to crystallization of Al—Fe compounds when the Fe content exceeds 1.0 percent by weight. The amount of Fe is preferably from 0.20 to 0.8 percent by weight.

The amount of Cu to be added is defined in the range from 0.05 to 0.5 percent by weight, because bending resistance required for the electric wire for automobiles, or vehicles cannot be attained when the content is less than 0.05 percent by weight, while electrical conductivity becomes inferior when the Cu content exceeds 0.5 percent by weight. The amount of Cu is preferably from 0.1 to 0.4 percent by weight.

The amount of Mg to be added is specified in the range from 0.05 to 0.4 percent by weight, because bending resistance required for the electric wire for automobiles or, vehicles cannot be accomplished when the content is less than 0.05 percent by weight, while electrical conductivity becomes poor when the content exceeds 0.4 percent by weight. The amount of Mg is preferably from 0.1 to 0.35 percent by weight.

The total content of Cu and Mg in the alloy composition is defined in the range between 0.3 and 0.8 percent by weight for improving bending resistance by adding Cu and Mg at the same time. Bending resistance required for the electric wire for automobiles, or vehicles cannot be attained when the total amount is less than 0.3 percent by mass, while electrical conductivity becomes inferior when the amount exceeds 0.8 percent by weight. Accordingly, the total amount of these components is preferably from 0.3 to 0.7 percent by weight. The mass ratio of Mg:Cu is preferably from 0.125:1 to 1.25:1.

The amount of inevitable impurities is preferably as small as possible for retaining electrical conductivity. It is preferable that the amount of Si is 0.10 percent by weight or less, the amount of Mn is 0.02 percent by weight or less, and the total amount of Ti and V is 0.025 percent by weight or less. Zr may be contained in an amount of up to about 0.1 mass %, since heat resistance is improved by allowing Al—Zr series compounds to precipitate.

Electrical conductivity for alloy comprising aluminum is required to be higher, in accordance with higher performance of electronic equipments provided in automobiles, naval ships and submarines, electrical and electronic equipments. Electrical conductivity is preferably 57% IACS or more. The upper limit of electrical conductivity is not particularly limited, but it is generally 66% IACS or less.

When higher flexibility is necessary while maintaining practically sufficient bendability, it is possible to attain these effects by heat-treatment after wire drawing or stranding processing. The heat-treatment may be applied under such a condition that the conductor completes the recrystallization after the heat treatment and is enough for recovering elongation and electrical conductivity of the conductor material. The condition may be at 250° C. or more. The time for heat-treatment is not particularly limited, but it is preferably from 30 minutes to 6 hours.

Herein, when the heat-treatment for recrystallization is carried out, it is possible to improve bendability while retaining the tensile strength, by applying a low temperature annealing after wire drawing. The annealing is preferably carried out at a condition of a temperature from 80° C. to 120° C. for 100 to 120 hours. After an aluminum conductor is annealed, the wire drawing process is applied at room temperature in the processing rate of 90% or more, and aluminum conductor is used as single conductor, or stranded to obtain a stranded conductor. Then, the single conductor or stranded conductor are continuously heated and cooled until the desired conductor is obtained. The processed conductor is then winding up in a pulley.

The aluminum used as single conductor or stranded conductor of an alloy comprising aluminum each having a diameter from 0.0124 to 11.68 mm to give a stranded conductor, and by coating the stranded conductor with a poly(phenylene ether) resin composition, preferably has a tensile strength of 110 MPa or more. The upper limit of the tensile strength is not particularly limited, but it is generally 400 MPa or less. The reason is that, for example, the aluminum is required to have a tensile strength above a prescribed level for preventing joint parts between the aluminum and terminals from being broken, during assembly work of the aluminum to the automobile. A tensile strength of 110 MPa permits workability of the joint parts to be ensured (no breakage after applying vibration in an axial direction at a sweep rate of 98 msec and a frequency from 50 to 100 Hz, for 3 hours). Accordingly, the single conductors of an alloy comprising aluminum to be used are also required to have a tensile strength of at least 110 MPa or more. In this connection, it is known that the resin-coating layer does not substantially contribute the tensile strength of the aluminum conductor.

In some embodiments, flexibility of the aluminum conductor could be improved further by applying a lubricant to at least one aluminum conductor from a plurality of conductors, or a plurality of strands. Although lubricant is applied to at least one aluminum conductor, it spreads over the adjoining conductors, wherein the coefficient of friction of the aluminum conductor with adjoining conductors reduces and flexibility increases. The amount of lubricant in use is maximum 2 percent by weight to that of aluminum conductor. Any industrial grease can be used as lubricant for the above purpose.

Conductors consisting of at least one first conductor and at least one second conductor, wherein said first conductor are constituted by conductor made of at least first type of metal conductor selected from a group of coated conductor comprising aluminum or alloy comprising aluminum, or a claded conductor comprising aluminum or an alloy comprising aluminum or, coated conductor comprising copper or alloy comprising copper, or a claded conductor comprising copper or an alloy comprising copper, or a coated conductor comprising stainless steel or an alloy comprising stainless steel, or a claded conductor comprising stainless steel or an alloy comprising stainless steel, or a coated conductor comprising silver or alloy comprising silver, or a claded conductor comprising silver or an alloy comprising silver, or a coated conductor comprising gold or alloy comprising gold, or a claded conductor comprising gold or an alloy comprising gold, or a coated conductor comprising platinum or alloy comprising platinum, or a claded conductor comprising platinum or an alloy comprising platinum. Said second conductor is constituted by conductor made of at least one second type of metal conductor selected from a group consisting of coated conductor comprising aluminum or alloy comprising aluminum, or a claded conductor comprising aluminum or an alloy comprising aluminum or, coated conductor comprising copper or alloy comprising copper, or a claded conductor comprising copper or an alloy comprising copper, or a coated conductor comprising stainless steel or an alloy comprising stainless steel, or a claded conductor comprising stainless steel or an alloy comprising stainless steel, or a coated conductor comprising silver or alloy comprising silver, or a claded conductor comprising silver or an alloy comprising silver, or a coated conductor comprising gold or alloy comprising gold, or a claded conductor comprising gold or an alloy comprising gold, or a coated conductor comprising platinum or alloy comprising platinum, or a claded conductor comprising platinum or an alloy comprising platinum. Namely, the first type of metal conductor and the second type of metal conductor are twisted to form a twisted wire so that properties of twisted wire are complementary combined to obtain an electrical conductor meeting the standard levels in both conductivity and mechanical property.

The covered conductor comprising aluminum or an alloy comprising aluminum can be selected from the group consisting of AA-1000 series, AA-2000 series, AA-3000 series, AA-4000 series, AA-5000 series, AA-6000 series, AA-7000 series, and AA-8000 series, preferably from AA-1000 series, AA-6000 series, and AA-8000 series, more preferably from AA-8000 series.

In some embodiments, the covered conductor comprising aluminum is sourced from the suppliers selected from Jiansu Shentian Industrial Co. ltd., or Chonghong Industries Ltd., or Linan Dagu Cable Manufacturing Ltd., or Lee Cheong Metal Co. Ltd., or Yueqing City Ouwei electric company Ltd., or Hangzhou Kinglido Industrial company Ltd., or SURAL, or Hangzhou Feixiang Electric Company Ltd., or Shenzhen Jacund Industrial Company Ltd., or Anbao (Qinhuagdao) Wire and Mesh Company Ltd., or Howar Equipment Incorporation.

Covering disposed over the conductor in the present invention comprises poly(phenylene ether) composition. The thickness of the covering is not particularly limited, larger thickness is not preferable in view of the industrial productivity. Although it depends on the diameter of the stranded conductor, the thickness of the covering is preferably about from 0.01 mm to 8.0 mm.

The cross-sectional area of the conductor and thickness of the insulating cover may vary and is typically determined by the end use and design of the covered conductor. In some embodiments the covered conductor is a covered conductor and the covered conductor can be used as electrical conductor without limitation, including, for example, for harness wire for automobiles, wire for household electrical appliances, wire for electric power, wire for instruments, wire for information communication, wire for electric cars, as well as ships, airplanes, and the like. In some embodiments the covered conductor is an optical cable and can be used in interior applications (inside a building), exterior applications (outside a building) or both interior and exterior applications. Exemplary applications include data transmission networks and voice transmission networks such as telephone networks and local area networks (LAN).

The covered conductor may meet or exceed the current standards set forth in ISO 6722 (as of second edition, 2006-08-01), such as flame retardance, heat aging, and scrape abrasion, making the covered conductor suitable for use in road vehicles. In particular the covered conductor could meet or exceed the heat aging standards for Classes A, B or C as set forth in ISO 6722 (as of second edition, 2006-08-01).

Exemplary stripping forces for various conductor sizes may be different from the current ISO 6722 (as of second edition, 2006-08-01).

Described a covered conductor comprising an aluminum conductor and a covering disposed over the conductor. The covering comprises a thermoplastic composition comprising a poly(arylene ether) having an intrinsic viscosity greater than 0.25 dl/g as measured in chloroform at 25° C. The covered conductor essentially meets the performance requirement of ISO 6722 (as of second edition, 2006-08-01), wherein the covering is disposed over the conductor, wherein the conductor has a cross-section that meets at least one of following: (i) American Wire Gauge (AWG) of AWG 56 to AWG 26, (ii) a nominal cross-section area of 0.000122 to 0.128 mm2 (corresponding to AWG 56 to AWG 26 according to ASTM B256-02); (iii) a nominal diameter from 0.0124 to 0.404 mm (corresponding to AWG 56 to AWG 26 according to UL 1581, 4th edition, Table 20.1). The covering of the covered conductor has a thickness of 0.010 to 0.85 mm.

In some embodiments, the conductor may have a cross-section that has an American Wire Gauge (AWG) number from AWG 56 to AWG 26. Within this range, the conductor may have a cross-section of AWG number greater than or equal to AWG 30, or, more specifically greater than or equal to AWG 35. Also within this range, the conductor may have a cross-section of AWG number less than or equal to AWG 50, or, more specifically, less than or equal to AWG 45.

In some embodiments, the conductor may have a nominal cross-section area of 0.000122 to 0.128 mm2 (corresponding to AWG 56 to AWG 26 according to ASTM B256-02). Within this range, the conductor may have a nominal cross-section greater than or equal to area of 0.000497 mm2 (AWG 50 according to ASTM B256-02), or, more specifically greater than or equal to 0.00487 mm2 (AWG 40, according to ASTM B256-02). Also within this range, the conductor may have a nominal cross-section area less than or equal to 0.0507 mm2 (AWG 30, according to ASTM B256-02), or, more specifically, less than or equal 0.0159 mm2 (AWG 35, according to ASTM B256-02).

In some embodiments, the conductor may have a nominal diameter of 0.0124 to 0.404 mm (corresponding to AWG 56 to AWG 26, according to UL 1581, 4th edition, Table 20.1). Within this range, the conductor may have a nominal diameter greater than or equal to area of 0.0251 mm (AWG 50 according to UL 1581, 4th edition, Table 20.1), or, more specifically greater than or equal to 0.0447 mm (AWG 40, according to UL 1581, 4th edition, Table 20.1). Also within this range, the conductor may have a nominal diameter less than or equal to 0.254 mm (AWG 30 according to UL 1581, 4th edition, Table 20.1), or, more specifically, less than or equal 0.142 mm (AWG 35, according to UL 1581, 4th edition, Table 20.1). The maximum and minimum range for the nominal diameter according to UL 1581, 4th edition, Table 20.1 would also apply herein.

The covering of the covered conductor in any embodiment may have a thickness of 0.010 to 0.85 mm. Within this range, the thickness of the covering of the covered conductor may be greater than or equal to 0.100 mm, or, more specifically, greater than or equal to 0.250 mm. Also within this range, the thickness of the coating of the covered conductor may be less than or equal to 0.60 mm, or, more specifically, less than or equal to 0.50 mm.

Described a covered conductor comprising aluminum and a covering disposed over aluminum. The covering comprises a thermoplastic composition comprising a poly(arylene ether) having an intrinsic viscosity greater than 0.25 dl/g as measured in chloroform at 25° C. The covered conductor essentially meets the performance requirement of ISO 6722 (as of second edition 2006-08-01), wherein the covering is disposed over the conductor, wherein the conductor has a cross-section that meets at least one of following: (i) American Wire Gauge (AWG) of AWG 24 to AWG 5, (ii) a cross-section area of 0.205 to 16.8 mm2 (corresponding to AWG 24 to AWG 5 according to ASTM B256-02); (iii) a nominal diameter of 0.511 to 4.62 mm (corresponding to AWG 24 to AWG 5 according to UL 1581, 4th edition, Table 20.1). The covering of the covered conductor has a thickness of 0.25 to 8 mm.

In some embodiments, the conductor may have a cross-section that has an American Wire Gauge (AWG) number from AWG 24 to AWG 5. Within this range, the conductor may have a cross-section of AWG number greater than or equal to AWG 10, or, more specifically greater than or equal to AWG 12. Also within this range, the conductor may have a cross-section of AWG number less than or equal to AWG 20, or, more specifically, less than or equal to AWG 15.

In some embodiments, the conductor may have a nominal cross-section area of 0.205 to 16.8 mm2 (corresponding to AWG 24 to AWG 5 according to ASTM B256-02). Within this range, the conductor may have a nominal cross-section greater than or equal to area of 0.52 mm2 (AWG 20 according to ASTM B256-02), or, more specifically greater than or equal to 1.65 mm2 (AWG 15, according to ASTM B256-02). Also within this range, the conductor may have a nominal cross-section area less than or equal to 5.26 mm2 (AWG 10, according to ASTM B256-02), or, more specifically, less than or equal 3.31 mm2 (AWG 12, according to ASTM B256-02).

In some embodiments, the conductor may have a nominal diameter of 0.511 to 4.62 mm (corresponding to AWG 24 to AWG 5, according to UL 1581, 4th edition, Table 20.1). Within this range, the conductor may have a nominal diameter greater than or equal to area of 0.813 mm (AWG 20 according to UL 1581, 4th edition, Table 20.1), or, more specifically greater than or equal to 1.45 mm (AWG 15, according to UL 1581, 4th edition, Table 20.1). Also within this range, the conductor may have a nominal diameter less than or equal to 2.588 mm (AWG 10 according to UL 1581, 4th edition, Table 20.1), or, more specifically, less than or equal 2.05 mm (AWG 12, according to UL 1581, 4th edition, Table 20.1). The maximum and minimum range for the nominal diameter according to UL 1581, 4th edition, Table 20.1 may also apply herein.

The covering of the covered conductor in any embodiment may have a thickness of 0.25 to 8 mm. Within this range, the thickness of the covering of the covered conductor may be greater than or equal to 0.5 mm, or, more specifically, greater than or equal to 1.5 mm. Also within this range, the thickness of the coating of the covered conductor may be less than or equal to 5 mm, or, more specifically, less than or equal to 3 mm.

In some embodiments, the covered conductor essentially meets the performance requirement of ISO 6722 (as of second edition, 2006-08-01). The current version of ISO 6722, section 5.2 specifies copper conductors with size at least 0.13 mm2 and a coating thickness at least 0.85 mm. Therefore, the term “essentially meets the performance requirement of ISO 6722 (as of second edition, 2006-08-01)” means that even though the conductor comprises aluminum and has a cross-section that meets as least one of following: (i) American Wire Gauge (AWG) from AWG 56 to AWG 26 (ii) a cross-section area from 0.000122 to 0.128 mm2 (corresponding to AWG 56 to AWG 26 according to ASTM B256-02); (iii) a nominal diameter from 0.0124 to 0.404 mm (corresponding to AWG 56 to AWG 26 according to UL 1581, 4th edition, Table 20.1) and/or the covering has a thickness of 0.010 to 0.85 mm, both are not explicitly defined in the current ISO 6722 (as of second edition, 2006-08-01) specification, the principles of ISO 6722 test (including the test items) will be met.

As suggested above, the poly(phenylene ether) composition useful in covered conductor applications, particularly covered conductors such as metal conductors, employed in environments where they may be exposed to chemicals, such as gasoline, diesel fuel, antifreeze, and the like, that can result in degradation. In another aspect the composition has desirable adhesion to the aluminum conductor. Adhesion must be sufficient to maintain the integrity of the wire under normal use but not so strong as to prevent intentional stripping. Typically a force of about 2 to 100 Newtons, depending on the size of the conductor and thickness of the thermoplastic coating, is employed to strip the thermoplastic coating from a conductor so it is desirable that the covered conductor has an adhesion strength between the conductive and the poly(phenylene ether) composition that is less than or equal to the stripping force typically employed for the conductor size and poly(phenylene ether) covering thickness. Exemplary stripping forces for various conductor sizes may be different from the current ISO 6722 (as of second edition, 2006-08-01).

In some embodiments, the covered conductor essentially meets the performance requirement of ISO 6722 (as of second edition, 2006-08-01). The current version of ISO 6722, section 5.2 specifies copper conductors with size at least 0.13 mm2 and a coating thickness at least 0.85 mm. Therefore, the term “essentially meets the performance requirement of ISO 6722” means that even though the conductor comprises aluminum and has a cross-section that meets as least one of following: (i) American Wire Gauge (AWG) from AWG 56 to AWG 26, (ii) a cross-section area from 0.000122 to 0.128 mm2 (corresponding to AWG 56 to AWG 26 according to ASTM B256-02); (iii) a nominal diameter from 0.0124 to 0.404 mm (corresponding to AWG 56 to AWG 26 according to UL 1581, 4th edition, Table 20.1) and/or the covering has a thickness of 0.010 to 0.85 mm, both are not explicitly defined in the current ISO 6722 (as of second edition, 2006-08-01) specification, the principles of ISO 6722 test (including the test items) will be met.

In some embodiments, the covered conductor comprising aluminum may have a conductor having a cross-section that meets at least one of following: (i) American Wire Gauge (AWG) from AWG 56 to AWG 26, (ii) a cross-section area from 0.000122 to 0.128 mm2 (corresponding to AWG 56 to AWG 26 according to ASTM B256-02); (iii) a nominal diameter from 0.0124 to 0.404 mm (corresponding to AWG 56 to AWG 26 according to UL 1581, 4th edition, Table 20.1), and/or the covering has a thickness of 0.010 to 0.85 mm comprising the thermoplastic composition described herein. The covered conductor may meet or exceed the current standards set forth in ISO 6722 (as of second edition, 2006-08-01), such as flame retardance, heat aging, and scrape abrasion, making the covered conductor suitable for use in road vehicles. In particular the covered conductor could meet or exceed the heat aging standards for Classes A, B or C as set forth in ISO 6722 (as of second edition, 2006-08-01).

In some embodiments, the covered conductor comprising aluminum may have a cross-section that meets as least one of following: (i) American Wire Gauge (AWG) from AWG 56 to AWG 26, (ii) a cross-section area from 0.000122 to 0.128 mm2 (corresponding to AWG 56 to AWG 26 according to ASTM B256-02); (iii) a nominal diameter from 0.0124 to 0.404 mm (corresponding to AWG 56 to AWG 26 according to UL 1581, 4th edition, Table 20.1), and/or the covering has a thickness of 0.010 to 0.85 mm comprising the thermoplastic composition described herein. The covered aluminum has a scrape abrasion resistance of greater than 10 cycles, as determined by the scrape abrasion specification of ISO 6722 (as of second edition, 2006-08-01) using a 7 Newton load, a needle having a 0.45 millimeter diameters, and covered aluminum having a cross-section that meets as least one of following: (i) American Wire Gauge (AWG) from AWG 56 to AWG 26, (ii) a cross-section area from 0.000122 to 0.128 mm2 (corresponding to AWG 56 to AWG 26 according to ASTM B256-02); (iii) a nominal diameter from 0.0124 to 0.404 mm (corresponding to AWG 56 to AWG 26 according to UL 1581, 4th edition, Table 20.1) and/or a covering having a thickness of 0.010 to 0.85 mm.

In some embodiments, the covered aluminum conductor meets the performance requirement of ISO 6722 (as of second edition, 2006-08-01), wherein the conductor has a cross-section that meets as least one of following: (i) American Wire Gauge (AWG) from AWG 56 to AWG 26, (ii) a cross-section area from 0.000122 to 0.128 mm2 (corresponding to AWG 56 to AWG 26 according to ASTM B256-02); (iii) a nominal diameter from 0.0124 to 0.404 mm (corresponding to AWG 56 to AWG 26 according to UL 1581, 4th edition, Table 20.1), the covering has a thickness from about 0.010 to about 0.85 mm and further wherein for a total length of 13,500 to 15,500 meters of covered conductor there are less than or equal to six individual lengths of covered conductor and each individual length of wire has a length greater than or equal to 150 meters.

In some embodiments, the covered aluminum conductor may have a cross-section that meets at least one of following: (i) American Wire Gauge (AWG) from AWG 56 to AWG 26, (ii) a cross-section area from 0.000122 to 0.128 mm2 (corresponding to AWG 56 to AWG 26 according to ASTM B256-02); (iii) a nominal diameter from 0.0124 to 0.404 mm (corresponding to AWG 56 to AWG 26 according to UL 1581, 4th edition, Table 20.1), and/or the covering has a thickness of 0.010 to 0.85 mm comprising the thermoplastic composition described herein. The covered aluminum conductor can have a long-term chemical resistance to gasoline greater than or equal to 100 days. The long term chemical resistance to gasoline is tested according a method comprising: a) testing a coated conductor for chemical resistance according to ISO 6722 (as of second edition, 2006-08-01) using ISO 1817 liquid C; b) aging the coated conductor at 23° C. and 50% relative humidity with no externally applied stress; and c) inspecting the coated conductor daily for a crack, wherein a) through c) are performed in the order given. The detailed procedure of long-term chemical resistance test can found in U.S. Patent Publication No. 2006-0278425 that is incorporated herein by reference by its entirety.

In some embodiments, the covered conductor essentially meets the performance requirement of ISO 6722 (as of second edition, 2006-08-01). The current version of ISO 6722, section 5.2 specifies copper conductors with size at least 0.13 mm2 and a coating thickness at least 0.85 mm. Therefore, the term “essentially meets the performance requirement of ISO 6722 (as of second edition, 2006-08-01) means that even though the conductor comprises aluminum and has a cross-section that meets as least one of following: (i) American Wire Gauge (AWG) from AWG 24 to AWG 5 (ii) a cross-section area from 0.20 to 16.8 mm2 (corresponding to AWG 24 to AWG 5 according to ASTM B256-02); (iii) a nominal diameter from 0.51 to 4.62 mm (corresponding to AWG 24 to AWG 5 according to UL 1581, 4th edition, Table 20.1) and/or the covering has a thickness of 0.25 to 8 mm, both are not explicitly defined in the current ISO 6722 specification (as of second edition, 2006-08-01), the principles of ISO 6722 test (including the test items) will be met.

As suggested above, the tc poly(arylene ether) composition useful in covered conductor applications, particularly covered conductors such as electrical wires, employed in environments where they may be exposed to chemicals, such as gasoline, diesel fuel, antifreeze, and the like, that can result in degradation. In another aspect the composition has desirable adhesion to the aluminum conductor. Adhesion must be sufficient to maintain the integrity of the wire under normal use but not so strong as to prevent intentional stripping. Typically a force of about 2 to 100 Newtons, depending on the size of the conductor core and thickness of the thermoplastic coating, is employed to strip the thermoplastic coating from a wire so it is desirable that the covered conductor has an adhesion strength between the conductive core and the poly(phenylene ether) composition that is less than or equal to the stripping force typically employed for the conductive core size and thermoplastic coating thickness. Exemplary stripping forces for various conductor sizes may be different from the current ISO 6722 (as of second edition 2006-08-01).

In some embodiments, the covered aluminum may have a cross-section that meets at least one of following: (i) American Wire Gauge (AWG) of AWG 24 to AWG 5, (ii) a cross-section area of 0.20 to 16.8 mm2 (corresponding to AWG 24 to AWG 5 according to ASTM B256-02); (iii) a nominal diameter from 0.51 to 4.62 mm (corresponding to AWG 24 to AWG 5 according to UL 1581, 4th edition, Table 20.1) and/or the covering of the covered conductor has a thickness of 0.25 to 8 mm. The covered conductor may meet or exceed the current standards set forth in ISO 6722 (as of second edition, 2006-08-01) such as flame retardance, heat aging, and scrape abrasion, making the covered conductor suitable for use in road vehicles. In particular the covered conductor could meet or exceed the heat aging standards for Classes A, B, or C as set forth in ISO 6722 (as of second edition, 2006-08-01).

In some embodiments, the covered aluminum has a scrape abrasion resistance of greater than 10 cycles, as determined by the scrape abrasion specification of ISO 6722 (as of second edition, 2006-08-01) using a 7 Newton load, a needle having a 0.45 millimeter diameters, and covered conductor having a cross-section that meets as least one of following: (i) American Wire Gauge (AWG) of AWG 24 to AWG 5, (ii) a cross-section area of 0.20 to 16.8 mm2 (corresponding to AWG 24 to AWG 5 according to ASTM B256-02); (iii) a nominal diameter from 0.51 to 4.62 mm (corresponding to AWG 24 to AWG 5 according to UL 1581, 4th edition, Table 20.1) and/or the covering of the covered conductor has a thickness of 0.25 to 8 mm.

In some embodiments, the covered aluminum has a cross-section that meets as least one of following: (i) American Wire Gauge (AWG) of AWG 24 to AWG 5, (ii) a cross-section area of 0.20 to 16.8 mm2 (corresponding to AWG 24 to AWG 5 according to ASTM B256-02); (iii) a nominal diameter from 0.51 to 4.62 mm (corresponding to AWG 24 to AWG 5 according to UL 1581, 4th edition, Table 20.1) and/or the covering of the covered conductor has a thickness of 0.25 to 8 mm and wherein the thermoplastic composition has a tensile elongation at break greater than 30% as determined by ASTM D638-03 using a Type I specimen and a speed of 50 millimeters per minute, and a flexural modulus less than 1000 Megapascals (MPa) as determined by ASTM D790-03 using a speed of 1.27 millimeters per minute. The details of this performance and test method can be found in U.S. Pat. No. 7,084,347 that is incorporated by reference by its entirety.

In some embodiments, the covered aluminum meets the performance requirement of ISO 6722 (as of second edition, 2006-08-01), wherein the conductor has a cross-section that meets as least one of following: (i) American Wire Gauge (AWG) of AWG 24 to AWG 5, (ii) a cross-section area of 0.20 to 16.8 mm2 (corresponding to AWG 24 to AWG 5 according to ASTM B256-02); (iii) a nominal diameter from 0.51 to 4.62 mm (corresponding to AWG 24 to AWG 5 according to UL 1581, 4th edition, Table 20.1) and/or the covering of the covered conductor has a thickness of 0.25 to 8 mm and further wherein for a total length of 13,500 to 15,500 meters of covered conductor there are less than or equal to six individual lengths of covered conductor and each individual length of wire has a length greater than or equal to 150 meters.

In some embodiments, the covered aluminum meets the performance requirement of ISO 6722 (as of second edition, 2006-08-01), the conductor a cross-section that meets as least one of following: (i) American Wire Gauge (AWG) of AWG 24 to AWG 5, (ii) a cross-section area of 0.20 to 16.8 mm2 (corresponding to AWG 24 to AWG 5 according to ASTM B256-02); (iii) a nominal diameter from 0.51 to 4.62 mm (corresponding to AWG 24 to AWG 5 according to UL 1581, 4th edition, Table 20.1) and/or the covering of the covered conductor has a thickness of 0.25 to 8 mm. The coated conductor may have a long-term chemical resistance to gasoline greater than or equal to 100 days. The long term chemical resistance to gasoline is tested according a method comprising: a) testing a coated conductor for chemical resistance according to ISO 6722 (as of second edition, 2006-08-01), using ISO 1817 liquid C; b) aging the coated conductor at 23° C. and 50% relative humidity with no externally applied stress; and c) inspecting the coated conductor daily for a crack, wherein a) through c) are performed in the order given. The detailed procedure of long-term chemical resistance test can found in U.S. Patent Publication No. 2006-0278425 that is incorporated herein by reference by its entirety.

Disclosed herein a covered conductor comprising a conductor and a covering disposed over the conductor. The covering comprises a thermoplastic composition comprising a poly(arylene ether) having an intrinsic viscosity greater than 0.25 dl/g as measured in chloroform at 25° C. The conductor can be metal, such as coated conductor comprising aluminum or an alloy comprising aluminum, or a claded conductor comprising aluminum or an alloy comprising aluminum or coated conductor comprising copper or alloy comprising copper, or a claded conductor comprising copper or an alloy comprising copper, or a coated conductor comprising stainless steel or an alloy comprising stainless steel, or a claded conductor comprising stainless steel or an alloy comprising stainless steel, or a coated conductor comprising silver or alloy comprising silver, or a claded conductor comprising silver or an alloy comprising silver, or a coated conductor comprising gold or alloy comprising gold, or a claded conductor comprising gold or an alloy comprising gold, or a coated conductor comprising platinum or alloy comprising platinum, or a claded conductor comprising platinum or an alloy comprising platinum. The conductor can be a single strand or a bundle of several strands.

In some embodiments, the conductor comprises plurality of strands. In this case, the cross section area is defined as an equivalent to a summation of total cross section area of all strands.

Disclosed herein a covered conductor comprising aluminum and a covering disposed over the conductor. The covering comprises a thermoplastic composition comprising a poly(arylene ether) having an intrinsic viscosity greater than 0.25 dl/g as measured in chloroform at 25° C. The covered conductor essentially meets the performance requirement of ISO 6722, wherein the covering is disposed over the conductor, wherein the conductor has a cross-section that meets at least one of following: (i) AWG 56 to AWG 4/0, (please check this) (ii) a cross-sectional area of 0.000122 to 107.2 mm2 (corresponding to AWG 56 to AWG 4/0); (iii) a nominal diameter from 0.0124 to 11.68 mm (corresponding to AWG 56 to AWG 4/0 according to UL 1581, 4th. edition, table 20.1. The maximum and minimum range for the nominal diameter according to UL 1581, 4th edition, Table 20.1 would also apply herein. The covering of the covered conductor has a thickness of 0.01 to 8.0 mm.

Described herein a covered conductor comprising aluminum and a covering disposed over the conductor. The covering comprises a thermoplastic composition comprising a poly(arylene ether) having an intrinsic viscosity greater than 0.25 dl/g as measured in chloroform at 25° C. The covered conductor essentially meets the performance requirement of UL1581 (revised in 2008), or ISO 6722 (as of second edition, 2006-08-01), wherein covered conductor essentially the covering is disposed over the round compact stranded conductor, wherein the round compact stranded conductor has a cross-section that meets at least one of the following: (i) AWG 12 to AWG 1000 Kcmil; (ii) a nominal diameter from 2.16 to 26.92 mm (corresponding to AWG 12 to AWG 1000 Kcmil according to UL 1581, 4th. edition, table 20.2. The maximum and minimum range for the nominal diameter according to UL 1581, 4th edition, Table 20.2 would also apply herein. The covering of the covered conductor has a thickness of 0.01 to 8.0 mm. A compact-stranded conductor consisting of a central core (one or more strands) surrounded by one or more layers of helically laid strands.

Disclosed herein a covered conductor comprising aluminum and a covering disposed over the conductor. The covering comprises a thermoplastic composition comprising a poly(arylene ether) having an intrinsic viscosity greater than 0.25 dl/g as measured in chloroform at 25° C. The covered conductor essentially meets the performance requirement of UL1581, wherein covered conductor essentially the covering is disposed over the round compressed concentric-lay-stranded ASTM Classes B, C, and D aluminum, uncoated copper, and coated copper conductors that meets at least one of the following (i) AWG 14 to AWG 2000 Kcmil; (ii) a nominal diameter from 1.80 to 40.2 mm (corresponding to AWG 14 to AWG 2000 Kcmil according to UL 1581, 4th. edition, table 20.3). Aluminum is in the use of AWG 12 to AWG 2000 Kcmil, not in the AWG 14 and AWG 13 sizes. The maximum and minimum range for the nominal diameter according to UL 1581, 4th edition, Table 20.3 would also apply herein. The covering of the covered conductor has a thickness of 0.01 to 8.0 mm. The individual wires of a concentric-lay-stranded conductor are not required to be all of the same diameter.

Described herein a covered conductor comprising aluminum and a covering disposed over the conductor. The covering comprises a thermoplastic composition comprising a poly(arylene ether) having an intrinsic viscosity greater than 0.25 dl/g as measured in chloroform at 25° C. The covered conductor essentially meets the performance requirement of UL1581 (revised in 2008), wherein covered conductor essentially the covering is disposed over the round compressed concentric-unilay-stranded ASTM Class B aluminum, uncoated copper, and coated copper conductors that meets at least one of the following: (i) AWG 1 to AWG 2000 Kcmil; (ii) a nominal diameter from 7.95 to 38.94 mm (corresponding to AWG 1 to AWG 2000 Kcmil according to UL 1581, 4th. edition, table 20.3.1. The maximum and minimum range for the nominal diameter according to UL 1581, 4th edition, Table 20.3.1 would also apply herein. The covering of the covered conductor has a thickness of 0.01 to 8.0 mm.

Since aluminum of the present invention is light weight and excellent in bendability and flexibility with excellent compatibility to for use in moving portions such as driving parts, it is suitable for use in building and constructions, naval ships and submarines, aircraft, electrical and electronic equipments and devices and more particularly in automobiles, in the form of coated wire or wire harnesses. In particular, the aluminum conducting wire of the present invention is suitable as the automobile wire harness made for reduction of weight as much as possible in terms of improvement of performance of the automobile.

The present invention also discloses poly(arylene ether) compositions that provide an improved balance of mechanical properties, chemical resistance, scratch resistance, electrical resistance, high heat performance, and processability. The present poly(arylene ether) compositions are prepared without chlorinated or brominated materials, and can, optionally, be free of all halogens. They are therefore environmental friendly, and thus superior to poly(vinyl chloride). The present poly(arylene ether) compositions can achieve requisite flame retardancy needed for various wire and cable applications without using large quantities of inorganic flame-retardants. This means that wire and cable insulation made from poly(arylene ether) compositions is thinner and lighter than crosslinked polyethylene. In another aspect the poly(arylene ether) compositions have desirable adhesion to the metal conductor, specifically the conductor comprising aluminum or an alloy comprising aluminum.

Poly(arylene ether) resin is a type of plastic known for its excellent water resistance, dimensional stability, and inherent flame retardancy. Properties such as strength, stiffness, chemical resistance, and heat resistance can be tailored by blending it with various other plastics in order to meet the requirements of a wide variety of consumer products, for example, plumbing fixtures, electrical boxes, automotive parts, and insulation for wire and cable.

The poly(arylene ether) compositions used for the covering as described herein comprise poly(arylene ether). The poly(arylene ether) compositions disclosed herein are compatibilized polymeric compositions comprising poly(arylene ether) and another polymer comprising a crystalline polymer, a semi-crystalline polymer, an amorphous polymer, or a mixture thereof. The poly(arylene ether) and the other polymer are essentially not identical. The poly(arylene ether) compositions, optionally, further comprise a compatibilizer, a flame retardant, or a combination of a compatibilizer and a flame retardant.

Examples of the other polymer that can be used in the poly(arylene ether) compositions include polyolefins, polystyrenes, polyesters, polyamides, polyphenylene sulfides, polyarylene sulfides, polyarylsulfones, polyethersulfones, polysulfones, polyether etherketones, polyetherketones, polyether ketone ketones, polyimides, polyetherimides, polyamideimides, polyarylates, polycarbonates, polyacetals, polyacrylics, polyarylates, polytetrafluoroethylenes, polybenzoxazoles, polyphthalides, polyanhydrides, polyvinyl ethers, polyvinyl thioethers, polyvinyl alcohols, polyvinyl ketones, polyvinyl halides, polyvinyl chlorides, polyvinyl nitriles, polyvinyl esters, polysulfonates, polysulfides, polythioesters, polysulfonamides, polyureas, polyphosphazenes, polysilazanes, polyethylene terephthalate, polybutylene terephthalate, polyurethane, polytetrafluoroethylene, fluorinated ethylene propylene, perfluoroalkoxyethylene, polychlorotrifluoroethylene, polyvinylidene fluoride, or the like, or a combination comprising at least one of the foregoing polymers.

The intrinsic viscosity of the poly(arylene ether) and the melt flow index of the polyolefin can have an impact on the morphology of the composition. In some embodiments, the poly(arylene ether) or combination of poly(arylene ether)s has an intrinsic viscosity greater than 0.3 dl/g as measured in chloroform at 25° C. and the polyolefin has a melt flow rate of 0.8 to 15 grams per ten minutes when determined according to ASTM D1238. When the poly(arylene ether) or combination of poly(arylene ethers) has an intrinsic viscosity less than 0.25 dl/g, the composition can demonstrate decreased heat aging.

As used herein, a “poly(arylene ether)” comprises a plurality of structural units of the formula (I):

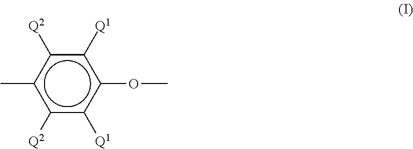

wherein for each structural unit, each Q¹ and Q² is independently hydrogen, halogen, primary or secondary lower alkyl (e.g., an alkyl containing 1 to about 7 carbon atoms), phenyl, haloalkyl, aminoalkyl, alkenylalkyl, alkynylalkyl, hydrocarbonoxy, aryl and halohydrocarbonoxy wherein at least two carbon atoms separate the halogen and oxygen atoms. In some embodiments, each Q¹ is independently alkyl or phenyl, for example, C₁₋₄ alkyl, and each Q² is independently hydrogen or methyl. The poly(arylene ether) may comprise molecules having aminoalkyl-containing end group(s), typically located in an ortho position to the hydroxy group. Also frequently present are tetramethyl diphenylquinone (TMDQ) end groups, typically obtained from reaction mixtures in which tetramethyl diphenylquinone by-product is present.

The poly(arylene ether) may be in the form of a homopolymer; a copolymer; a graft copolymer; an ionomer; or a block copolymer; as well as combinations comprising at least one of the foregoing. Poly(arylene ether) includes polyphenylene ether comprising 2,6-dimethyl-1,4-phenylene ether units optionally in combination with 2,3,6-trimethyl-1,4-phenylene ether units.

The poly(arylene ether) may be prepared by the oxidative coupling of monohydroxyaromatic compound(s) such as 2,6-xylenol and/or 2,3,6-trimethylphenol. Catalyst systems are generally employed for such coupling; they can contain heavy metal compound(s) such as a copper, manganese or cobalt compound, usually in combination with various other materials such as a secondary amine, tertiary amine, halide or combination of two or more of the foregoing.

In some embodiments, the poly(arylene ether) comprises a capped poly(arylene ether). The terminal hydroxy groups may be capped with a capping agent via an acylation reaction, for example. The capping agent chosen is desirably one that results in a less reactive poly(arylene ether) thereby reducing or preventing crosslinking of the polymer chains and the formation of gels or black specks during processing at elevated temperatures. Suitable capping agents include, for example, esters of salicylic acid, anthranilic acid, or a substituted derivative thereof, and the like; esters of salicylic acid, and especially salicylic carbonate and linear polysalicylates, are preferred. As used herein, the term “ester of salicylic acid” includes compounds in which the carboxy group, the hydroxy group, or both have been esterified. Suitable salicylates include, for example, aryl salicylates such as phenyl salicylate, acetylsalicylic acid, salicylic carbonate, and polysalicylates, including both linear polysalicylates and cyclic compounds such as disalicylide and trisalicylide. The preferred capping agents are salicylic carbonate and the polysalicylates, especially linear polysalicylates. When capped, the poly(arylene ether) may be capped to any desirable extent up to 80 percent, more specifically up to about 90 percent, and even more specifically up to 100 percent of the hydroxy groups are capped. Suitable capped poly(arylene ether) and their preparation are described in U.S. Pat. Nos. 4,760,118 to White et al. and 6,306,978 to Braat et al.

Capping poly(arylene ether) with polysalicylate is also believed to reduce the amount of aminoalkyl terminated groups present in the poly(arylene ether) chain. The aminoalkyl groups are the result of oxidative coupling reactions that employ amines in the process to produce the poly(arylene ether). The aminoalkyl group, ortho to the terminal hydroxy group of the poly(arylene ether), can be susceptible to decomposition at high temperatures. The decomposition is believed to result in the regeneration of primary or secondary amine and the production of a quinone methide end group, which may in turn generate a 2,6-dialkyl-1-hydroxyphenyl end group. Capping of poly(arylene ether) containing aminoalkyl groups with polysalicylate is believed to remove such amino groups to result in a capped terminal hydroxy group of the polymer chain and the formation of 2-hydroxy-N,N-alkylbenzamine(salicylamide). The removal of the amino group and the capping provides a poly(arylene ether) that is more stable to high temperatures, thereby resulting in fewer degradative products, such as gels or black specks, during processing of the poly(arylene ether).

The poly(arylene ether) can have a number average molecular weight of about 3,000 to about 40,000 grams per mole (g/mol) and a weight average molecular weight of about 5,000 to about 80,000 g/mol, as determined by gel permeation chromatography using monodisperse polystyrene standards, a styrene divinyl benzene gel at 40° C. and samples having a concentration of 1 milligram per milliliter of chloroform. The poly(arylene ether) or combination of poly(arylene ether)s can have an intrinsic viscosity greater than 0.25 deciliters per gram (dl/g), as measured in chloroform at 25° C. The intrinsic viscosity of the poly(arylene ether) used in making the thermoplastic composition (initial intrinsic viscosity) can differ from the intrinsic viscosity of the poly(arylene ether) in the thermoplastic composition (final intrinsic viscosity). Initial intrinsic viscosity is defined as the intrinsic viscosity of the poly(arylene ether) prior to melt mixing with the other components of the composition and final intrinsic viscosity is defined as the intrinsic viscosity of the poly(arylene ether) after melt mixing with the other components of the composition. As understood by one of ordinary skill in the art the viscosity of the poly(arylene ether) may be up to 30% higher after melt mixing. The percentage of increase can be calculated by (final intrinsic viscosity−initial intrinsic viscosity)/initial intrinsic viscosity. Determining an exact ratio, when two intrinsic viscosities are used, will depend somewhat on the exact intrinsic viscosities of the poly(arylene ether) used and the ultimate physical properties that are desired.

In some embodiments, a poly(arylene ether) having the specified molecular weight characteristics can be prepared by a so-called “reactive precipitation” procedure using specific catalysts. In reactive precipitation, oxidative polymerization is conducted in a mixture comprising a solvent for the poly(arylene ether) and a non-solvent for the poly(arylene ether), and the product poly(arylene ether) precipitates out of the polymerization reaction mixture. Suitable solvents for the poly(arylene ether) include aromatic hydrocarbons such as benzene, alkyl-substituted benzenes (including toluene and xylenes), and mixtures thereof. Suitable non-solvents for the poly(arylene ether) include C₁-C₄ alkanols (such as methanol, ethanol, n-propanol, isopropanol, and butanols), C₃-C₁₂ ketones (such as acetone, methyl ethyl ketone, and acetophenone), C₃-C₁₂ aliphatic esters (such as methyl acetate, ethyl acetate, butyl acetate, and caprolactone), C₃-C₁₂ aliphatic amides (such as dimethylformamide, dimethylacetamide, and caprolactam), and mixtures thereof. The weight ratio of solvent to non-solvent is typically in the range of about 1:10 to about 10:1, specifically about 1:5 to about 5:1, more specifically about 1:3 to about 3:1, yet more specifically about 1:2 to about 2:1. The specific catalyst comprises copper ion and morpholine. The copper ion is typically provide in the form of a copper halide salt, such as a cuprous (Cu⁺) or cupric (Cu²⁺) salt of chloride, bromide, or iodide. Preferred copper salts include cuprous chloride and cupric chloride. In some embodiments, the molar ratio of copper ion to morpholine is about 10:1 to about 100:1, specifically about 20:1 to about 70:1. In addition to morpholine, the catalyst can, optionally, further comprise other amines, including dialkylamines (such as dicyclohexylamine), trialkylamines (such as triethylamine), aromatic amines (such as pyridine), and mixtures thereof. Detailed reaction conditions for reactive precipitation in the presence of copper/morpholine catalysts are described in, for example, Czechoslovakia Specification of Invention Nos. 227,586 and 229,840 of Bartaskova et al., and Czechoslovakia Patent Specification Nos. 275,438 and 275,981 of Spousta et al. Use of a catalyst comprising morpholine can be detected by residual morpholino groups in the product poly(arylene ether). Thus, in some embodiments, the poly(arylene ether) comprises about 0.1 to about 0.6 weight percent of (covalently bound) morpholino groups, based on the weight of the poly(arylene ether). Within this range, the concentration of morpholino groups can be about 0.15 to about 0.5 weight percent, specifically about 0.2 to about 0.4 weight percent. The content of (covalently bound) morpholino groups in the poly(arylene ether) can be determined by proton nuclear magnetic resonance spectroscopy (¹H NMR), as described in with working examples below.

In some embodiments, the poly(arylene ether) is further characterized by a molecular weight distribution that is at least bimodal. The molecular weight distribution comprises a first local maximum having a first molecular weight and a second local maximum having a second molecular weight that is greater than the first molecular weight, and wherein a ratio of the second molecular weight to the first molecular weight is about 2:1 to about 4:1. Such poly(arylene ether) and a method of increasing the melt flow rate of a poly(arylene ether) compositions have been described in U.S. Provisional Patent Application Ser. No. 61/101,206 filed Sep. 30, 2008, and U.S. Provisional Patent Application Ser. No. 61/146,450 filed Jan. 22, 2009, which are incorporated herein by reference in their entirety.

In some embodiments, the poly(arylene ether) is a poly(2,6-dimethyl-1,4-phenylene ether); and wherein the poly(2,6-dimethyl-1,4-phenylene ether), before it is blended with the other resin, has a weight average molecular weight of about 75,000 to about 95,000 atomic mass units, a peak molecular weight of about 40,000 to about 60,000 atomic mass unit, a ratio of the weight average molecular weight to the peak molecular weight is about 1.3:1 to about 4:1, preferably about 1.5:1 to about 2.5:1, more preferably 1.6:1 to about 2.3:1, and a bimodal molecular weight distribution comprising a second local maximum having a second molecular weight of about 200,000 to about 400,000 atomic mass units.

The poly(arylene ether) may have a hydroxy end group content of less than or equal to 6300 parts per million based on the total weight of the poly(arylene ether) (ppm) as determined by Fourier Transform Infrared Spectrometry (FTIR). In some embodiments the poly(arylene ether) may have a hydroxy end group content of less than or equal to 3000 ppm, or, more specifically, less than or equal to 1500 ppm, or, even more specifically, less than or equal to 500 ppm.

The poly(arylene ether) may be a composition comprising a poly(arylene ether); and a poly(arylene ether)-polysiloxane block copolymer comprising a poly(arylene ether) block, and a polysiloxane block comprising, on average, 35 to 80 siloxane repeating units; wherein the composition comprises 1 to 8 weight percent siloxane repeating units and 12 to 99 weight percent arylene ether repeating units; wherein the composition is the product of a process comprising oxidatively copolymerizing a monomer mixture comprising a monohydric phenol and a hydroxyaryl-terminated polysiloxane; and wherein the composition has a weight average molecular weight of at least 30,000 atomic mass units.

The poly(arylene ether) may be a product of polymerizing the monohydric phenol alone and a by-product of the block copolymer synthesis. When the monohydric phenol consists of a single compound (for example, 2,6-dimethylphenol), the poly(arylene ether) is the product of homopolymerizing that single monohydric phenol. When the monohydric phenol comprises two or more distinct monohydric phenol species (for example, a mixture of 2,6-dimethylphenol and 2,3,6-trimethylphenol), the poly(arylene ether) is the product of copolymerizing the two or more distinct monohydric phenol species. Using the nuclear magnetic resonance methods described in the working examples described in U.S. patent application Ser. No. 12/277,835 filed Nov. 25, 2008, which is fully incorporated herein by reference, it has not been possible to allocate the phenylene ether residues between poly(arylene ether) and poly(arylene ether)-polysiloxane block copolymer. However, the presence of poly(arylene ether) is inferred from the presence of “tail” groups as defined below (e.g., 2,6-dimethylphenoxy groups when the monohydric phenol is 2,6-dimethylphenol) and/or the presence of “biphenyl” groups as defined below (e.g., the residue of 3,3′,5,5′-tetramethyl-4,4′-biphenol) in the isolated product.

Thus, in some of the embodiments the poly(arylene ether) may be a composition, comprising: a poly(arylene ether); and a poly(arylene ether)-polysiloxane block copolymer comprising a poly(arylene ether) block, and a polysiloxane block comprising, on average, 35 to 80 siloxane repeating units; wherein the composition comprises 1 to 8 weight percent siloxane repeating units and 12 to 99 weight percent arylene ether repeating units; wherein the composition is the product of a process comprising oxidatively copolymerizing a monomer mixture comprising a monohydric phenol and a hydroxyaryl-terminated polysiloxane; and wherein the composition has a weight average molecular weight of at least 30,000 atomic mass units.

The poly(arylene ether) may be substantially free of visible particulate impurities. In some embodiments, the poly(arylene ether) is substantially free of particulate impurities greater than about 15 micrometers. As used herein, the term “substantially free of visible particulate impurities” when applied to poly(arylene ether) means that a ten gram sample of a polymeric material dissolved in fifty milliliters of chloroform (CHCl₃) exhibits fewer than 5 visible specks when viewed in a light box. Particles visible to the naked eye are typically those greater than 40 micrometers in diameter. As used herein, the term “substantially free of particulate impurities greater than about 15 micrometers” means that of a forty gram sample of polymeric material dissolved in 400 milliliters of CHCl₃, the number of particulates per gram having a size of about 15 micrometers is less than 50, as measured by a Pacific Instruments ABS2 analyzer based on the average of five samples of twenty milliliter quantities of the dissolved polymeric material that is allowed to flow through the analyzer at a flow rate of one milliliter per minute (plus or minus five percent).

In some embodiments, the poly(arylene ether) is a poly(2,6-dimethyl-1,4-phenylene ether) present in an amount of about 30 to about 70 weight percent; the poly(arylene ether) has a weight average molecular weight of about 45,000 to about 75,000 atomic mass units; the poly(arylene ether) has a peak molecular weight of about 20,000 to about 40,000 atomic mass units; the ratio of the weight average molecular weight to the peak molecular weight is about 1.5:1 to about 2.5:1; the poly(arylene ether) comprises about 0.1 to about 0.6 weight percent of morpholino groups.

In some embodiments, the poly(arylene ether) may be a poly(2,6-dimethyl-1,4-phenylene ether), wherein a purified sample of poly(2,6-dimethyl-1,4-phenylene ether) prepared by dissolution of the poly(2,6-dimethyl-1,4-phenylene ether) in toluene, precipitation from methanol, reslurry, and isolation, and has a monomodal molecular weight distribution in the molecular weight range of 250 to 1,000,000 atomic mass units, and comprises less than or equal to 2.2 weight percent of poly(2,6-dimethyl-1,4-phenylene ether) having a molecular weight more than fifteen times the number average molecular weight of the entire purified sample; wherein the purified sample after separation into six equal poly(2,6 dimethyl-1,4-phenylene ether) weight fractions of decreasing molecular weight comprises a first, highest molecular weight fraction; and wherein the first, highest molecular weight fraction comprises at least 10 mole percent of poly(2,6 dimethyl-1,4-phenylene ether) comprising a terminal morpholine substituted phenoxy group. Such poly(arylene ether) and a method of preparing such poly(arylene ether) have been described in U.S. patent application Ser. No. 12/495,980 filed Jul. 1, 2009, which is incorporated herein by reference in its entirety.

The composition may comprise the poly(arylene ether) in an amount of 5 to 50 weight percent (wt %), based on the weight of the total composition. Within this range the amount of poly(arylene ether) may be greater than or equal to about 15 wt %, or, more specifically, greater than or equal to about 35 wt %. Also within this range the amount of poly(arylene ether) may be less than or equal to about 45 wt %, more specifically, less than or equal to about 40 wt %.

In some embodiments, the poly(arylene ether) composition described herein comprise at least two phases, a polyolefin phase and a poly(arylene ether) phase. The polyolefin phase is continuous and the poly(arylene ether) phase is dispersed in the polyolefin phase. Good compatibilization between the phases can result in, among others, improved physical properties including higher impact strength at low temperatures and room temperature, better heat aging, better flame retardance, better chemical resistance as well as greater tensile elongation. It is generally accepted that the morphology of the composition is indicative of the degree or quality of compatibilization. Small, relatively uniformly sized particles of poly(arylene ether) evenly distributed throughout an area of the composition are indicative of good compatibilization.

In some embodiments, the poly(arylene ether) composition has poly(arylene ether) particles dispersed in the continuous polyolefin phase. When the composition is injection molded or extruded, particularly when extruded to form a covered conductor, the poly(arylene ether) particles may have an average diameter less than 5 micrometers or more specifically, less than or equal to 3 micrometers, or, even more specifically, less than or equal to 2 micrometers. As readily appreciated by one of ordinary skill in the art the poly(arylene ether) particles may have spherical or non-spherical shapes. The shape of the particles may be dependent upon molding or extruding conditions, particularly the amount of shear present during article formation. When the particle shape is non-spherical the diameter of the particle is defined as the longest linear dimension. This can alternately be described as the major axis.

In some embodiments, the poly(arylene ether) composition has poly(arylene ether) particles dispersed in the continuous polyolefin phase. When the composition is injection molded or extruded the poly(arylene ether) particles have an average particle area less than or equal to 4 square micrometers (μm²), or, more specifically, less than or equal to 2 square micrometers, or, even more specifically, less than or equal to 1 square micrometer determined as described below.

The average diameter and/or particle area of the poly(arylene ether) particles in an injection molded item may be determined using transmission electron microscopy. The composition is injection molded into a disc having a 3.2 millimeters thickness as is used in an ASTM D 3763-02 test. A portion located at the center (in terms of diameter) of the disc is removed and then sections having a thickness of 100 nanometers are removed from the center (in terms of thickness) of the portion. The sections are stained in freshly prepared ruthenium tetraoxide staining solution for 30 seconds. The microscopy studies may be performed on an electron microscope such as a Technai G2. Digital image acquisition may be performed using a camera such as a Gatan Model 791 side mount camera. Images may be analyzed using image analysis software such as Clemex Vision PE to determine the average diameter or average particle area. Only particles that have boundaries completely within the viewing area are included in the analysis. The analysis and the average values are based on at least 100 particles.

The average diameter and/or particle area of the poly(arylene ether) particles in an extruded item, such as a covered conductor, may be determined by removing a portion of the extruded thermoplastic and then sections having a thickness of 100 nanometers are removed from the portion at a depth of 50-60 micrometers from the surface. The sections are stained in freshly prepared ruthenium tetraoxide staining solution for 30 seconds. The microscopy studies may be performed on an electron microscope such as a Technai G2. Digital image acquisition may be performed using a camera such as a Gatan Model 791 side mount camera. Images may be analyzed using image analysis software such as Clemex Vision PE to determine the average diameter or the particle area. Only particles that have boundaries completely within the viewing area are included in the analysis. The analysis and average values are based on at least 100 particles.

In some embodiments, the poly(arylene ether) composition described herein comprises: the product obtained on curing with 5 to 5,000 megarads of electron beam radiation an uncured composition comprising 20 to 55 weight percent of a poly(arylene ether), 20 to 50 weight percent of a thermoplastic polyolefin, and 2 to 20 weight percent of a compatibilizer for the poly(arylene ether) and the thermoplastic polyolefin; wherein all weight percents are based on the total weight of the uncured composition. The thermosetting resin composition passes the class A, B, or C short-term and long term heat ageing tests according to ISO 6722 (as of second edition, 2006-08-01), and the chemical resistance test according to LV112.

The poly(arylene ether) composition is obtained on curing the uncured composition with 5 to 5,000 megarads of electron beam radiation. Specifically, the dosage can be 5 to 500 megarads of electron beam radiation, more specifically 10 to 50 megarads of electron beam radiation. When the dosage is significantly less than 5 megarads, insufficient improvement in the chemical resistance of the cured composition is obtained. When the dosage is significantly greater than 5,000 megarads, excessive polymer chain scission can occur and be manifested as reduced flexibility and deteriorated thermal aging properties. The accelerating voltage of the electrons can be varied according to factors including the electron beam equipment used, the composition of the uncured composition, the thickness of the uncured composition, the desired degree of curing, and the desired processing time. In some embodiments, the electrons are accelerated through a voltage of about 10 to about 10,000 kilovolts, specifically about 40 to about 1,000 kilovolts, more specifically about 80 to about 400 kilovolts, still more specifically about 80 to about 150 kilovolts. The uncured composition can be formed into articles before electron beam curing. Alternatively, the composition can be electron beam cured before being formed into articles.

Polyolefins are of the general structure: CₙH₂ₙ and include polyethylene (HDPE, LDPE, MDPE, LLDPE) polypropylene and polyisobutylene with exemplary homopolymers being atactic polypropylene, and isotatic polypropylene. Polyolefin resins of this general structure and methods for their preparation are well known in the art and are described for example in U.S. Pat. Nos. 2,933,480, 3,093,621, 3,211,709, 3,646,168, 3,790,519, 3,884,993, 3,894,999, 4,059,654, 4,166,055 and 4,584,334. In one embodiment the polyolefin consists essentially of a polyolefin homopolymer, or, more specifically, a crystalline polyolefin homopolymer. The density of polyethylene (HDPE, LDPE, MDPE, LLDPE) can be 0.90 gram/cm³ to 0.98 gram/cm³.

Copolymers of polyolefins may also be used such copolymers of polypropylene with rubber and polyethylene with rubber. Additionally copolymers include copolymers such as ethylene octene rubber. These are sometimes referred to as impact modified polypropylene. Such copolymers are typically heterophasic and have sufficiently long sections of each component to have both amorphous and crystalline phases. In one embodiment the polyolefin comprises a polyolefin block copolymer with end group consists essentially of a polyolefin homopolymer of C2 to C3 and a middle block comprise a copolymer of C2-C12. Additionally the polyolefin may comprise a combination of homopolymer and copolymer, a combination of homopolymers having different melt temperatures, and/or a combination of homopolymers having a different melt flow rate.

Although there is not necessarily a clear line between thermoplastic polyolefins and polyolefin thermoplastic elastomers, thermoplastic polyolefins typically have a flexural modulus at 25° C. that is greater than 1,000 megapascals, whereas polyolefin thermoplastic elastomers typically have a flexural modulus at 25° C. that is less than 1,000 megapascals. Suitable thermoplastic polyolefins include, for example, high density polyethylenes, medium density polyethylenes, low density polyethylenes, linear low density polyethylenes, polypropylenes (propylene homopolymers), propylene random copolymers, propylene graft copolymers, and propylene block copolymers.

In some embodiments, the thermoplastic polyolefin is a homopolymer of ethylene or propylene. Exemplary homopolymers include polyethylene, high density polyethylene (HDPE), medium density polyethylene (MDPE), and isotactic polypropylene. Polyolefin resins of this general structure and methods for their preparation are well known in the art. In some embodiments, the thermoplastic polyolefin is an olefin copolymer in which the monomer ratio is controlled to provide a thermoplastic (not elastomeric) product.

In some embodiments, the polyolefin comprises a crystalline polyolefin such as isotactic polypropylene. Crystalline polyolefins area defined as polyolefins having a crystallinity content greater than or equal to 20%, or, more specifically, greater than or equal to 25%, or, even more specifically, greater than or equal to 30%. Crystallinity may be determined by differential scanning calorimetry (DSC).

In some embodiments, the polyolefin comprises a crystalline polyolefin such as isotactic polypropylene. Crystalline polyolefins are defined as polyolefins having a crystallinity content greater than or equal to 20%, specifically greater than or equal to 25%, more specifically greater than or equal to 30%. Percent crystallinity can be determined by differential scanning calorimetry (DSC). In some embodiments, the polyolefin comprises a high density polyethylene. The high density polyethylene can have a density of 0.941 to 0.965 grams per milliliter.

In some embodiments, the polyolefin comprises liquid polyolefins having a weight average molecular weight of 2,000 to about 50,000 atomic mass units. The examples of such polyolefines can be polybutenes, olefinic waxes, or the liquid polyolefins used as flow promoters in polymeric compositions. In some embodiments, the polyolefin has a weight average molecular weight of 40,000 to about 5,000,000 atomic mass units.

In some embodiments, the polyolefin comprises a polypropylene having a melt temperature greater than or equal to 120° C., specifically greater than or equal to 125° C., more specifically greater than or equal to 130° C., even more specifically greater than or equal to 135° C. In some embodiments, the polypropylene has a melt temperature less than or equal to 175° C. In some embodiments, the polyolefin comprises a high density polyethylene having a melting temperature of greater than or equal to 124° C., specifically greater than or equal to 126° C., more specifically greater than or equal to 128° C. In some embodiments, the melting temperature of the high density polyethylene is less than or equal to 140° C.

In some embodiments, the polyolefin has a melt flow rate (MFR) of about 0.3 to about 10 grams per ten minutes (g/10 min). Specifically, the melt flow rate can be about 0.3 to about 5 g/10 min. Melt flow rate can be determined according to ASTM D1238 using either powdered or pelletized polyolefin, a load of 2.16 kilograms and a temperature suitable for the resin (190° C. for ethylene based resins and 230° C. for propylene based resins).

In some embodiments, the polyolefin comprises polyethylene homo polyethylene or a polyethylene copolymer. Additionally the polyethylene may comprise a combination of homopolymer and copolymer, a combination of homopolymers having different melting temperatures, and/or a combination of homopolymers having a different melt flow rate. The polyethylene can have a density of 0.911 grams per cubic centimeter to 0.98 grams per centimeter.

In some embodiments, the polyolefin comprises a high density polyethylene (HDPE). The high density polyethylene can have a density of 0.941 to 0.965 grams per milliliter.

In some embodiments, the polyolefin comprises a medium density polyethylene (MDPE). The medium density polyethylene can have a density of 0.921 to 0.94 grams per milliliter.

In some embodiments, the polyolefin comprises a mixture of medium density polyethylene (MDPE) and a high density polyethylene (HDPE).

In some embodiments, the polyolefin has a melt flow rate (MFR) of about 0.3 to about 10 grams per ten minutes (g/10 min). Specifically, the melt flow rate can be about 0.3 to about 5 g/10 min. Melt flow rate can be determined according to ASTM D1238 using either powdered or pelletized polyolefin, a load of 2.16 kilograms and a temperature suitable for the resin (190° C. for ethylene based resins and 230° C. for propylene based resins).

In some embodiments, the polyolefin comprises polyethylene homo polyethylene or a polyethylene copolymer. Additionally the polyethylene may comprise a combination of homopolymer and copolymer, a combination of homopolymers having different melting temperatures, and/or a combination of homopolymers having a different melt flow rate. The polyethylene can have a density of 0.911 grams per cubic centimeter to 0.98 grams per cubic centimeter.

In some embodiments, a mixture of different types of polyolefin can be used.

In some embodiments, a mixture of polyethylenes with different densities can be used.

Specific examples of commercially available thermoplastic polyolefins suitable for the present invention, include the high density polyethylene available from EquiStar as Petrothene LR5900 00, the medium density polyethylene available from EquiStar as Petrothene GA837091, the linear low density polyethylene available from EquiStar as Petrothene GA818073, the low density polyethylene available from EquiStar as Petrothene NA940000, the ethylene-propylene random copolymer available from ExxonMobil as PP9122, the heterophasic polypropylene-poly(ethylene-propylene) available from Basell as Pro-fax 7624, and the propylene homopolymer available from Sunoco as D015-C2. Mixtures of two or more thermoplastic polyolefins can be used.

In some embodiment polyolefin thermoplastic elastomers are olefinic block copolymers, graft copolymers or, blends of polyolefins, polyolefin block copolymers. Polyolefin thermoplastic elastomers commercially available under the trade names of Infuse from DOW chemicals, Vistaflex from Advanced Elastomer Systems, Ferroflex from Ferro Corporation, Hifax and Dexflex from Lyondell-Basell Industries, Polytrop from A Schulman, Telcar from Technor Apex, Kelburon from DSM, Vitacom from British VITA/VTC TPE Group, Vestolen from SABIC are suitable for the present invention.

Other suitable thermoplastic elastomers comprise: thermoplastic polyurethane elastomers; styrenic triblock copolymers; styrenic star branched block copolymers; blends of halogen containing polymers such as poly(vinyl chloride) (PVC)-nitrile blends, poly(vinyl chloride) (PVC)-polyurethane blends, poly(vinyl chloride) (PVC)-copolyester elastomer blends; thermoplastic polyether ester elastomer; thermoplastic elastomers of polyamides; ionomeric thermoplastic elastomers; polyacrylate based thermoplastic elastomers one or more of the foregoing. The above-mentioned elastomers are described in details in “Thermoplastic Elastomers”, 3^{rd} edition, Holden Geoffrey et al, Hanser Gardner Publications, 2004, and the same has been fully incorporated herein by reference along with all its cited references, which are also incorporated herein by reference in their entirety.

The poly(arylene ether) composition may comprise the polyolefin in an amount of 1 to 80 weight percent (wt %), based on the total weight of the thermoplastic composition. Within this range the amount of polyolefin may be greater than or equal to 5 wt %, or, more specifically, greater than or equal to about 10 wt % or, more specifically, greater than or equal to about 20 wt %. Also within this range the amount of polyolefin may be less than or equal to about 70 wt %, or, more specifically, less than or equal to about 60 wt % or, more specifically, less than or equal to about 45 wt %.

In some embodiments, when the poly(arylene ether) compositions comprise greater than or equal to 15 weight percent polyethylene, based on the total weight of the composition, the compositions can be essentially free of a polypropylene. Essentially free is defined as containing less than 10 weight percent (wt %), or, more specifically less than 7 wt %, or, more specifically less than 5 wt %, or, even more specifically less than 3 wt % of a polypropylene resin, based on the total weight of composition.

The poly(arylene ether) composition may comprise a homopolymer of an alkenyl aromatic monomer, wherein the alkenyl aromatic monomer has the formula,

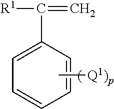

wherein R¹ is hydrogen, lower alkyl or halogen; Q¹ is vinyl, halogen or lower alkyl; and p is from 0 to 5. Exemplary alkenyl aromatic monomers include styrene, chlorostyrene, and vinyltoluene. In some embodiments, the homopolymer of an alkenyl aromatic monomer is the homopolymer derived from styrene (i.e., homopolystyrene). The homopolystyrene comprises at least 99% of its weight, or, more specifically, 100% of its weight, from styrene. Homopolystyrenes include atactic and syndiotactic homopolystyrenes.

Styrenic resins include homopolymers and copolymers of alkenyl aromatic monomers. As used herein the term “copolymer of alkenyl aromatic monomers” refers to a copolymer of monomers consisting of two or more different alkenyl aromatic monomers. Homopolymers of alkenyl aromatic monomers include polystyrenes, including atactic and syndiotactic polystyrenes. The copolymers of alkenyl aromatic monomers include random copolymers of two or more monomers selected from the group consisting of styrene, methylstyrenes, and t-butylstyrenes. The copolymers of alkenyl aromatic monomers also include rubber modified polystyrene resin (also known as high impact polystyrene or HIPS). The copolymers of alkenyl aromatic monomers also include block copolymers (as defined as “styrenic block copolymer” thereafter). The homopolymers and copolymers of alkenyl aromatic monomers, when present, can be used in an amount of 1 to 60 weight percent, specifically 10 to 40 weight percent, based on the total weight of the thermoplastic composition.

In some embodiments, when the poly(arylene ether) composition comprise greater than or equal to 30 weight percent polyolefin, based on the total weight of the composition, the compositions can be essentially free of an poly(alkenyl aromatic) resin such as polystyrene or rubber-modified polystyrene (also known as high impact polystyrene or HIPS). Essentially free is defined as containing less than 10 weight percent (wt %), or, more specifically less than 7 wt %, or, more specifically less than 5 wt %, or, even more specifically less than 3 wt % of an alkenyl aromatic resin, based on the total weight of composition.

A styrenic block copolymer is a copolymer comprising (A) at least one block comprising repeating aryl alkylene units and (B) at least one block comprising repeating alkylene units. The arrangement of blocks (A) and (B) may be a linear structure or a so-called radial teleblock structure having branched chains. A-B diblock copolymers and A-B-A triblock copolymers have one or two blocks A comprising repeating aryl alkylene units. The pendant aryl moiety may be polycyclic and may have a substituent at any available position on the cyclic portion. Suitable substituents include alkyl groups having 1 to 4 carbons. An exemplary aryl alkylene unit may be derived from the monomer unit shown by the formula,

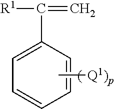

wherein R¹ is hydrogen, lower alkyl or halogen; Q¹ is vinyl, halogen or lower alkyl; and p is from 0 to 5. Exemplary alkenyl aromatic monomers include styrene, chlorostyrene, and vinyltoluene. Block A may further comprise alkylene units having 2 to 15 carbons as long as the quantity of aryl alkylene units exceeds the quantity of alkylene units. Block B comprises repeating alkylene units having 2 to 15 carbons such as ethylene, propylene, butylene or combinations of two or more of the foregoing. Block B may further comprise aryl alkylene units as long as the quantity of alkylene units exceeds the quantity of aryl alkylene units. Each occurrence of block A may have a molecular weight which is the same or different than other occurrences of block A. Similarly each occurrence of block B may have a molecular weight which is the same or different than other occurrences of block B.

The repeating aryl alkylene units may result from the polymerization of aryl alkylene monomers such as styrene. The repeating alkylene units result from the hydrogenation of repeating unsaturated units such as butadiene. The butadiene may comprise 1,4-butadiene and/or 1,2-butadiene. The B block may further comprise some unsaturated carbon-carbon bonds.

In some embodiments the poly(arylene ether) composition, in addition to the poly(arylene ether) and the polyolefin, comprises a hydrogenated styrenic block copolymer of an alkenyl aromatic compound and a conjugated diene. This hydrogenated styrenic block copolymer has a poly(alkenyl aromatic) content of about 10 to 45 weight percent, based on the total weight of the hydrogenated block copolymer. Specifically, the poly(alkenyl aromatic) content can be about 10 to about 40 weight percent, or about 10 to about 35 weight percent. The hydrogenated block copolymer may have a weight average molecular weight greater than or equal to 20,000 atomic mass units. As noted above, this molecular weight is determined by gel permeation chromatography and based on comparison to polystyrene standards. In some embodiments, the hydrogenated block copolymer has a weight average molecular weight of 20,000 to about 400,000 atomic mass units, preferably 50,000 to about 380,000 atomic mass units, more preferably 150,000 t about 360,000 atomic mass units, and even more preferably 220,000 to about 350,000 atomic mass units. Methods for making high molecular weight hydrogenated block copolymers are known in the art and described, for example, in U.S. Pat. No. 3,431,323 to Jones. High molecular weight hydrogenated block copolymers are also commercially available as, for example, the polystyrene-poly(ethylene/butylene)-polystyrene triblock copolymer having a styrene content of 31 weight percent based and a weight average molecular weight of about 240,000 to about 301,000 atomic mass units available from Kraton Polymers as KRATON G 1651.

In some embodiments, the poly(arylene ether) composition may comprise a first styrenic block copolymer and a second styrenic block copolymer. The first styrenic block copolymer has an aryl alkylene content greater than or to equal to 50 weight percent based on the total weight of the first styrenic block copolymer. The styrenic second block copolymer has an aryl alkylene content less than 50 weight percent based on the total weight of the styrenic second block copolymer. The styrenic first block copolymer, the second styrenic block copolymer or both the first and second styrenic block copolymers may be a blend of diblock and triblock copolymers. An exemplary combination of block copolymers is a polystyrene-poly(ethylene/butylene)-polystyrene having a styrenic content of 15 weight percent to 40 weight percent, based on the total weight of the block copolymer and a polystyrene-poly(ethylene-butylene)-polystyrene having a styrenic content of 55 weight percent to 70 weight percent, based on the total weight of the block copolymer may be used. Exemplary styrenic block copolymers having an aryl alkylene content greater than 50 wt % are commercially available from Asahi under the trademark TUFTEC and have grade names such as H1043, as well as some grades available under the trade name SEPTON from Kuraray. Exemplary styrenic block copolymers having an aryl alkylene content less than 50 wt % are commercially available from Kraton Polymers under the trademark KRATON and have grade names such as G-1701, G-1702, G-1730, G-1641, G-1650, G-1651, G-1652, G-1657, A-RP6936 and A-RP6935. In some embodiments the first and second styrenic block copolymers are both triblock copolymers.

In some embodiments the styrenic block copolymer(s) or a hydrogenated styrenic block copolymers have a number average molecular weight of 5,000 to 1,000,000 grams per mole (g/mol), as determined by gel permeation chromatography (GPC) using polystyrene standards. Within this range, the number average molecular weight may be at least 10,000 g/mol, or, more specifically, at least 30,000 g/mol, or, even more specifically, at least 45,000 g/mol. Also within this range, the number average molecular weight may preferably be up to 800,000 g/mol, or, more specifically, up to 700,000 g/mol, or, even more specifically, up to 650,000 g/mol

The conjugated diene used to prepare the hydrogenated block copolymer can be a C₄-C₂₀ conjugated diene. Suitable conjugated dienes include, for example, 1,3 butadiene, 2 methyl-1,3-butadiene, 2-chloro-1,3-butadiene, 2,3 dimethyl 1,3 butadiene, 1,3-pentadiene, 1,3-hexadiene, and the like, and combinations thereof. In some embodiments, the conjugated diene is 1,3-butadiene, 2 methyl-1,3-butadiene, or a combination thereof. In some embodiments, the conjugated diene consists of 1,3-butadiene.

The hydrogenated styrenic block copolymer is a copolymer comprising (A) at least one block derived from an alkenyl aromatic compound and (B) at least one block derived from a conjugated diene, in which the aliphatic unsaturated group content in the block (B) is reduced by hydrogenation. The arrangement of blocks (A) and (B) includes a linear structure, a grafted structure, and a radial teleblock structure with or without a branched chain. Linear styrenic block copolymers include tapered linear structures and non tapered linear structures. In some embodiments, the hydrogenated styrenic block copolymer has a tapered linear structure. Method of preparing tapered block copolymers, which may also be referred to as controlled distribution block copolymers, are described, for example, in U.S. Patent Application No. US 2003/181584 A1 of Handlin et al. Suitable tapered block copolymers are also commercially available as, for example, KRATON A RP6936 and KRATON A RP6935 from Kraton Polymers. In some embodiments, the hydrogenated styrenic block copolymer has a non-tapered linear structure. In some embodiments, the hydrogenated styrenic block copolymer comprises a B block that comprises random incorporation of alkenyl aromatic monomer. Linear styrenic block copolymer structures include diblock (A-B block), triblock (A-B-A block or B-A-B block), tetrablock (A-B-A-B block), and pentablock (A-B-A-B-A block or B-A-B-A-B block) structures as well as linear structures containing 6 or more blocks in total of A and B, wherein the molecular weight of each A block may be the same as or different from that of other A blocks, and the molecular weight of each B block may be the same as or different from that of other B blocks. In some embodiments, the hydrogenated styrenic block copolymer is a diblock copolymer, a triblock copolymer, or a combination thereof.

In some embodiments, the hydrogenated styrenic block copolymer may be functionalized with acid and or amine moiety.

Illustrative commercially available hydrogenated styrenic block copolymers include the polystyrene-poly(ethylene-propylene) diblock copolymers available from Kraton Polymers as Kraton G1701 and G1702; the polystyrene-poly(ethylene-butylene)-polystyrene triblock copolymers available from Kraton Polymers as Kraton G1641, G1650, G1651, G1654, G1657, G1726, G4609, G4610, GRP-6598, RP-6924, MD-6932M, MD-6933, and MD-6939; the polystyrene-poly(ethylene-butylene-styrene)-polystyrene (S-EB/S-S) triblock copolymers available from Kraton Polymers as Kraton RP-6935 and RP-6936, the polystyrene-poly(ethylene-propylene)-polystyrene triblock copolymers available from Kraton Polymers as Kraton G1730; the maleic anhydride-grafted polystyrene-poly(ethylene-butylene)-polystyrene triblock copolymers available from Kraton Polymers as Kraton G1901, G1924, and MD-6684; the maleic anhydride-grafted polystyrene-poly(ethylene-butylene-styrene)-polystyrene triblock copolymer available from Kraton Polymers as Kraton MD-6670; the polystyrene-poly(ethylene-butylene)-polystyrene triblock copolymer comprising 67 weight percent polystyrene available from Asahi Kasei Elastomer as TUFTEC H1043; the polystyrene-poly(ethylene-butylene)-polystyrene triblock copolymer comprising 42 weight percent polystyrene available from Asahi Kasei Elastomer as TUFTEC H1051; the polystyrene-poly(butadiene-butylene)-polystyrene triblock copolymers available from Asahi Kasei Elastomer as TUFTEC P1000 and P2000; the polystyrene-polybutadiene-poly(styrene-butadiene)-polybutadiene block copolymer available from Asahi Kasei Elastomer as S.O.E.-SS L601; the hydrogenated radial block copolymers available from Chevron Phillips Chemical Company as K Resin KK38, KR01, KR03, and KR05; the polystyrene-poly(ethylene-butylene)-polystyrene triblock copolymer comprising about 60 weight polystyrene available from Kuraray as SEPTON S8104; the polystyrene poly(ethylene ethylene/propylene)-polystyrene triblock copolymers available from Kuraray as SEPTON S4044, S4055, S4077, and S4099; and the polystyrene-poly(ethylene-propylene)-polystyrene triblock copolymer comprising about 65 weight percent polystyrene available from Kuraray as SEPTON S2104. Mixtures of two of more block copolymers may be used. Illustrative commercially available unhydrogenated block copolymers include the KRATON® D series polymers, including KRATON® D1101 and D1102, from Kraton Polymers, and the styrene butadiene radial teleblock copolymers available as, for example, K-RESIN KR01, KR03, KR05, and KR10 sold by Chevron Phillips Chemical Company.

In some embodiments, one or more types of the styrenic block copolymers can be used together. The styrenic block copolymer or combination of styrenic block copolymers may be present in the composition in an amount of 1 to 60 weight percent, based on the total weight of the composition. Within this range the styrenic block copolymer or combination of styrenic block copolymer may be present in an amount greater than or equal to 5, or, more specifically, greater than or equal to 15 weight percent based on the total weight of composition. Also within this range, the styrenic block copolymer or combination of styrenic block copolymer may be present in an amount less than or equal to 55, or, more specifically, less than or equal to 40, or, even more specifically, less than or equal to 30 weight percent based on the total weight of the composition.

There is no limitation on the type of compatibilizer. In some embodiments, the compatibilizer comprises a polymer compatibilizer selected from a group consists of (i) a combination of diblock and triblock styrenic block copolymers, (ii) a styrenic block copolymer wherein a central block is a controlled distribution copolymer, also described herein as linear styrenic block copolymers having tapered linear structures, (iii) a polypropylene-polystyrene graft copolymer, and (iv) a styrenic block copolymer has an aryl alkylene content greater than or to equal to 50 weight percent based on the total weight of the first block copolymer and mixtures thereof. The polymeric compatibilizer may be different from or inclusive of the styrenic resin, in particular, the styrenic block copolymer.

Poly(arylene ether) compositions, in which the poly(arylene ether) is not the continuous phase, or co-continuous phase, the polymer compatibilizer is present in an amount sufficient to result in the formation of dispersed poly(arylene ether) particles having an average diameter less than 5 micrometers and/or an average particle area less than or equal to 4 square micrometers (μm²). In some embodiments, the polymer compatibilizer may be present in the composition in an amount of 0 to 30 weight percent, based on the combined weight of the total composition. Within this range the combination of block copolymers may be present in an amount greater than or equal to 5, or, more specifically, greater than or equal to 10 weight percent based on the combined total weight of the composition.

The detailed description of the polymer compatibilizer can be found in U.S. Patent Publication Nos. 20060135661 and 20060135695 that are incorporated herein by reference by their entirety.

There is no particular restriction on the types of flame retardants that may be used except that the flame retardant is suitably stable at the elevated temperatures employed during processing and free of chlorine and bromine. Exemplary flame retardants include melamine (CAS No. 108-78-1), melamine cyanurate (CAS No. 37640-57-6), melamine phosphate (CAS No. 20208-95-1), melamine pyrophosphate (CAS No. 15541-60-3), melamine polyphosphate (CAS No. 218768-84-4), melam, melem, melon, zinc borate (CAS No. 1332-07-6), boron phosphate, red phosphorous (CAS No. 7723-14-0), organophosphate esters, monoammonium phosphate (CAS No. 7722-76-1), diammonium phosphate (CAS No. 7783-28-0), alkyl phosphonates (CAS No. 78-38-6 and 78-40-0), metal dialkyl phosphinate, ammonium polyphosphates (CAS No. 68333-79-9), 9,10 dihydro-9-oxa-10 phosphophenanthrene-10 oxide (DOPO) (CAS No. 35948-26-5), gel coated red phosphorus, low melting glasses and combinations of two or more of the foregoing flame retardants.

In some embodiments, the poly(arylene ether) composition comprises a flame retardant selected from the group consisting of an organophosphate ester, a metal dialkyl phosphinate, a nitrogen-containing flame retardant, metal hydroxides and mixtures thereof. The amount of the flame retardant, when present in the thermoplastic composition, is sufficient for the covered conductor, when tested according to the flame propagation procedure contained in the ISO 6722 (as of second edition, 2006-08-01), to have a flame out time less or equal to 70 seconds. In some embodiments, the flame retardant may be present in an amount of 1 to 35 weight percent (wt. %), with respect to the total weight of the composition. Within this range the amount of flame retardant can be greater than or equal to 5 wt. %, or more specifically, greater than or equal to 10 wt. %. Also within this range the amount of flame retardant can be less than or equal to 30 wt. %, or, more specifically, less than or equal to 25 wt. %.

Exemplary organophosphate ester flame retardants include, but are not limited to, phosphate esters comprising phenyl groups, substituted phenyl groups, or a combination of phenyl groups and substituted phenyl groups, bis-aryl phosphate esters based upon resorcinol such as, for example, resorcinol bis-diphenylphosphate, as well as those based upon bis-phenols such as, for example, bis-phenol A bis-diphenylphosphate. In some embodiments, the organophosphate ester is selected from tris(alkylphenyl) phosphate (for example, CAS No. 89492-23-9 or CAS No. 78-33-1), resorcinol bis-diphenylphosphate (for example, CAS No. 57583-54-7), bis-phenol A bis-diphenylphosphate (for example, CAS No. 181028-79-5), triphenyl phosphate (for example, CAS No. 115-86-6), tris(isopropylphenyl) phosphate (for example, CAS No. 68937-41-7) and mixtures of two or more of the foregoing organophosphate esters.

In some embodiments the organophosphate ester comprises a bis-aryl phosphate of Formula III:

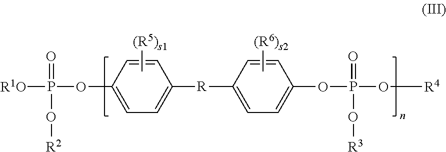

wherein R, R⁵ and R⁶ are independently at each occurrence an alkyl group having 1 to 5 carbons and R¹-R⁴ are independently an alkyl, aryl, arylalkyl or alkylaryl group having 1 to 10 carbons; n is an integer equal to 1 to 25; and s1 and s2 are independently an integer equal to 0 to 2. In some embodiments OR¹, OR², OR³ and OR⁴ are independently derived from phenol, a monoalkylphenol, a dialkylphenol or a trialkylphenol.

As readily appreciated by one of ordinary skill in the art, the bis-aryl phosphate is derived from a bisphenol. Exemplary bisphenols include 2,2-bis(4-hydroxyphenyl)propane (so-called bisphenol A), 2,2-bis(4-hydroxy-3-methylphenyl)propane, bis(4-hydroxyphenyl)methane, bis(4-hydroxy-3,5-dimethylphenyl)methane and 1,1-bis(4-hydroxyphenyl)ethane. In some embodiments, the bisphenol comprises bisphenol A.

Organophosphate esters can have differing molecular weights making the determination of the amount of different organophosphate esters used in the thermoplastic composition difficult. In some embodiments the amount of phosphorus, as the result of the organophosphate ester, is 0.8 weight percent to 1.2 weight percent with respect to the total weight of the composition.

In some embodiments, the flame retardant comprises an organophosphate ester in an amount of 5 to 30 weight percent (wt. %), with respect to the total weight of the composition. Within this range the amount of organophosphate ester can be greater than or equal to 7 wt. %, or more specifically, greater than or equal to 10 wt. %. Also within this range the amount of organophosphate ester can be less than or equal to 25 wt. %, or, more specifically, less than or equal to 20 wt. %.

In some embodiments, the flame retardant comprises a metal dialkyl phosphinate. As used herein, the term “metal dialkyl phosphinate” refers to a salt comprising at least one metal cation and at least one dialkyl phosphinate anion. In some embodiments, the metal dialkyl phosphinate has the formula:

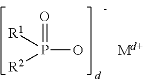

wherein R¹ and R² are each independently C₁-C₆ alkyl; M is calcium, magnesium, aluminum, or zinc; and d is 2 or 3. Examples of R¹ and R² include methyl, ethyl, n-propyl, isopropyl, n-butyl, tert-butyl, n-pentyl, and phenyl. In some embodiments, R¹ and R² are ethyl, M is aluminum, and d is 3 (that is, the metal dialkyl phosphinate is aluminum tris(diethyl phosphinate)).

In some embodiments, the metal dialkyl phosphinate is in particulate form. The metal dialkyl phosphinate particles may have a median particle diameter (D50) less than or equal to 40 micrometers, or, more specifically, a D50 less than or equal to 30 micrometers, or, even more specifically, a D50 less than or equal to 25 micrometers. Additionally, the metal dialkyl phosphinate may be combined with a polymer, such as a poly(arylene ether), a polyolefin, a polyamide, a block copolymer, or combination thereof, to form a masterbatch. The metal dialkyl phosphinate masterbatch comprises the metal dialkyl phosphinate in an amount greater than is present in the thermoplastic composition. Employing a masterbatch for the addition of the metal dialkyl phosphinate to the other components of the thermoplastic composition can facilitate addition and improve distribution of the metal dialkyl phosphinate.

In some embodiments, the flame retardant comprises a metal dialkyl phosphinate present in an amount of 0 to 20 weight percent (wt. %), with respect to the total weight of the composition. Within this range the amount of metal dialkyl phosphinate can be greater than or equal to 2 wt. %, or more specifically, greater than or equal to 5 wt. %. Also within this range the amount of organophosphate ester can be less than or equal to 15 wt. %, or, more specifically, less than or equal to 10 wt. %.

In some embodiments, the flame retardant comprises a nitrogen-containing flame retardant comprising a nitrogen-containing heterocyclic base and a phosphate or pyrophosphate or polyphosphate acid. In some embodiments, the nitrogen-containing flame retardant has the formula

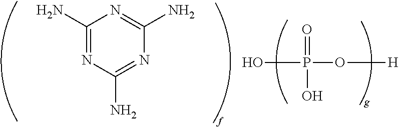

wherein g is 1 to about 10,000 and the ratio of f to g is about 0.5:1 to about 1.7:1, specifically 0.7:1 to 1.3:1, more specifically 0.9:1 to 1.1:1. It will be understood that this formula includes species in which one or more protons are transferred from the polyphosphate group to the melamine group(s). When g is 1, the nitrogen-containing flame retardant is melamine phosphate (CAS Reg. No. 20208-95-1). When g is 2, the nitrogen-containing flame retardant is melamine pyrophosphate (CAS Reg. No. 15541 60-3). When g is, on average, greater than 2, the nitrogen-containing flame retardant is melamine polyphosphate (CAS Reg. No. 56386-64-2). In some embodiments, the nitrogen-containing flame retardant is melamine pyrophosphate, melamine polyphosphate, or a mixture thereof. In some embodiments in which the nitrogen-containing flame retardant is melamine polyphosphate, g has an average value of greater than 2 to about 10,000, specifically about 5 to about 1,000, more specifically about 10 to about 500. In some embodiments in which the nitrogen-containing flame retardant is melamine polyphosphate, g has an average value of greater than 2 to about 500. Methods for preparing melamine phosphate, melamine pyrophosphate, and melamine polyphosphate are known in the art, and all are commercially available. For example, melamine polyphosphates may be prepared by reacting polyphosphoric acid and melamine, as described, for example, in U.S. Pat. No. 6,025,419 to Kasowski et al., or by heating melamine pyrophosphate under nitrogen at 290° C. to constant weight, as described in International Patent Application No. WO 98/08898 A1 to Jacobson et al.

The nitrogen-containing flame retardant can have a low volatility relative to temperatures. For example, in some embodiments, the nitrogen-containing flame retardant exhibits less than 1 percent weight loss by thermogravimetric analysis when heated at a rate of 20° C. per minute from 25 to 280° C., specifically 25 to 300° C., more specifically 25 to 320° C.

In some embodiments, the flame retardant comprises a nitrogen-containing flame retardant present in an amount of 0 to 20 weight percent (wt. %), with respect to the total weight of the composition. Within this range the amount of nitrogen-containing flame retardant can be greater than or equal to 2 wt. %, or more specifically, greater than or equal to 5 wt. %. Also within this range the amount of organophosphate ester can be less than or equal to 15 wt. %, or, more specifically, less than or equal to 10 wt. %.

In some embodiments, the flame retardant may comprise metal hydroxides. Suitable metal hydroxides include all those capable of providing fire retardance, as well as combinations thereof. The metal hydroxide can be chosen to have substantially no decomposition during processing of the fire additive composition and/or flame retardant thermoplastic composition. Substantially no decomposition is defined herein as amounts of decomposition that do not prevent the flame retardant additive composition from providing the desired level of fire retardance. Exemplary metal hydroxides include, but are not limited to, magnesium hydroxide (for example, CAS No. 1309-42-8), aluminum hydroxide (for example, CAS No. 21645-51-2), cobalt hydroxide (for example, CAS No. 21041-93-0) and combinations of two or more of the foregoing. In some embodiments, the metal hydroxide comprises magnesium hydroxide. In some embodiments the metal hydroxide has an average particle size less than or equal to 10 micrometers and/or a purity greater than or equal to 90 weight percent. In some embodiments it is desirable for the metal hydroxide to contain substantially no water, i.e. a weight loss of less than 1 weight percent upon drying at 120° C. for 1 hour. In some embodiments the metal hydroxide can be coated, for example, with stearic acid or other fatty acid.

The flame retardant can comprise the metal hydroxide in an amount of 0 to 35 weight percent, based on the total weight of the composition. Within this range the metal hydroxide can be present in an amount greater than or equal to 10, or, more specifically, greater than or equal to 15, or, even more specifically, greater than or equal to 20 weight percent based on the total weight of the composition. Also within this range the metal hydroxide can be present in an amount less than or equal to 30, or, more specifically, less than or equal to 25 weight percent based on the total weight of the composition.

In some embodiments the poly(arylene ether) composition comprises less than 0.1 weight percent polysiloxane, or, more specifically, less than 0.05 weight percent polysiloxane.

In some embodiments, the poly(arylene ether) composition comprises a polysiloxane in an amount 0 to 5 weight percent, based on the total weight of the composition. In some embodiments, the polysiloxane may have a functional group, for example, silicone fluids commercially available from Momentive Performance Materials under the trade names SF 1706, SF 50, SF 9750, SF 1000, SF 1923, SF 1708, GAS 1027, OF 7747, TP 3635, TSF 4706.

In some embodiments, the covered conductor comprising a conductor and a covering, wherein the covering is disposed over the conductor, wherein the conductor comprises aluminum or an alloy comprising aluminum, and wherein the covering comprises a poly(arylene ether) composition that may exhibit low smoke properties, and may meet or exceed performance requirements set forth by ASTM E662 (as of version, 2009-03-01), or UL 1666 (revised on 2007-02-16).

Additionally, the poly(arylene ether) composition, optionally, comprises various fillers, and reinforcing agents, such as, for example, silicates, silica, alumina, aluminum hydroxide, magnesium hydroxide, kaolin clay, nano-clay, TiO₂, fibers, chopped or continuous glass fibers, glass spheres, low melting glass, polyhedral oligomeric silsesquioxanes (POSS), calcium carbonate, talc, mica, boron nitride, barium sulphate, wollastonite, non-conducting carbon black, wood fibers, cellulosic fibers, sisal fibers, and jute fibers. The loading of these fillers and reinforcing agents may vary from 0 to 50 weight percent based on the total composition.

The poly(arylene ether) composition may also comprise various additives such as mold release agents, UV absorbers, stabilizers like light stabilizers, heat stabilizers and others, anti-oxidants like hindered phenols, phosphorous compounds, lubricants, plasticizers, nucleating agents, acid scavengers, antimicrobial agents, fluorescent whitening agents, pigments, dyes, photo-bleachable dyes, colorants, anti-static agents, free-radical generating chemicals, curing agents, anti-dripping agents, smoke suppressants, flow promoters, silicon containing chemicals, fluorine-containing chemicals, foaming agents, blowing agents, metal deactivators, and combinations comprising one or more of the foregoing additives. The loading of these additives can vary from 0.01 to 5 weight percent based on the total composition.

The additives suitable for the present invention are further described in details in “Plastics Additives Handbook”, 6^{th} edition, Hans Zweifel, Hanser Gardner Publications, 2009 (ISBN No.: 978-1-56990-430-8), and the same has been fully incorporated herein by reference along with all its cited references, which are also incorporated herein by reference in their entirety.

A method for making the poly(arylene ether) composition comprises melt mixing (compounding) the components, typically in a melt mixing device such as an compounding extruder or Banbury mixer. In some embodiments, the poly(arylene ether), styrenic block copolymers, and polyolefin are simultaneously melt mixed. In another embodiment, the poly(arylene ether), styrenic block copolymers, and optionally a portion of the polyolefin are melt mixed to form a first melt mixture. Subsequently, the polyolefin or remainder of the polyolefin is further melt mixed with the first melt mixture to form a second melt mixture. Alternatively, the poly(arylene ether) and a portion of the styrenic block copolymers may be melt mixed to form a first melt mixture and then the polyolefin and the remainder of the styrenic block copolymers are further melt mixed with the first melt mixture to form a second melt mixture.

The aforementioned melt mixing processes can be achieved without isolating the first melt mixture or can be achieved by isolating the first melt mixture. One or more melt mixing devices including one or more types of melt mixing devices can be used in these processes. In some embodiments, some components of the thermoplastic composition that forms the covering may be introduced and melt mixed in an extruder used to coat the conductor.

The method and location of the addition of the flame retardant is typically dictated by the identity and physical properties, e.g., solid or liquid, of the flame retardant as well understood in the general art of polymer alloys and their manufacture. In some embodiments, the flame retardant is combined with one of the components of the thermoplastic composition, e.g., a portion of the polyolefin, to form a concentrate that is subsequently melt mixed with the remaining components.

The poly(arylene ether), styrenic block copolymers, polyolefin and flame retardant are melt mixed at a temperature greater than or equal to the glass transition temperature of the poly(arylene ether) but less than the degradation temperature of the polyolefin. For example, the poly(arylene ether), styrenic block copolymers, polyolefin and flame retardant may be melt mixed at an extruder temperature of 240° C. to 320° C., although brief periods in excess of this range may occur during melt mixing. Within this range, the temperature may be greater than or equal to 250° C., or, more specifically, greater than or equal to 260° C. Also within this range the temperature may be less than or equal to 310° C., or, more specifically, less than or equal to 300° C.

In some embodiments, the poly(arylene ether) composition described herein comprises poly(arylene ether), a hydrogenated block copolymer, and a ethylene-vinyl aliphatic acid copolymer. The compositions comprising poly(arylene ether), an optional homopolymer of an alkenyl aromatic polymer, a hydrogenated block copolymer and ethylene-vinyl aliphatic acid copolymer have greater ultimate elongation than comparable compositions without ethylene-vinyl aliphatic acid copolymer.

In some embodiments, the poly(arylene ether) composition, without filler, may have an ultimate elongation of 150% to 350% as determined by ASTM D 412-98a using a strain rate of 200 millimeters per minute (mm/min). Within this range the composition may have an ultimate elongation greater than or equal to 160%, or, more specifically, greater than or equal to 170%.

The poly(arylene ether) composition, without filler, may have a tensile modulus at 50% of the ultimate elongation of 12 Megapascals (MPa) to 25 MPa. Within this range the composition may have a tensile modulus greater than or equal to 14 MPa, or, more specifically, greater than or equal to 16 Mpa. Tensile modulus at 50% of the ultimate elongation is determined by ASTM D 412-98a.

Useful ethylene-vinyl aliphatic acid copolymer can be prepared by, for example, radical polymerization of ethylene and a vinyl ester of an aliphatic acid. Typical examples of vinyl esters of aliphatic acids are vinyl acetate, vinyl butyrate, vinyl laurate, etc. In one embodiment the ethylene-vinyl aliphatic acid copolymer is ethylene vinyl acetate copolymer (EVA). EVA is commercially available from Lanxess under the trade name LEVAPREN, from Arkema under the tradename EVATANE, from DuPont under the trade name ELVAX, and from Equistar under the tradename ULTRATHENE.

It is understood that when ethylene and a vinyl ester of an aliphatic acid react to form the copolymer the resulting copolymer comprises residues (or moieties) derived from the vinyl ester of an aliphatic acid. The amount of these residues is referred to as the vinyl aliphatic acid content. The ethylene-vinyl aliphatic acid copolymer has a vinyl aliphatic acid content of 15 to 80 wt %, based on the total weight of the EVA. Within this range the amount of vinyl aliphatic acid content in the EVA may be greater than or equal to 18 wt %. Also within this range the amount of vinyl aliphatic acid content in the EVA may be less than 70 wt %.

The composition comprises the ethylene-vinyl aliphatic acid copolymer in an amount of 5 to 40 wt %, based on the combined weight of the poly(arylene ether), block copolymer, ethylene-vinyl aliphatic acid copolymer, and optional homopolymer of an alkenyl aromatic copolymer. Within this range the amount of ethylene-vinyl aliphatic acid copolymer may be greater than or equal to 7 wt %, or, more specifically, greater than or equal to 10 wt %. Also within this range the amount of ethylene vinyl acetate copolymer may be less than or equal to 35 wt %.

The poly(arylene ether) composition comprises poly(arylene ether) in an amount of 25 to 40 weight percent (wt %), based on the combined weight of the poly(arylene ether), ethylene-vinyl aliphatic acid copolymer, block copolymer, and optional homopolymer of an alkenyl aromatic monomer. Within this range the amount of poly(arylene ether) may be less than or equal to 35 wt %.

In some embodiments, the poly(arylene ether) composition described herein comprises a compatibilized polymeric composition comprising poly(arylene ether) and a polyester. The composition exhibits a stable phase morphology, and a unique combination of good heat resistance, dimensional stability, and nominal strain at break and impact properties. The poly(arylene ether) composition comprises a continuous phase comprising a polyester and a dispersed phase comprising poly(arylene ether), wherein the dispersed phase may be present in an amount that is less than or equal to 35 weight percent (wt %) based on the total weight of the composition. The impact modifier may reside in the dispersed phase, or in the continuous phase, or may also be present at the interface between the phases. When the impact modifier resides in the disperse phase, the combined amount of impact modifier and poly(arylene ether) is less than 35 weight percent (wt %), based on the total weight of the composition. The exact amount and types or combinations of poly(arylene ether), impact modifier and polyester will depend, in part, on the requirements needed in the final blend composition. In some embodiments, the poly(arylene ether) and impact modifier are present in an amount of 5 to 35 wt %, or, more specifically, 10 to 25 wt %, based on the total weight of the composition.

In some embodiments, the poly(arylene ether) composition is made using a three lobe extruder, and the composition can comprise up to 45 wt % of a disperse phase comprising poly(arylene ether), based on the total weight of the composition. Despite having an increased amount of disperse phase the compositions meet or exceed the above mentioned criteria for notched Izod strength and nominal strain at break.

In addition to the amount of the disperse phase it is also important that the composition be made using a polymeric compatibilizer having an average of greater than or equal to 3 pendant epoxy groups per molecule. The quantity of pendant epoxy groups can be calculated as follows: the average number of pendant epoxy groups=(Number average molecular weight of the compatibilizer (g/mol)×epoxy content (meq/kg))/1,000,000.

Suitable polyesters include those comprising structural units of the formula:

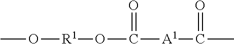

wherein each R¹ is independently a divalent aliphatic, alicyclic or aromatic hydrocarbon radical, or mixtures thereof and each A¹ is independently a divalent aliphatic, alicyclic or aromatic radical, or mixtures thereof. Examples of suitable polyesters comprising the structure of above formula are poly(alkylene dicarboxylate)s, liquid crystalline polyesters, polyarylates, and polyester copolymers such as copolyestercarbonates and polyesteramides. Also included are polyesters that have been treated with relatively low levels of diepoxy or multi-epoxy compounds. It is also possible to use branched polyesters in which a branching agent, for example, a glycol having three or more hydroxyl groups or a trifunctional or multifunctional carboxylic acid has been incorporated. Treatment of the polyester with a trifunctional or multifunctional epoxy compound, for example, triglycidyl isocyanurate can also be used to male branched polyester. Furthermore, it is sometimes desirable to have various concentrations of acid and hydroxyl end groups on the polyester, depending on the ultimate end-use of the composition.

In one embodiment at least some of the polyester comprises nucleophilic groups such as, for example, carboxylic acid groups. In some instances, it is desirable to reduce the number of carboxylic end groups, typically to less than 20 micro equivalents per gram of polyester, with the use of acid reactive species. In other instances, it is desirable that the polyester has a relatively high carboxylic end group concentration, in the range of 20 to 250 micro equivalents per gram of polyester or, more specifically, 30 to 100 micro equivalents per gram of polyester.

In one embodiment, the R¹ radical in formula (II) is a C2-10 alkylene radical, a C6-10 alicyclic radical or a C6-20 aromatic radical in which the allylene groups contain 2-6 and most often 2 or 4 carbon atoms. The A1 radical in formula (II) is most often p- or m-phenylene or a mixture thereof. This class of polyesters includes the poly(allylene terephthalates), the poly(alkylene naphthalates) and the polyarylates. Exemplary poly(alkylene terephthalates) include linear aliphatic polyesters such as poly(ethylene terephthalate) (PET) and poly(butylene terephthalate) (PBT), as well as cyclic aliphatic polyesters such as poly(cyclohexanedimethanol terephthalate) (PCT). Exemplary poly(alkylene naphthalate)s include poly(butylene-2,6-naphthalate) (PBN) and poly(ethylene-2,6-naphthalate) (PEN). Other useful polyesters include poly(ethylene-co-cyclohexanedimethanol terephthalate) (PETG), polytrimethylene terephthalate (PTT), poly(dimethanol-1,4-cyclohexanedicarboxylate) (PCCD), and polyxylene terephthalate (PXT). Polyesters are known in the art as illustrated by the following U.S. Pat. Nos. 2,465,319, 2,720,502, 2,727,881, 2,822,348, 3,047,539, 3,671,487, 3,953,394, and 4,128,526.

Liquid crystalline polyesters having melting points less that 380° C. and comprising recurring units derived from aromatic diols, aliphatic or aromatic dicarboxylic acids, and aromatic hydroxy carboxylic acids are also useful. Examples of useful liquid crystalline polyesters include, but are not limited to, those described in U.S. Pat. Nos. 4,664,972 and 5,110,896. Mixtures of polyesters are also sometimes suitable.

The various polyesters can be distinguished by their corresponding glass transition temperatures (Tg) and melting points (Tm). The liquid crystalline polyesters generally have a Tg and Tm that are higher than the naphthalate-type polyesters. The naphthalate-type polyesters generally have a Tg and Tm that are higher than the terephthalate-type polyesters. Thus, the resultant poly(arylene ether) alloys with the liquid crystalline or naphthalate-type polyesters are typically better suited to applications requiring higher temperature resistance than are the terephthalate-type polyesters. The poly(arylene ether) alloys with terephthalate-type polyesters are generally easier to process due to the polyesters' lower Tgs and Tms. Selection of the polyester or blend of polyesters utilized is therefore determined, in part, by the desired property profile required by the ultimate end-use application for the composition.

Because of the tendency of polyesters to undergo hydrolytic degradation at the high extrusion and molding temperatures in some embodiments the polyester is substantially free of water. The polyester may be predried before admixing with the other ingredients. Alternatively, the polyester can be used without predrying and the volatile materials can be removed by vacuum venting the extruder. The polyesters generally have number average molecular weights in the range of 15,000-100,000, as determined by gel permeation chromatography (GPC) at 30° C. in a 60:40 by weight mixture of phenol and 1,1,2,2-tetrachloroethane.

The poly(arylene ether) composition can comprise 40 to 90 wt % of the polyester, based on the total weight of the composition. Within this range the composition can comprise less than or equal to 80 wt %, or, more specifically, less than or equal to 75 wt %, or, even more specifically, less than or equal to 65 wt % polyester. Also within this range, the composition can comprise greater than or equal to 45 wt %, or, more specifically, greater than or equal to 50 wt % polyester.

The poly(arylene ether) composition also comprises an impact modifier. In some embodiments the impact modifier resides primarily in the poly(arylene ether) phase. Examples of suitable impact modifiers include block copolymers; elastomers such as polybutadiene; random copolymers such as ethylene vinyl acetate (EVA); and combinations comprising two or more of the foregoing impact modifiers.

Exemplary block copolymers include A-B diblock copolymers and A-B-A triblock copolymers having one or two blocks A, which comprise structural units derived from an alkenyl aromatic monomer, for example styrene; and a rubber block, B, which generally comprises structural units derived from a diene such as isoprene or butadiene. The diene block may be partially hydrogenated. Mixtures of these diblock and triblock copolymers are especially useful.

Suitable A-B and A-B-A copolymers include, but are not limited to, polystyrene-polybutadiene; polystyrene-poly(ethylene-butylene); polystyrene-polyisoprene; polystyrene-poly(ethylene-propylene); poly(alpha-methylstyrene)-polybutadiene; poly(alpha-methylstyrene)-poly(ethylene-butylene); polystyrene-polybutadiene-polystyrene (SBS); polystyrene-poly(ethylene-butylene)-polystyrene (SEBS); polystyrene-polyisoprene-polystyrene; polystyrene-poly(ethylene-propylene)-polystyrene; poly(alpha-methylstyrene)-polybutadiene-poly(alpha-methylstyrene); as well as selectively hydrogenated versions thereof, and the like, as well as combinations comprising two or more of the foregoing impact modifiers. Such A-B and A-B-A block copolymers are available commercially from a number of sources, including Phillips Petroleum under the trademark SOLPRENE, Kraton Polymers, under the trademark KRATON, Dexco under the trademark VECTOR, and Kuraray under the trademark SEPTON.

In some embodiments, the impact modifier may reside primarily in the polyester phase. The impact modifier used in the present compositions may be a functional impact modifier, e.g., a polymeric or non-polymeric compound that reacts with the polyester and that increases the impact resistance of the poly(arylene ether) composition. The reactive part of the impact modifier can be monofunctional or polyfunctional, and includes but is not limited to functional groups such as carboxylic acids, carboxylic acid anhydrides, amines, epoxides, carbodiimides, orthoesters, oxazolines, oxiranes, and aziridines. In some embodiments, the functional impact modifier is an epoxy functional core-shell polymer with a core prepared from butyl acrylate monomer, available commercially from Rohm and Haas as EXL 2314. A sub category of these functional impact modifiers includes carboxy reactive impact modifiers. An example of a carboxy reactive compound having impact modifying properties is a co- or ter-polymer including units of ethylene and glycidyl methacrylate (GMA), sold by Arkema. A typical composition of such a glycidyl ester impact modifier is about 67 wt. % ethylene, 25 wt. % methyl methacrylate and 8 wt. % glycidyl methacrylate impact modifier, available from Arkema under the brand name LOTADER AX8900. Another example of a carboxy reactive compound that has impact modifying properties is a terpolymer made of ethylene, butyl acrylate and glycidyl methacrylate, available from DuPont under the trade name ELVALOY PT or ELVALOY PTW. In some embodiments, the composition comprises mono or di epoxy compounds that do not act as a viscosity modifier. In some embodiments the functional impact modifier is an epoxy-functional copolymer comprising units derived from a C2-20 olefin and units derived from a glycidyl(meth)acrylate. Exemplary olefins include ethylene, propylene, butylene, and the like. The olefin units can be present in the copolymer in the form of blocks, e.g., as polyethylene, polypropylene, polybutylene, and the like blocks. It is also possible to use mixtures of olefins, i.e., blocks containing a mixture of ethylene and propylene units, or blocks of polyethylene together with blocks of polypropylene.

When present, the amount of the impact modifier is 5 wt % to 35 wt %, based on the total weight of the composition. Within this range, the impact modifier may be present in amount greater than or equal to 10 wt %, or, more specifically, greater than or equal to 15 wt %. Also within this range, the impact modifier may be present in amount less than or equal to 30 wt %, or, more specifically, less than or equal to 25 wt %, or, even more specifically, less than or equal to 20 wt %. The exact amount and types or combinations of impact modifiers utilized will depend in part on the requirements needed in the final blend composition and may be determined by those skilled in the art.

In addition to the poly(arylene ether), polyester, and impact modifier, the composition is made using a polymeric compatibilizer having an average of greater than or equal to 3 pendant epoxy groups per molecule. In some embodiments the polymeric compatibilizer has an average of greater than or equal to 8 pendant epoxy groups per molecule, or, more specifically, an average of greater than or equal to 11 pendant epoxy groups per molecule or, more specifically, an average of greater than or equal to 15 pendant epoxy groups per molecule or, more specifically, an average of greater than or equal to 17 pendant epoxy groups per molecule. As used herein and throughout, a polymeric compatibilizer is a polymeric polyfunctional compound that interacts with the poly(arylene ether), the polyester, or both. This interaction may be chemical (e.g. grafting) and/or physical (e.g. affecting the surface characteristics of the disperse phases). When the interaction is chemical, the compatibilizer may be partially or completely reacted with the poly(arylene ether), polyester, or both such that the composition comprises a reaction product. For example, the epoxy groups may react with acid groups present on the polyester, the functional groups on the functionalized poly(arylene ether) or both during melt blending. Use of the polymeric compatibilizer can improve the compatibility between the poly(arylene ether) and the polyester, as may be evidenced by enhanced impact strength, mold knit line strength, elongation and/or the formation of a distinctive two phase morphology. Such morphology is evidenced by the occurrence of two distinct phases within a molded part; a continuous phase comprising polyester and a disperse phase comprising poly(arylene ether). The disperse phase particles have an average particle diameter of 0.2 to 5 micrometers, or, more specifically, 0.5 to 4 micrometers, or, even more specifically 0.5 to 3 micrometers. The average particle diameter is the average circular diameter of at least 100 particles and may be determined by scanning electron microscopy or by transmission electron microscopy. In the case of elliptical particles “circular diameter” is the mean of the major and minor axis of each particle. In other words, the diameters of the circumcircle and incircle are averaged for each elliptical particle.

Illustrative examples of suitable compatibilizers include, but are not limited to, copolymers of glycidyl methacrylate (GMA) with alkenes, copolymers of GMA with alkenes and acrylic esters, copolymers of GMA with alkenes and vinyl acetate, copolymers of GMA and styrene. Suitable alkenes comprise ethylene, propylene, and mixtures of two or more of the foregoing. Suitable acrylic esters comprise allyl acrylate monomers, including, but not limited to, methyl acrylate, ethyl acrylate, propyl acrylate, butyl acrylate, and combinations of the foregoing alkyl acrylate monomers. When present, the acrylic ester may be used in an amount of 15 wt % to 35 wt % based on the total amount of monomer used in the copolymer. When present, vinyl acetate may be used in an amount of 4 wt % to 10 wt % based on the total amount of monomer used in the copolymer. Illustrative examples of suitable compatibilizers comprise ethylene-glycidyl acrylate copolymers, ethylene-glycidyl methacrylate copolymers, ethylene-glycidyl methacrylate-vinyl acetate copolymers, ethylene-glycidyl methacrylate-allyl acrylate copolymers, ethylene-glycidyl methacrylate-methyl acrylate copolymers, ethylene-glycidyl methacrylate-ethyl acrylate copolymers, and ethylene-glycidyl methacrylate-butyl acrylate copolymers.

Use of glycidyl methacrylate copolymers as a polymeric compatibilizer is known in the art as illustrated by the following U.S. Pat. Nos. 5,698,632 and 5,719,236. However, unlike the prior art which teaches the compatibilizer can be compounds having two pendant epoxy groups per molecule as well as some mono-functional species, it has been discovered that the polymeric compatibilizer must have an average of greater than or equal to 3 pendant epoxy groups per molecule, or, more specifically, an average of greater than or equal to 8 pendant epoxy groups, or, more specifically, an average of greater than or equal to 11 pendant epoxy groups, or, more specifically, an average of greater than or equal to 15 pendant epoxy groups, or, more specifically, an average of greater than or equal to 17 pendant epoxy groups. Diglycidyl compounds do not exhibit the required reactivity to form a composition with a stable phase morphology.

The poly(arylene ether) composition comprises 0.1 wt % to 20 wt % of polymeric compatibilizer, based on the total weight of the composition. Within this range, the composition can comprise less than or equal to 15 wt %, or, more specifically less than or equal to 10 wt %, or, even more specifically, less than or equal to 8 wt % compatibilizer. Also within this range, the composition may comprise greater than or equal to 0.5 wt %, or, more specifically, greater than or equal to 1 wt %, or, even more specifically, greater than or equal to 4 wt % compatibilizer.

The foregoing compatibilizer may be added directly to the composition or pre-reacted with either or both of the poly(arylene ether) and polyester, as well as with other materials employed in the preparation of the composition. The initial amount of the compatibilizer used and order of addition will depend upon the specific compatibilizer chosen and the specific amounts of poly(arylene ether) and polyester employed.

The poly(arylene ether) composition may also comprise additives known in the art. Possible include anti-oxidants, dyes, pigments, colorants, stabilizers, flame retardants, drip retardants, crystallization nucleators, metal salts, antistatic agents, plasticizers, lubricants, and combinations comprising two or more of the foregoing additives. These additives are known in the art, as are their effective levels and methods of incorporation. Effective amounts of the additives vary widely, but they are usually present in an amount of less than or equal to 50 wt %, based on the total weight of the composition. Amounts of these additives are generally 0.25 wt % to 2 wt %, based upon the total weight of the composition. The effective amount can be determined by those skilled in the art without undue experimentation.

The poly(arylene ether) composition may also comprise fillers as known in the art. Fillers may include reinforcing fillers. Exemplary fillers include small particle minerals (e.g., clay, mica, talc, and the like), glass fibers, nanoparticles, organoclay, and the like and combinations comprising one or more of the foregoing fillers. Fillers are typically used in amounts of 5 wt % to 50 wt %, based on the total weight of the composition.

The poly(arylene ether) composition can be prepared using various techniques, including batch or continuous techniques that employ kneaders, extruders, mixers, and the like. For example, the poly(arylene ether) composition can be formed as a melt blend employing a twin-screw extruder. In one embodiment at least some of the components are added sequentially. For example, the poly(arylene ether), the impact modifier, and functionalizing agent may be added to the extruder at the feed throat or in feeding sections adjacent to the feed throat, while the polyester and polymeric compatibilizer, may be added to the extruder in the subsequent feeding section downstream. A vacuum system may be applied to the extruder, prior to the second sequential addition, to generate a sufficient vacuum to lower the residual levels of non-reacted functionalizing agent and any other volatile materials. In an alternative embodiment, the sequential addition of the components may be accomplished through multiple extrusions. A composition may be made by preextrusion of selected components, such as the poly(arylene ether), the impact modifier and the functionalizing agent to produce a pelletized mixture. A second extrusion may then be employed to combine the preextruded components with the remaining components. The extruder may be a two lobe or three lobe twin screw extruder. It is contemplated that a three lobe extruder may yield a composition with significantly higher notched Izod and nominal strain at break values when compared to compositionally identical compositions made using a two lobe twin screw extruder.

In some embodiments, the poly(arylene ether) composition described herein comprises at least two phases, a polyamide phase and a poly(arylene ether) phase. The polyamide phase is continuous and the poly(arylene ether) phase is dispersed in the polyamide phase. The compatibilized blends of poly(arylene ether) and polyamide can be made using a polymeric compatibilizer or a non-polymeric compatibilizer.

Polyamide resins, also known as nylons, are characterized by the presence of an amide group (—C(O)NH—), and are described in U.S. Pat. No. 4,970,272. Exemplary polyamide resins include, but are not limited to, nylon-6; nylon-6,6; nylon-4; nylon-4,6; nylon-12; nylon-6,10; nylon-6,9; nylon-6,12; amorphous polyamides; polyphthalamides, nylon-6/6T and nylon-6,6/6T with triamine contents below 0.5 weight percent; nylon-9T; and combinations of polyamides.

Polyamide resins may be obtained by a number of well known processes such as those described in U.S. Pat. Nos. 2,071,250; 2,071,251; 2,130,523; 2,130,948; 2,241,322; 2,312,966; 2,512,606; 6,887,930; and JP 2000-212434. Polyamide resins are commercially available from a wide variety of sources.

In some embodiments, the polyamide resin comprises nylon-6 and nylon-6,6. In some embodiments, the polyamide resin or combination of polyamide resins has a melting point (Tm) greater than or equal to 171° C. When the polyamide comprises a super tough polyamide, i.e. a rubber-toughened polyamide, the composition may or may not contain a separate impact modifier.

In some embodiments, polyamide resins having an intrinsic viscosity of up to 400 milliliters per gram (ml/g) can be used, or, more specifically, having a viscosity of 90 to 350 ml/g, or, even more specifically, having a viscosity of 110 to 240 ml/g, as measured in a 0.5 weight percent (wt %) solution in 96 wt % sulfuric acid in accordance with ISO 307.

In some embodiments, the polyamide may have a relative viscosity of up to 6, or, more specifically, a relative viscosity of 1.89 to 5.43, or, even more specifically, a relative viscosity of 2.16 to 3.93. Relative viscosity is determined according to DIN 53727 in a 1 wt % solution in 96 wt % sulfuric acid.

In some embodiments, the polyamide resin comprises a polyamide having an amine end group concentration greater than or equal to 35 microequivalents amine end group per gram of polyamide (μeq/g) as determined by titration with HCl. Within this range, the amine end group concentration may be greater than or equal to 40 μeq/g, or, more specifically, greater than or equal to 45 μeq/g. The maximum amount of amine end groups is typically determined by the polymerization conditions and molecular weight of the polyamide. Amine end group content may be determined by dissolving the polyamide in a suitable solvent, optionally with heat. The polyamide solution is titrated with 0.01 Normal hydrochloric acid (HCl) solution using a suitable indication method. The amount of amine end groups is calculated based the volume of HCl solution added to the sample, the volume of HCl used for the blank, the molarity of the HCl solution and the weight of the polyamide sample.

In some embodiments, the polyamide comprises greater than or equal to 50 weight percent of the total weight of the polyamide, of a polyamide having a melting temperature within 35%, or more specifically within 25%, or, even more specifically, within 15% of the glass transition temperature (Tg) of the poly(arylene ether). As used herein having a melting temperature within 35% of the glass transition temperature of the polyarylene ether is defined as having a melting temperature that is greater than or equal to (0.65×Tg of the poly(arylene ether)) and less than or equal to (1.35×Tg of the poly(arylene ether)).

The composition comprises polyamide in an amount sufficient to form a continuous or co-continuous phase of the composition. The amount of polyamide can be 30 to 85 weight percent. Within this range, the polyamide may be present in an amount greater than or equal to 33 weight percent, or, more specifically, in an amount greater than or equal to 38 weight percent, or, even more specifically, in an amount greater than or equal to 40 weight percent. Also within this range, the polyamide may be present in an amount less than or equal to 60 weight percent, or, more specifically, less than or equal to 55 weight percent, or, even more specifically, less than or equal to 50 weight percent. Weight percent is based on the total weight of the thermoplastic composition.

In some embodiments, the poly(arylene ether) composition described herein comprises at least two phases, a aliphatic-aromatic polyamide phase and a poly(arylene ether) phase. The aliphatic-aromatic polyamide phase is continuous and the poly(arylene ether) phase is dispersed in the aliphatic-aromatic polyamide phase. The compatibilized blends of poly(arylene ether) and aliphatic-aromatic polyamide can be made using a polymeric compatibilizer having epoxy groups. The compatibilized blend can be made using an aliphatic-aromatic polyamide having an amine end group content less than 45 micromoles per gram of polyamide.

The poly(arylene ether) compositions described herein can have poly(arylene ether) domains with a size of 0.25 to 5 micrometers. In some embodiments the poly(arylene ether) domains have a mean domain size of 0.5 to 3 micrometers. In some embodiments the standard deviation of the mean domain size is less than 2.0. Less than or equal to 3%, or, more specifically, less than or equal to 1% of the poly(arylene ether) domains are greater than or equal to 5 micrometers. This is in comparison to comparable compositions free of the polymeric compatibilizer, which have poly(arylene ether) domain sizes of 1 to 12 micrometers, a mean domain size of 1.5 to 7 micrometers with a standard deviation greater than 2, and greater than 10% of the poly(arylene ether) domains are greater than or equal to 5 micrometers.

Additionally, the poly(arylene ether) domain size of the thermoplastic compositions described herein is stable and in some embodiments shows less than or equal to a 10% increase after annealing at 310° C. for 8 minutes.

The aliphatic-aromatic polyamide comprises units derived from one or more diamines. 60 to 100 mol % of the diamine units, based on the total moles of diamine units, are derived from 1,9-nonanediamine units, 2-methyl-1,8-octanediamine units, or a combination thereof. Within this range the amount of 1,9-nonanediamine units, 2-methyl-1,8-octanediamine units, or combination thereof may be greater than or equal to 75 mol %, or, more specifically, greater than or equal to 90 mol %.

The molar ratio of the 1,9-nonanediamine units to the 2-methyl-1,8-octanediamine units may be 100:0 to 20:80, or, more specifically, 100:0 to 50:50, or, even more specifically, 100:0 to 50:40. This can be referred to as the N/I ratio.

Examples of other diamine units that may be used in addition to the 1,9-nonanediamine units and/or 2-methyl-1,8-octanediamine units include units derived from linear aliphatic diamines such as 1,6-hexanediamine, 1,7-heptanediamine, 1,8-octanediamine, 1,10-decanediamine, 1,11-undecanediamine and 1,12-dodecanediamine; branched aliphatic diamines such as 2-methyl-1,5-pentanediamine, 3-methyl-1,5-pentanediamine, 2,2,4-trimethyl-1,6-hexanediamine, 2,4,4-trimethyl-1,6-hexanediamine and 5-methyl-1,9-nonanediamine; alicyclic diamines such as cyclohexanediamine, methylcyclohexanediamine, isophoronediamine, bis(4-aminocyclohexyl)methane, norbornanedimethylamine and tricyclodecanedimethylamine; and aromatic diamines such as p-phenylenediamine, m-phenylenediamine, m-xylylenediamine, p-xylylenediamine, 4,4′-diaminodiphenylsulfone and 4,4′-diaminodiphenyl ether. These can be used singly or in combinations of two or more types. In some embodiments, units derived from 1,6-hexanediamine, 1,7-heptanediamine, 1,8-octanediamine, 1,10-decanediamine and/or 1,12-dodecanediamine are combined with the 1,9-nonanediamine units, 2-methyl-1,8-octanediamine units, or combination thereof.

The aliphatic-aromatic polyamide can be manufactured by any known method for manufacturing crystalline polyamides. For example, it can be manufactured by solution polymerization or interfacial polymerization in which an acid chloride and a diamine are used as raw materials, or by melt polymerization, solid-phase polymerization, or melt extrusion polymerization in which a dicarboxylic acid and a diamine are used as raw materials.

The intrinsic viscosity of the aliphatic-aromatic polyamide, measured in concentrated sulfuric acid at 30° C., may be 0.4 to 3.0 dl/g, or, more specifically, 0.5 to 2.0 dl/g, or, even more specifically, 0.6 to 1.8 dl/g.

The melt viscosity of the aliphatic-aromatic polyamide may be 300 to 3500 poise at a shear rate of 1000 s−1 and a temperature of 330° C., as measured by capillary viscometry. Within this range, the melt viscosity may be greater than or equal to 325, or, more specifically, greater than or equal to 350 poise. Also within this range, the melt viscosity may be less than or equal to 3300, or, more specifically, less than or equal to 3100 poise.

The aliphatic-aromatic polyamide can have an amine end group content less than or equal to 45 micromoles per gram of polyamide. Amine end group content may be determined by dissolving the polyamide in a suitable solvent, optionally with heat. The polyamide solution is titrated with 0.01 Normal hydrochloric acid (HCl) solution using a suitable indication method. The amount of amine end groups is calculated based the volume of HCl solution added to the sample, the volume of HCl used for the blank, the molarity of the HCl solution and the weight of the polyamide sample. It is explicitly contemplated that an aliphatic-aromatic polyamide having an amine end group content greater than 45 micromoles per gram of polyamide could also be used successfully in the compositions described herein.

The compatibilized blend may additionally comprise an aliphatic polyamide such as nylon 6, 6/6, 6/69, 6/10, 6/12, 11, 12, 4/6, 6/3, 7, 8, 6T, modified 6T, polyphthalamides (PPA), and combinations of two or more of the foregoing.

The composition may contain aliphatic-aromatic polyamide in an amount of 35 weight percent to 80 weight percent based on the total weight of the composition. Within this range the amount of aliphatic-aromatic polyamide may be greater than or equal to 37, or, more specifically, greater than or equal to 38 weight percent. Also within this range the amount of aliphatic-aromatic polyamide may be less than or equal to 70, or, more specifically, less than or equal to 60 weight percent.

The compatibilized poly(arylene ether)/aliphatic-aromatic polyamide blend is formed using a functionalizing agent. When used herein, the expression “functionalizing agent” refers to polyfunctional compounds, which interact with the poly(arylene ether), the polyamide resin, or both. This interaction may be chemical (e.g., grafting) and/or physical (e.g., affecting the surface characteristics of the dispersed phases). In either instance the resulting compatibilized poly(arylene ether)/polyamide composition appears to exhibit improved compatibility, particularly as evidenced by enhanced impact strength, mold knit line strength and/or elongation. As used herein, the expression “compatibilized poly(arylene ether)/aliphatic-aromatic polyamide blend” refers to those compositions which have been physically and/or chemically compatibilized with a polymeric compatibilizing agent and a functionalizing agent.

The functionalizing agent comprises a polyfunctional compound that is one of two types. The first type has in the molecule both (a) a carbon-carbon double bond and (b) at least one carboxylic acid, anhydride, epoxy, imide, amide, ester group or functional equivalent thereof. Examples of such polyfunctional compounds include maleic acid; maleic anhydride; fumaric acid; maleic hydrazide; dichloro maleic anhydride; and unsaturated dicarboxylic acids (e.g. acrylic acid, butenoic acid, methacrylic acid, t-ethylacrylic acid, pentenoic acid). In some embodiments, the functionalizing agent comprises maleic anhydride and/or fumaric acid.

The second type of polyfunctional functionalizing agent compounds are characterized as having both (a) a group represented by the formula (OR) wherein R is hydrogen or an alkyl, aryl, acyl or carbonyl dioxy group and (b) at least two groups each of which may be the same or different selected from carboxylic acid, acid halide, anhydride, acid halide anhydride, ester, orthoester, amide, imido, amino, and salts thereof. Typical of this type of functionalizing agents are the aliphatic polycarboxylic acids, acid esters and acid amides represented by the formula:

(R^{I}O)ₘR(COOR^{II})ₙ(CONR^{III}R^{IV}),

wherein R is a linear or branched chain saturated aliphatic hydrocarbon having 2 to 20, or, more specifically, 2 to 10 carbon atoms; R^{I} is hydrogen or an alkyl, aryl, acyl or carbonyl dioxy group having 1 to 10, or, more specifically, 1 to 6, or, even more specifically, 1 to 4 carbon atoms; each R^{II} is independently hydrogen or an alkyl or aryl group having 1 to 20, or, more specifically, 1 to 10 carbon atoms; each R^{III} and R^{IV} are independently hydrogen or an alkyl or aryl group having 1 to 10, or, more specifically 1 to 6, or, even more specifically, 1 to 4, carbon atoms; m is equal to 1 and (n+s) is greater than or equal to 2, or, more specifically, equal to 2 or 3, and n and s are each greater than or equal to zero and wherein (OR) is alpha or beta to a carbonyl group and at least two carbonyl groups are separated by 2 to 6 carbon atoms. Each of R^{I}, R^{II}, R^{III} and R^{IV} cannot be aryl when the respective substituent has less than 6 carbon atoms.

Suitable polycarboxylic acids include, for example, citric acid, malic acid, agaricic acid; including the various commercial forms thereof, such as for example, the anhydrous and hydrated acids; and combinations comprising one or more of the foregoing. In some embodiments, the functionalizing agent comprises citric acid. Illustrative of esters useful herein include, for example, acetyl citrate and mono- and/or distearyl citrates and the like. Suitable amides useful herein include, for example, N,N′-diethyl citric acid amide; N-phenyl citric acid amide; N-dodecyl citric acid amide; N,N′-didodecyl citric acid amide and N-dodecyl malic acid. Derivates include the salts thereof, including the salts with amines and the alkali and alkaline metal salts. Exemplary suitable salts include calcium malate, calcium citrate, potassium malate, and potassium citrate.

The foregoing functionalizing agents may be added directly to the melt blend or pre-reacted with either or both the poly(arylene ether) and polyamide. In some embodiments, at least a portion of the functionalizing agent is pre-reacted, either in the melt or in a solution of a suitable solvent, with all or a part of the poly(arylene ether). It is believed that such pre-reacting may cause the functionalizing agent to react with the polymer and, consequently, functionalize the poly(arylene ether). For example, the poly(arylene ether) may be pre-reacted with maleic anhydride, fumaric acid and/or citric acid to form an anhydride and/or acid functionalized poly(arylene ether), which has improved compatibility with the polyamide compared to a non-functionalized poly(arylene ether).

The amount of the functionalizing agent used will be dependent upon the specific functionalizing agent chosen and the specific polymeric system to which it is added.

In some embodiments, the functionalizing agent is employed in an amount of 0.05 to 2.0 weight percent, based on the total weight of the composition. Within this range the amount of functionalizing agent may be greater than or equal to 0.1, or, more specifically, greater than or equal to 0.2 weight percent. Also within this range the amount of functionalizing agent may be less than or equal to 1.75, or, more specifically, less than or equal to 1.5 weight percent.

The poly(arylene ether) composition also comprises an impact modifier. In some embodiments the impact modifier resides primarily in the poly(arylene ether) phase. Examples of suitable impact modifiers include block copolymers; elastomers such as polybutadiene; random copolymers such as ethylene vinyl acetate (EVA); and combinations comprising two or more of the foregoing impact modifiers.

Exemplary block copolymers include A-B diblock copolymers and A-B-A triblock copolymers having one or two blocks A, which comprise structural units derived from an alkenyl aromatic monomer, for example styrene; and a rubber block, B, which generally comprises structural units derived from a diene such as isoprene or butadiene. The diene block may be partially hydrogenated. Mixtures of these diblock and triblock copolymers are especially useful.

Suitable A-B and A-B-A copolymers include, but are not limited to, polystyrene-polybutadiene; polystyrene-poly(ethylene-butylene); polystyrene-polyisoprene; polystyrene-poly(ethylene-propylene); poly(alpha-methylstyrene)-polybutadiene; poly(alpha-methylstyrene)-poly(ethylene-butylene); polystyrene-polybutadiene-polystyrene (SBS); polystyrene-poly(ethylene-butylene)-polystyrene (SEBS); polystyrene-polyisoprene-polystyrene; polystyrene-poly(ethylene-propylene)-polystyrene; poly(alpha-methylstyrene)-polybutadiene-poly(alpha-methylstyrene); as well as selectively hydrogenated versions thereof, and the like, as well as combinations comprising two or more of the foregoing impact modifiers. Such A-B and A-B-A block copolymers are available commercially from a number of sources, including Phillips Petroleum under the trademark SOLPRENE, Kraton Polymers, under the trademark KRATON, Dexco under the trademark VECTOR, and Kuraray under the trademark SEPTON.

In some embodiments, the impact modifier may primarily reside in the polyamide phase. Examples of suitable impact modifiers for the polyamide phase include functionalized elastomeric polyolefins containing at least one functional group selected from the group consisting of carboxylic acid groups, esters, acid anhydrides, epoxy groups, oxazoline groups, carbodiimide groups, isocyanate groups, silanol groups, carboxylates, and combinations of two or more of the foregoing functional groups. The elastomeric polyolefin is a polyolefin miscible with the polyamide and includes linear random copolymers, linear block copolymer and core-shell type copolymers wherein the shell is miscible with polyamide and comprises a functional group reactive with the polyamide. Exemplary polyolefins include polyethylene, ethylene-vinyl acetate copolymer (EVA), ethylene-ethylacrylate copolymer (EEA), ethylene-octane copolymer, ethylene-propylene copolymer, ethylenebutene copolymer, ethylene-hexene copolymer, or ethylene-propylene-diene terpolymers. Monomers comprising the functional group may be graft-polymerized with the polyolefin or co-polymerized with the polyolefin monomers. In one embodiment the structural units of the elastomeric polyolefin are derived from ethylene and at least one C3 olefin, such as, propylene, 1-butene, 1-hexene, and 1-octene. Also suitable as impact modifiers for the polyamide phase are core-shell type graft copolymers and ionomer resins, which may be wholly or partially neutralized with metal ions. In general, the core-shell type graft copolymers have a predominantly conjugated diene or crosslinked acrylate rubbery core and one or more shells polymerized thereon and derived from monoalkenylaromatic and/or acrylic monomers alone or in combination with other vinyl monomers. Other impact modifiers include the above-described types containing units having polar groups or active functional groups, as well as miscellaneous polymers such as Thiokol rubber, polysulf de rubber, polyurethane rubber, polyether rubber (e.g., polypropylene oxide), epichlorohydrin rubber, ethylene-propylene rubber, thermoplastic polyester elastomers, thermoplastic ether-ester elastomers, and the like, as well as mixtures comprising any one of the foregoing. Specially preferred ionomer resins include those sold under the trade name SURLYN by DuPont.

The impact modifier can be present in an amount of 5 weight percent to 35 weight percent, based on the total weight of the composition. Within this range, the impact modifier may be present in an amount greater than or equal to 10 weight percent, or, more specifically, greater than or equal to 15 weight percent. Also within this range, the impact modifier may be present in an amount less than or equal to 30 weight percent, or, more specifically, less than or equal to 25 weight percent, or, even more specifically, less than or equal to 20 weight percent. The exact amount and types or combinations of impact modifiers utilized will depend in part on the requirements needed in the final blend composition and may be determined by those skilled in the art.

In addition to the poly(arylene ether), aliphatic-aromatic polyamide, and impact modifier, the poly(arylene ether) composition is made using a polymeric compatibilizer having an average of greater than or equal to 3 epoxy groups per molecule. In some embodiments the polymeric compatibilizer has an average of greater than or equal to 6 epoxy groups per molecule, or, more specifically, an average of greater than or equal to 8 epoxy groups per molecule or, more specifically, an average of greater than or equal to 10 epoxy groups per molecule. As used herein and throughout, a polymeric compatibilizer is a polymeric polyfunctional compound that interacts with the poly(arylene ether), the aliphatic-aromatic polyamide, or both. This interaction may be chemical (e.g. grafting) and/or physical (e.g. affecting the surface characteristics of the disperse phases). When the interaction is chemical, the compatibilizer may be partially or completely reacted with the poly(arylene ether), aliphatic-aromatic polyamide, or both such that the composition comprises a reaction product. For example, the epoxy groups may react with acid groups present on the aliphatic-aromatic polyamide, the functional groups on the functionalized poly(arylene ether), or both during melt blending. Use of the polymeric compatibilizer can improve the compatibility between the poly(arylene ether) and the aliphatic-aromatic polyamide, as may be evidenced by enhanced impact strength, mold knit line strength, elongation and/or the formation of a distinctive two phase morphology. Such morphology is evidenced by the occurrence of two distinct phases within a molded part; a continuous phase comprising aliphatic-aromatic polyamide and a disperse phase comprising poly(arylene ether). The disperse phase domains can have a mean domain size of 0.5 to 3 micrometers. The average domain diameter is the average circular diameter of at least 50 domain and may be determined by scanning electron microscopy or by transmission electron microscopy. In the case of elliptical domains “circular diameter” is the mean of the major and minor axis of each domain. In other words, the diameters of the circumcircle and incircle are averaged for each elliptical domain.

Illustrative examples of suitable compatibilizers include, but are not limited to, copolymers of glycidyl methacrylate (GMA) with alkenes, copolymers of GMA with alkenes and acrylic esters, copolymers of GMA with alkenes and vinyl acetate, copolymers of GMA and styrene. Suitable alkenes comprise ethylene, propylene, and mixtures of two or more of the foregoing. Suitable acrylic esters comprise alkyl acrylate monomers, including, but not limited to, methyl acrylate, ethyl acrylate, propyl acrylate, butyl acrylate, and combinations of the foregoing alkyl acrylate monomers. When present, the acrylic ester may be used in an amount of 15 weight percent to 35 weight percent based on the total amount of monomer used in the copolymer. When present, vinyl acetate may be used in an amount of 4 weight percent to 10 weight percent based on the total amount of monomer used in the copolymer. Illustrative examples of suitable compatibilizers comprise ethylene-glycidyl acrylate copolymers, ethylene-glycidyl methacrylate copolymers, ethylene-glycidyl methacrylate-vinyl acetate copolymers, ethylene-glycidyl methacrylate-alkyl acrylate copolymers, ethylene-glycidyl methacrylate-methyl acrylate copolymers, ethylene-glycidyl methacrylate-ethyl acrylate copolymers, and ethylene-glycidyl methacrylate-butyl acrylate copolymers.

The composition comprises 0.1 weight percent to 20 weight percent of polymeric compatibilizer, based on the total weight of the composition. Within this range, the composition can comprise less than or equal to 15 weight percent, or, more specifically less than or equal to 10 weight percent, or, even more specifically, less than or equal to 8 weight percent compatibilizer. Also within this range, the composition may comprise greater than or equal to 0.5 weight percent, or, more specifically, greater than or equal to 1 weight percent polymeric compatibilizer.

The foregoing polymeric compatibilizer may be added directly to the composition or pre-reacted with either or both of the poly(arylene ether) and aliphatic-aromatic polyamide, as well as with other materials employed in the preparation of the composition. The initial amount of the compatibilizer used and order of addition will depend upon the specific compatibilizer chosen and the specific amounts of poly(arylene ether) and aliphatic-aromatic polyamide employed.

The poly(arylene ether) composition may also comprise additives known in the art. Possible include anti-oxidants, dyes, pigments, colorants, stabilizers, flame retardants, drip retardants, crystallization nucleators, metal salts, antistatic agents, plasticizers, lubricants, and combinations comprising two or more of the foregoing additives. These additives are known in the art, as are their effective levels and methods of incorporation. Effective amounts of the additives vary widely, but they are usually present in an amount of less than or equal to 50 weight percent, based on the total weight of the composition. Amounts of these additives are generally 0.25 weight percent to 2 weight percent, based upon the total weight of the composition. The effective amount can be determined by those skilled in the art without undue experimentation.

The poly(arylene ether) composition may also comprise fillers as known in the art. Fillers may include reinforcing fillers. Exemplary fillers include small particle minerals (e.g., clay, mica, talc, and the like), glass fibers, nanoparticles, organoclay, and the like and combinations comprising one or more of the foregoing fillers. Fillers are typically used in amounts of 5 weight percent to 50 weight percent, based on the total weight of the composition.

The poly(arylene ether) composition can be prepared using various techniques, including batch or continuous techniques that employ kneaders, extruders, mixers, and the like. For example, the composition can be formed as a melt blend employing a twin-screw extruder. In some embodiments at least some of the components are added sequentially. For example, the poly(arylene ether), the impact modifier, and functionalizing agent may be added to the extruder at the feed throat or in feeding sections adjacent to the feed throat, while the aliphatic-aromatic polyamide and polymeric compatibilizer, may be added to the extruder in a subsequent feeding section downstream. When a functionalized poly(arylene ether) is used the functionalized poly(arylene ether) and impact modifier may be added to the extruder at the feed throat or in feeding sections adjacent to the feed throat, while the aliphatic-aromatic polyamide and polymeric compatibilizer may be added to the extruder in a subsequent feeding section downstream. A vacuum system may be applied to the extruder, prior to the second sequential addition, to generate a sufficient vacuum to lower the residual levels of non-reacted functionalizing agent and any other volatile materials. In an alternative embodiment, the sequential addition of the components may be accomplished through multiple extrusions. A composition may be made by preextrusion of selected components, such as the poly(arylene ether), the impact modifier and the functionalizing agent to produce a pelletized mixture. A second extrusion may then be employed to combine the preextruded components with the remaining components. The extruder may be a two lobe or three lobe twin screw extruder. It is contemplated that a three lobe extruder may yield a composition with significantly higher notched Izod and nominal strain at break values when compared to compositionally identical compositions made using a two lobe twin screw extruder.

In some embodiments, the poly(arylene ether) composition suitable for the present invention may be selected from the group consisting of Noryl resins from SABIC Innovative Plastics; Xyron resins from Asahi Kasei Chemicals Corporation, Japan; Iupiace resins from Mitsubishi, Japan; Lemalloy resins from Mitsubishi, Japan; Polyphenyl Ether resins from Bluestar, China; Acnor resins from Aquafil Technopolymers, Italy; Ashlene resins from Ashley Polymers, USA; Vestoran resins from Evonik Degussa, Germany; and any variants of the foregoing resins.

The poly(arylene ether) composition can be recycled by reusing material, which has already been formed into an article. To reuse the material the article is reduced to particles of a size suitable for reprocessing. Particle size is generally determined by the reprocessing method (e.g., injection molding, extrusion molding, and the like) and may be determined by one of ordinary skill in the art. Exemplary methods of reducing an article to particles include chopping, grinding, and combinations thereof. A “recycle” is defined as reducing an already formed article to particles and using the particles to make a new article. The poly(arylene ether) composition, after 1 to 10 recycles, can have a tensile strength that is greater than or equal to 100% of the tensile strength of the virgin material. Tensile strength, as used herein, is determined by ASTM D 412-98a. More specifically, the recycled composition, after 1 to 10 recycles, has a tensile strength that is greater than or equal to 12 MPa, or, more specifically, greater than or equal to 13 MPa, or, even more specifically, greater than or equal to 14 MPa.

Additionally, the poly(arylene ether) composition, after 1 to 10 recycles, has an ultimate elongation that is greater than or equal to the ultimate elongation of the virgin material when determined as described above. More specifically, the recycled material, without filler and after 1 to 10 recycles, has an ultimate elongation of 150% to 350%. Within this range the ultimate elongation is greater than or equal to 160%, or, even more specifically, greater than or equal to 170%.

The poly(arylene ether) composition, after 1 to 10 recycles, has a tensile modulus at 50% elongation that is greater than or equal to the tensile modulus at 50% elongation of the virgin material when determined as described above. More specifically, the recycled composition, after 1 to 10 recycles, can have a tensile modulus at 50% of the ultimate elongation of 12 Megapascals (MPa) to 25 MPa. Within this range the recycled composition may have a tensile modulus greater than or equal to 14 MPa, or, more specifically, greater than or equal to 16 MPa.

In some of the embodiments, the poly(arylene ether) composition can be formed as a melt blend employing a twin-screw extruder. After some or all the components are melt mixed, the molten mixture can be melt filtered through one of more filters. In some embodiments the one or more filters have openings with diameters of 20 micrometers to 150 micrometers. Within this range, the openings may have diameters less than or equal to 130 micrometers, or, more specifically, less than or equal to 110 micrometers. Also within this range the openings can have diameters greater than or equal to 30 micrometers, or, more specifically, greater than or equal to 40 micrometers.

In some embodiments, the filter openings have a maximum diameter that is less than or equal to half of the thickness of the covering that will be applied to the conductor. For example, if the covered conductor has a covering with a thickness of 200 micrometers, the filter openings have a maximum diameter less than or equal to 100 micrometers.

Any suitable melt filtration system or device that can remove particulate impurities from the molten mixture may be used. In some embodiments the melt is filtered through a single melt filtration system. Multiple melt filtration systems are also contemplated.

Suitable melt filtration systems include filters made from a variety of materials such as, but not limited to, sintered-metal, metal mesh or screen, fiber metal felt, ceramic, or a combination of the foregoing materials, and the like. Particularly useful filters are sintered metal filters exhibiting high tortuosity, including the sintered wire mesh filters prepared by Pall Corporation and Martin Kurz & Company, Inc.

In some embodiments, the melt filtered mixture is passed through a die head and pelletized by either strand pelletization or underwater pelletization. The pelletized material may be packaged, stored and transported. In some embodiments the pellets are packaged into metal foil lined plastic bags, typically polypropylene bags, or metal foil lined paper bags. Substantially all of the air can be evacuated from the pellet filled bags.

In some embodiments, the poly(arylene ether) composition is substantially free of visible particulate impurities. Visible particulates or “black specks” are dark or colored particulates generally visible to the human eye without magnification and having an average diameter of 40 micrometers or greater. Although some people are able to without magnification visually detect particles having an average diameter smaller than 30 micrometers and other people can detect only particles having an average diameter larger than 40 micrometers, the terms “visible particles,” “visible particulates,” and “black specks” when used herein without reference to a specified average diameter means those particulates having an average diameter of 40 micrometers or greater. As used herein, the term “substantially free of visible particulate impurities” when applied to the thermoplastic composition means that when the composition is injection molded to form 5 plaques having dimensions of 75 millimeters×50 millimeters and having a thickness of 3 millimeters and the plaques are visually inspected for black specks with the naked eye the total number of black specks for all five plaques is less than or equal to 100, or, more specifically, less than or equal to 70, or, even more specifically, less than or equal to 50.

In some embodiments, the injection molded test specimens made from the poly(arylene ether) composition may be resistant to degradation of (decrease in) tensile strength when subjected to elevated temperatures for extended periods of time. In one embodiment, when injection molded test specimens of the composition are heat aged at 80° C. for 500 hours the specimens have a tensile strength that is greater than or equal to 80%, or, more specifically, greater than or equal to 90%, or, even more specifically, greater than or equal to 95% of the tensile strength prior to heat aging. Tensile strength testing is performed as described above.

In some embodiments, the pellets are melted and the poly(arylene ether) composition applied to the conductor by a suitable method such as extrusion coating to form a covered conductor. After the pellets are melted, the molten mixture can be melt filtered through one of more filters before coating the conductor. For example, a coating extruder equipped with a screw, optionally a melt filter, crosshead, breaker plate, distributor, nipple, and die can be used. The melted poly(arylene ether) composition forms a covering disposed over a circumference of the conductor. Extrusion coating may employ a single taper die, a double taper die, other appropriate die or combination of dies to position the conductor centrally and avoid die lip build up.

In some embodiments, the poly(arylene ether) composition is applied to the conductor to form a covering disposed over the conductor. Additional layers may be applied to the covering.

In some embodiments the composition is applied to a conductor having one or more intervening layers between the conductor and the covering to form a covering disposed over the conductor. For instance, an optional adhesion promoting layer may be disposed between the conductor and covering. In another example the conductor may be coated with a metal deactivator prior to applying the covering. In another example the intervening layer comprises a thermoplastic or thermoset composition that, in some cases, is foamed.

In some embodiments, a covered conductor comprising a conductor and a covering, wherein the covering is disposed over the conductor, wherein the conductor comprises aluminum or an alloy comprising aluminum, wherein the covering comprises a poly(arylene ether) composition and wherein, the covering has a thickness from about 0.01 to about 8 mm.

In some embodiments it may be useful to dry the poly(arylene ether) composition before extrusion coating. Exemplary drying conditions are 60-90° C. for 2-20 hours. Additionally, in some embodiments, during extrusion coating, the poly(arylene ether) composition is melt filtered, prior to formation of the coating, through one or more filters having opening diameters of 20 micrometers to 150 micrometers. Within this range, the openings diameters may be greater than or equal to 30 micrometers, or more specifically greater than or equal to 40 micrometers. Also within this range the openings diameters may be less than or equal to 130 micrometers, or, more specifically, less than or equal to 110 micrometers. The coating extruder may comprise one or more filters as described above.

In some embodiments, during extrusion coating, the poly(arylene ether) composition is melt filtered, prior to formation of the coating, through one or more filters having opening diameters wherein the filter openings have a maximum diameter that is less than or equal to half of the thickness of the covering that will be applied to the conductor.

In another embodiment, the melt filtered mixture produced by melt mixing is not pelletized. Rather the molten melt filtered mixture is formed directly into a coating for the conductor using a coating extruder that is in tandem with the melt mixing apparatus, typically a compounding extruder. The coating extruder may comprise one or more filters as described above.

In some embodiments, it is contemplated that a sheet of the thermoplastic composition is made separately. Multiple conductors will be line in parallel between two of the sheet of the poly(arylene ether) composition and pressed together to make a so-called “Ribbon wires”.

It is contemplated that in some embodiments the poly(arylene ether) composition may be extruded or otherwise formed into a tube that will provide a covering. The conductor and optional intervening layer may be inserted into the tube to form the covered conductor.

A color concentrate or masterbatch may be added to the poly(arylene ether) composition prior to or during the extrusion coating. When a color concentrate is used it is typically present in an amount less than or equal to 3 weight percent, based on the total weight of the composition. In some embodiments dye and/or pigment employed in the color concentrate is free of chlorine, bromine, and fluorine. As appreciated by one of skill in the art, the color of the poly(arylene ether) composition prior to the addition of color concentrate may impact the final color achieved and in some cases it may be advantageous to employ a bleaching agent and/or color stabilization agents. Bleaching agents and color stabilization agents are known in the art and are commercially available.

The extruder temperature during extrusion coating is generally less than or equal to 320° C., or, more specifically, less than or equal to 310° C., or, more specifically, less than or equal to 290° C. Additionally the processing temperature is adjusted to provide a sufficiently fluid molten composition to afford a covering for the conductor, for example, higher than the melting point of the poly(arylene ether) composition, or more specifically at least 10° C. higher than the melting point of the poly(arylene ether) composition.

After extrusion coating the covered conductor is usually cooled using a water bath, water spray, air jets, or a combination comprising one or more of the foregoing cooling methods. Exemplary water bath temperatures are 20 to 85° C.

Alternatively the poly(arylene ether) composition may be molded or extruded to form articles such as films, sheets, tapes, or any other component of wire harness assemblies when it is desirable for such articles to have combination of chemical resistance, heat aging, abrasion resistance and impact strength.

The invention includes the following embodiments:

In some of the embodiments, the poly(arylene ether) composition comprises a dispersed phase comprising polyarylene ether, and a continuous phase comprising an other polymer. The other polymer may comprise a crystalline, a semi-crystalline, an amorphous polymer, or a mixture thereof. The poly(arylene ether) and the other polymer are essentially not identical. Examples of the other polymer that can be used in the poly(arylene ether) composition include polyolefins, polystyrenes, polyesters, polyamides, polyphenylene sulfides, polyarylene sulfides, polyarylsulfones, polyethersulfones, polysulfones, polyether etherketones, polyetherketones, polyether ketone ketones, polyimides, polyetherimides, polyamideimides, polyarylates, polycarbonates, polyacetals, polyacrylics, polyarylates, polytetrafluoroethylenes, polybenzoxazoles, polyphthalides, polyanhydrides, polyvinyl ethers, polyvinyl thioethers, polyvinyl alcohols, polyvinyl ketones, polyvinyl halides, polyvinyl chlorides, polyvinyl nitriles, polyvinyl esters, polysulfonates, polysulfides, polythioesters, polysulfonamides, polyureas, polyphosphazenes, polysilazanes, polyethylene terephthalate, polybutylene terephthalate, polyurethane, polytetrafluoroethylene, fluorinated ethylene propylene, perfluoroalkoxyethylene, polychlorotrifluoroethylene, polyvinylidene fluoride, or the like, or a combination comprising at least one of the foregoing polymers.

In some of the embodiments, the poly(arylene ether) composition, optionally, comprises a compatibilizer, a flame retardant described herein, or a combination of a compatibilizer and a flame retardant described herein. In some of the embodiments, the poly(arylene ether) composition, optionally, further comprises a dispersed phase modifier, a continuous phase modifier, an other modifier, or a combination comprising at least one of the foregoing components.

In some of the embodiments, the poly(arylene ether) composition has a higher limit for the poly(arylene ether) defined herein as H_{PAE}, and a lower limit for the poly(arylene ether) defined herein as L_{PAE}. The higher limit for the poly(arylene ether) (H_{PAE}) in the poly(arylene ether) compositions can be in the range of 30 weight percent to 80 weight percent. Weight percent is with regard to the total weight of the composition. Within this range the H_{PAE} can be less than 70 weight percent, preferably less than 60 weight percent, more preferably less than 50 weight percent, and even more preferably less than 45 weight percent. The lower limit for the poly(arylene ether) (L_{PAE}) in the poly(arylene ether) compositions can be in the range of 1 weight percent to 40 weight percent. Within this range the L_{PAE} can be greater than 5 weight percent, preferably greater than 10 weight percent, more preferably greater than 20 weight percent, and even more preferably greater than 30 weight percent.

In some of the embodiments, the poly(arylene ether) composition, when comprises the other polymer, may have a higher limit for the other polymer defined herein as H_{OP}, and a lower limit for the other polymer defined herein as L_{OP}. The higher limit for the other polymer (H_{OP}) in the poly(arylene ether) compositions can be in the range of 20 weight percent to 80 weight percent. Weight percent is with regard to the total weight of the composition. Within this range the H_{OP} can be less than 70 weight percent, preferably less than 60 weight percent, more preferably less than 50 weight percent, and even more preferably less than 45 weight percent. The lower limit for the other polymer (L_{OP}) in the poly(arylene ether) compositions can be in the range of 1 weight percent to 45 weight percent. Within this range the L_{OP} can be greater than 10 weight percent, preferably greater than 10 weight percent, more preferably greater than 30 weight percent, and even more preferably greater than 40 weight percent.

In some of the embodiments, the poly(arylene ether) composition, when comprises the flame retardant, may have a higher limit for the flame retardant defined herein as H_{FR}, and a lower limit for the flame retardant defined herein as L_{FR}. The higher limit for the flame retardant (H_{FR}) in the poly(arylene ether) compositions can be in the range of 20 weight percent to 45 weight percent. Weight percent is with regard to the total weight of the composition. Within this range the H_{FR} can be less than 40 weight percent, preferably less than 35 weight percent, more preferably less than 30 weight percent, and even more preferably less than 25 weight percent. The lower limit for the flame retardant (L_{FR}) in the poly(arylene ether) compositions can be in the range of 1 weight percent to 25 weight percent. Within this range the L_{FR} can be greater than 5 weight percent, preferably greater than 10 weight percent, more preferably greater than 15 weight percent, and even more preferably greater than 20 weight percent.

In some of the embodiments, the poly(arylene ether) composition, when comprises the compatibilizer, may have a higher limit for the compatibilizer defined herein as H_{COM}, and a lower limit for the compatibilizer defined herein as L_{COM}. The higher limit for the compatibilizer (H_{COM}) in the poly(arylene ether) compositions can be in the range of 25 weight percent to 60 weight percent. Weight percent is with regard to the total weight of the composition. Within this range the H_{COM} can be less than 55 weight percent, preferably less than 50 weight percent, more preferably less than 40 weight percent, and even more preferably less than 30 weight percent. The lower limit for the compatibilizer (L_{COM}) in the poly(arylene ether) compositions can be in the range of 1 weight percent to 30 weight percent. Within this range the L_{COM} can be greater than 5 weight percent, preferably greater than 10 weight percent, more preferably greater than 15 weight percent, and even more preferably greater than 20 weight percent.

In some of the embodiments, the poly(arylene ether) composition may comprise a dispersed phase modifier, wherein the dispersed phase modifier may primarily reside in the dispersed phase comprising polyarylene ether, and the interface between the dispersed phase and the continuous phase. Examples of the dispersed phase modifier that can be used in the poly(arylene ether) composition include the styrenic block copolymers, the hydrogenated styrenic block copolymers, the elastomers such as polybutadiene, random copolymers such as ethylene vinyl acetate (EVA) described herein. In some embodiments, the dispersed phase modifier can be the impact modifier described herein. In some of the embodiments, the poly(arylene ether) composition, when comprises the dispersed phase modifier, may have a higher limit for the dispersed phase modifier defined herein as H_{DPM}, and a lower limit for the dispersed phase modifier defined herein as L_{DPM}. The higher limit for the dispersed phase modifier (H_{DPM}) in the poly(arylene ether) compositions can be in the range of 25 weight percent to 60 weight percent. Weight percent is with regard to the total weight of the composition. Within this range the H_{DPM} can be less than 55 weight percent, preferably less than 50 weight percent, more preferably less than 40 weight percent, and even more preferably less than 30 weight percent. The lower limit for the dispersed phase modifier (L_{DPM}) in the poly(arylene ether) compositions can be in the range of 1 weight percent to 30 weight percent. Within this range the L_{DPM} can be greater than 5 weight percent, preferably greater than 10 weight percent, more preferably greater than 15 weight percent, and even more preferably greater than 20 weight percent.

In some of the embodiments, the poly(arylene ether) composition may comprise a continuous phase modifier, wherein the continuous phase modifier may primarily reside in the continuous phase comprising the other polymer, and the interface between the dispersed phase and the continuous phase. Examples of the continuous phase modifier that can be used in the poly(arylene ether) composition include the functional impact modifiers, epoxy functional core-shell polymers, co- or ter-polymers including units of ethylene and glycidyl methacrylate (GMA), terpolymers made of ethylene, butyl acrylate and glycidyl methacrylate, ethylene-vinyl acetate copolymer (EVA), ethylene-ethylacrylate copolymer (EEA), ethylene-octane copolymer, ethylene-propylene copolymer, ethylenebutene copolymer, ethylene-hexene copolymer, or ethylene-propylene-diene terpolymers. In some embodiments, the continuous phase modifier can be the impact modifier described herein. In some of the embodiments, the poly(arylene ether) composition, when comprises the continuous phase modifier, may have a higher limit for the continuous phase modifier defined herein as H_{CPM}, and a lower limit for the continuous phase modifier defined herein as L_{CPM}. The higher limit for the continuous phase modifier (L_{CPM}) in the poly(arylene ether) compositions can be in the range of 25 weight percent to 60 weight percent. Weight percent is with regard to the total weight of the composition. Within this range the H_{CPM} can be less than 55 weight percent, preferably less than 50 weight percent, more preferably less than 40 weight percent, and even more preferably less than 30 weight percent. The lower limit for the continuous phase modifier (L_{CPM}) in the poly(arylene ether) compositions can be in the range of 1 weight percent to 30 weight percent. Within this range the L_{CPM} can be greater than 5 weight percent, preferably greater than 10 weight percent, more preferably greater than 15 weight percent, and even more preferably greater than 20 weight percent.

In some of the embodiments, the poly(arylene ether) composition may comprise an other modifier, wherein the other modifier may reside in the dispersed phase comprising the poly(arylene ether), or the continuous phase comprising the other polymer, or on the interface between the continuous phase and the dispersed phase. Examples of the other modifier that can be used in the poly(arylene ether) composition include fibrous fillers, particulate fillers, reinforcing agents, mold release agents, UV absorbers, stabilizers like light stabilizers, heat stabilizers and others, anti-oxidants like hindered phenols, phosphorous compounds, lubricants, plasticizers, nucleating agents, acid scavengers, antimicrobial agents, fluorescent whitening agents, pigments, dyes, photo-bleachable dyes, colorants, anti-static agents, free-radical generating chemicals, curing agents, anti-dripping agents, smoke suppressants, flow promoters, silicon containing chemicals, fluorine-containing chemicals, foaming agents, blowing agents, metal deactivators, and combinations comprising one or more of the foregoing. In some embodiments, the other modifier can be any one of the additives described herein. In some embodiments, the other modifier can be any one of the additives described in “Plastics Additives Handbook”, 6^{th} edition, Hans Zweifel, Hanser Gardner Publications, 2009 (ISBN No.: 978-1-56990-430-8), and the same has been fully incorporated herein by reference along with all its cited references, which are also incorporated herein by reference in their entirety. In some of the embodiments, the poly(arylene ether) composition, when comprises the other modifier, may have a higher limit for the other modifier defined herein as H_{OM}, and a lower limit for the other modifier defined herein as L_{OM}. The higher limit for the other modifier (H_{OM}) in the poly(arylene ether) compositions can be in the range of 25 weight percent to 60 weight percent. Weight percent is with regard to the total weight of the composition. Within this range the H_{OM} can be less than 55 weight percent, preferably less than 50 weight percent, more preferably less than 40 weight percent, and even more preferably less than 30 weight percent. The lower limit for the other modifier (L_{OM}) in the poly(arylene ether) compositions can be in the range of 1 weight percent to 30 weight percent. Within this range the L_{OM} can be greater than 5 weight percent, preferably greater than 10 weight percent, more preferably greater than 15 weight percent, and even more preferably greater than 20 weight percent.

The poly(arylene ether) compositions of the following embodiments A to H, may be prepared by combining the components of the composition in a twin screw extruder. The poly(arylene ether) and dispersed phase modifier can be added at the feed-throat, and the other polymer can be added downstream. The liquid flame retardants can be added by a liquid injector in the second half of the extruder. A covered conductor comprising a conductor and a covering disposed over the lateral surface of the conductor may be formed by extrusion coating. The methods of preparation of the poly(arylene ether) composition and the possible variations of such methods are within the knowledge of the skilled in the art.

### Embodiment A

A covered conductor comprising a conductor and a covering, wherein the covering is disposed over the conductor, wherein the conductor comprises aluminum or an alloy comprising aluminum, and wherein the covering comprises a poly(arylene ether) composition comprising: L_{PAE}-H_{PAE} weight percent of poly(arylene ether), and L_{OP}-H_{OP} weight percent of the other polymer described herein. Table 1 contains some of the formulations of Embodiment A comprising poly(arylene ether) and the other polymer.

TABLE 1

| Components | Poly(arylene ether) | Other Polymer |
|---|---|---|
| Embodiment A-1 | H_{PAE} | H_{OP} |
| Embodiment A-2 | H_{PAE} | L_{OP} |
| Embodiment A-3 | L_{PAE} | H_{OP} |
| Embodiment A-4 | L_{PAE} | L_{OP} |

### Embodiment B

A covered conductor comprising a conductor and a covering, wherein the covering is disposed over the conductor, wherein the conductor comprises aluminum or an alloy comprising aluminum, and wherein the covering comprises a poly(arylene ether) composition comprising: L_{PAE}-H_{PAE} weight percent of poly(arylene ether), L_{OP}-H_{OP} weight percent of the other polymer, and L_{FR}-H_{FR} weight percent of the flame retardant described herein. Table 2 contains some of the formulations of Embodiment B comprising poly(arylene ether), the other polymer, and the flame retardant.

TABLE 2

| | Poly(arylene | Other | Flame |
|---|---|---|---|
| Components | ether) | Polymer | Retardant |
| Embodiment B-1 | H_{PAE} | H_{OP} | H_{FR} |
| Embodiment B-2 | H_{PAE} | H_{OP} | L_{FR} |
| Embodiment B-3 | H_{PAE} | L_{OP} | H_{FR} |
| Embodiment B-4 | H_{PAE} | L_{OP} | L_{FR} |
| Embodiment B-5 | L_{PAE} | H_{OP} | H_{FR} |
| Embodiment B-6 | L_{PAE} | H_{OP} | L_{FR} |
| Embodiment B-7 | L_{PAE} | L_{OP} | H_{FR} |
| Embodiment B-8 | L_{PAE} | L_{OP} | L_{FR} |

### Embodiment C

A covered conductor comprising a conductor and a covering, wherein the covering is disposed over the conductor, wherein the conductor comprises aluminum or an alloy comprising aluminum, and wherein the covering comprises a poly(arylene ether) composition comprising: L_{PAE}-H_{PAE} weight percent of poly(arylene ether), L_{OP}-H_{OP} weight percent of the other polymer, and L_{COM}-H_{COM} weight percent of the compatibilizer described herein. Table 3 contains some of the formulations of Embodiment C comprising poly(arylene ether), the other polymer, and the compatibilizer.

TABLE 3

| | Poly(arylene | Other | |
|---|---|---|---|
| Components | ether) | Polymer | Compatibilizer |
| Embodiment C-1 | H_{PAE} | H_{OP} | H_{COM} |
| Embodiment C-2 | H_{PAE} | H_{OP} | L_{COM} |
| Embodiment C-3 | H_{PAE} | L_{OP} | H_{COM} |
| Embodiment C-4 | H_{PAE} | L_{OP} | L_{COM} |
| Embodiment C-5 | L_{PAE} | H_{OP} | H_{COM} |
| Embodiment C-6 | L_{PAE} | H_{OP} | L_{COM} |
| Embodiment C-7 | L_{PAE} | L_{OP} | H_{COM} |
| Embodiment C-8 | L_{PAE} | L_{OP} | L_{COM} |

### Embodiment D

A covered conductor comprising a conductor and a covering, wherein the covering is disposed over the conductor, wherein the conductor comprises aluminum or an alloy comprising aluminum, and wherein the covering comprises a poly(arylene ether) composition comprising: L_{PAE}-H_{PAE} weight percent of poly(arylene ether), L_{OP}-H_{OP} weight percent of the other polymer, L_{FR}-H_{FR} weight percent of the flame retardant, and L_{COM}-H_{COM} weight percent of the compatibilizer. Table 4 contains some of the formulations of Embodiment D comprising poly(arylene ether), the other polymer, the flame retardant, and the compatibilizer.

TABLE 4

| | Poly(arylene | Other | Flame | |
|---|---|---|---|---|
| Components | ether) | Polymer | Retardant | Compatibilizer |
| Embodiment D-1 | H_{PAE} | H_{OP} | H_{FR} | H_{COM} |
| Embodiment D-2 | H_{PAE} | H_{OP} | H_{FR} | L_{COM} |
| Embodiment D-3 | H_{PAE} | H_{OP} | L_{FR} | H_{COM} |
| Embodiment D-4 | H_{PAE} | H_{OP} | L_{FR} | L_{COM} |
| Embodiment D-5 | H_{PAE} | L_{OP} | H_{FR} | H_{COM} |
| Embodiment D-6 | H_{PAE} | L_{OP} | H_{FR} | L_{COM} |
| Embodiment D-7 | H_{PAE} | L_{OP} | L_{FR} | H_{COM} |
| Embodiment D-8 | H_{PAE} | L_{OP} | L_{FR} | L_{COM} |
| Embodiment D-9 | L_{PAE} | H_{OP} | H_{FR} | H_{COM} |
| Embodiment D-10 | L_{PAE} | H_{OP} | H_{FR} | L_{COM} |
| Embodiment D-11 | L_{PAE} | H_{OP} | L_{FR} | H_{COM} |
| Embodiment D-12 | L_{PAE} | H_{OP} | L_{FR} | L_{COM} |
| Embodiment D-13 | L_{PAE} | L_{OP} | H_{FR} | H_{COM} |
| Embodiment D-14 | L_{PAE} | L_{OP} | H_{FR} | L_{COM} |
| Embodiment D-15 | L_{PAE} | L_{OP} | L_{FR} | H_{COM} |
| Embodiment D-16 | L_{PAE} | L_{OP} | L_{FR} | L_{COM} |

### Embodiment E

A covered conductor comprising a conductor and a covering, wherein the covering is disposed over the conductor, wherein the conductor comprises aluminum or an alloy comprising aluminum, and wherein the covering comprises a poly(arylene ether) composition comprising: L_{PAE}-H_{PAE} weight percent of poly(arylene ether), L_{OP}-H_{OP} weight percent of the other polymer, L_{FR}-H_{FR} weight percent of the flame retardant, L_{COM}-H_{COM} weight percent of the compatibilizer, and L_{DPM}-H_{DPM} weight percent of the dispersed phase modifier. Table 5 contains some of the formulations of Embodiment E comprising poly(arylene ether), the other polymer, the flame retardant, the compatibilizer, and the dispersed phase modifier.

TABLE 5

| | | | | | Dispersed |
|---|---|---|---|---|---|
| | Poly(arylene | | Flame | | Phase |
| Components | ether) | Other Polymer | Retardant | Compatibilizer | Modifier |
| Embodiment E-1 | H_{PAE} | H_{OP} | H_{FR} | H_{COM} | H_{DPM} |
| Embodiment E-2 | H_{PAE} | H_{OP} | H_{FR} | H_{COM} | L_{DPM} |
| Embodiment E-3 | H_{PAE} | H_{OP} | H_{FR} | L_{COM} | H_{DPM} |
| Embodiment E-4 | H_{PAE} | H_{OP} | H_{FR} | L_{COM} | L_{DPM} |
| Embodiment E-5 | H_{PAE} | H_{OP} | L_{FR} | H_{COM} | H_{DPM} |
| Embodiment E-6 | H_{PAE} | H_{OP} | L_{FR} | H_{COM} | L_{DPM} |
| Embodiment E-7 | H_{PAE} | H_{OP} | L_{FR} | L_{COM} | H_{DPM} |
| Embodiment E-8 | H_{PAE} | H_{OP} | L_{FR} | L_{COM} | L_{DPM} |
| Embodiment E-9 | H_{PAE} | L_{OP} | H_{FR} | H_{COM} | H_{DPM} |
| Embodiment E-10 | H_{PAE} | L_{OP} | H_{FR} | H_{COM} | L_{DPM} |
| Embodiment E-11 | H_{PAE} | L_{OP} | H_{FR} | L_{COM} | H_{DPM} |
| Embodiment E-12 | H_{PAE} | L_{OP} | H_{FR} | L_{COM} | L_{DPM} |
| Embodiment E-13 | H_{PAE} | L_{OP} | L_{FR} | H_{COM} | H_{DPM} |
| Embodiment E-14 | H_{PAE} | L_{OP} | L_{FR} | H_{COM} | L_{DPM} |
| Embodiment E-15 | H_{PAE} | L_{OP} | L_{FR} | L_{COM} | H_{DPM} |
| Embodiment E-16 | H_{PAE} | L_{OP} | L_{FR} | L_{COM} | L_{DPM} |
| Embodiment E-17 | L_{PAE} | H_{OP} | H_{FR} | H_{COM} | H_{DPM} |
| Embodiment E-18 | L_{PAE} | H_{OP} | H_{FR} | H_{COM} | L_{DPM} |
| Embodiment E-19 | L_{PAE} | H_{OP} | H_{FR} | L_{COM} | H_{DPM} |
| Embodiment E-20 | L_{PAE} | H_{OP} | H_{FR} | L_{COM} | L_{DPM} |
| Embodiment E-21 | L_{PAE} | H_{OP} | L_{FR} | H_{COM} | H_{DPM} |
| Embodiment E-22 | L_{PAE} | H_{OP} | L_{FR} | H_{COM} | L_{DPM} |
| Embodiment E-23 | L_{PAE} | H_{OP} | L_{FR} | L_{COM} | H_{DPM} |
| Embodiment E-24 | L_{PAE} | H_{OP} | L_{FR} | L_{COM} | L_{DPM} |
| Embodiment E-25 | L_{PAE} | L_{OP} | H_{FR} | H_{COM} | H_{DPM} |
| Embodiment E-26 | L_{PAE} | L_{OP} | H_{FR} | H_{COM} | L_{DPM} |
| Embodiment E-27 | L_{PAE} | L_{OP} | H_{FR} | L_{COM} | H_{DPM} |
| Embodiment E-28 | L_{PAE} | L_{OP} | H_{FR} | L_{COM} | L_{DPM} |
| Embodiment E-29 | L_{PAE} | L_{OP} | L_{FR} | H_{COM} | H_{DPM} |
| Embodiment E-30 | L_{PAE} | L_{OP} | L_{FR} | H_{COM} | L_{DPM} |
| Embodiment E-31 | L_{PAE} | L_{OP} | L_{FR} | L_{COM} | H_{DPM} |
| Embodiment E-32 | L_{PAE} | L_{OP} | L_{FR} | L_{COM} | L_{DPM} |

### Embodiment F

A covered conductor comprising a conductor and a covering, wherein the covering is disposed over the conductor, wherein the conductor comprises aluminum or an alloy comprising aluminum, and wherein the covering comprises a poly(arylene ether) composition comprising: L_{PAE}-H_{PAE} weight percent of poly(arylene ether), L_{OP}-H_{OP} weight percent of the other polymer, L_{FR}-H_{FR} weight percent of the flame retardant, L_{COM}-H_{COM} weight percent of the compatibilizer, L_{DPM}-H_{DPM} weight percent of the dispersed phase modifier, and L_{CPM}-H_{CPM} weight percent of the continuous phase modifier. Table 6 contains some of the formulations of Embodiment F comprising poly(arylene ether), the other polymer, the flame retardant, the compatibilizer, the dispersed phase modifier, and the continuous phase modifier.

TABLE 6

| | | | | | Dispersed | Continuous |
|---|---|---|---|---|---|---|
| | Poly(arylene | Other | Flame | | Phase | Phase |
| Components | ether) | Polymer | Retardant | Compatibilizer | Modifier | Modifier |
| Embodiment F-1 | H_{PAE} | H_{OP} | H_{FR} | H_{COM} | H_{DPM} | H_{CPM} |
| Embodiment F-2 | H_{PAE} | H_{OP} | H_{FR} | H_{COM} | H_{DPM} | L_{CPM} |
| Embodiment F-3 | H_{PAE} | H_{OP} | H_{FR} | H_{COM} | L_{DPM} | H_{CPM} |
| Embodiment F-4 | H_{PAE} | H_{OP} | H_{FR} | H_{COM} | L_{DPM} | L_{CPM} |
| Embodiment F-5 | H_{PAE} | H_{OP} | H_{FR} | L_{COM} | H_{DPM} | H_{CPM} |
| Embodiment F-6 | H_{PAE} | H_{OP} | H_{FR} | L_{COM} | H_{DPM} | L_{CPM} |
| Embodiment F-7 | H_{PAE} | H_{OP} | H_{FR} | L_{COM} | L_{DPM} | H_{CPM} |
| Embodiment F-8 | H_{PAE} | H_{OP} | H_{FR} | L_{COM} | L_{DPM} | L_{CPM} |
| Embodiment F-9 | H_{PAE} | H_{OP} | L_{FR} | H_{COM} | H_{DPM} | H_{CPM} |
| Embodiment F-10 | H_{PAE} | H_{OP} | L_{FR} | H_{COM} | H_{DPM} | L_{CPM} |
| Embodiment F-11 | H_{PAE} | H_{OP} | L_{FR} | H_{COM} | L_{DPM} | H_{CPM} |
| Embodiment F-12 | H_{PAE} | H_{OP} | L_{FR} | H_{COM} | L_{DPM} | L_{CPM} |
| Embodiment F-13 | H_{PAE} | H_{OP} | L_{FR} | L_{COM} | H_{DPM} | H_{CPM} |
| Embodiment F-14 | H_{PAE} | H_{OP} | L_{FR} | L_{COM} | H_{DPM} | L_{CPM} |
| Embodiment F-15 | H_{PAE} | H_{OP} | L_{FR} | L_{COM} | L_{DPM} | H_{CPM} |
| Embodiment F-16 | H_{PAE} | H_{OP} | L_{FR} | L_{COM} | L_{DPM} | L_{CPM} |
| Embodiment F-17 | H_{PAE} | L_{OP} | H_{FR} | H_{COM} | H_{DPM} | H_{CPM} |
| Embodiment F-18 | H_{PAE} | L_{OP} | H_{FR} | H_{COM} | H_{DPM} | L_{CPM} |
| Embodiment F-19 | H_{PAE} | L_{OP} | H_{FR} | H_{COM} | L_{DPM} | H_{CPM} |
| Embodiment F-20 | H_{PAE} | L_{OP} | H_{FR} | H_{COM} | L_{DPM} | L_{CPM} |
| Embodiment F-21 | H_{PAE} | L_{OP} | H_{FR} | L_{COM} | H_{DPM} | H_{CPM} |
| Embodiment F-22 | H_{PAE} | L_{OP} | H_{FR} | L_{COM} | H_{DPM} | L_{CPM} |
| Embodiment F-23 | H_{PAE} | L_{OP} | H_{FR} | L_{COM} | L_{DPM} | H_{CPM} |
| Embodiment F-24 | H_{PAE} | L_{OP} | H_{FR} | L_{COM} | L_{DPM} | L_{CPM} |
| Embodiment F-25 | H_{PAE} | L_{OP} | L_{FR} | H_{COM} | H_{DPM} | H_{CPM} |
| Embodiment F-26 | H_{PAE} | L_{OP} | L_{FR} | H_{COM} | H_{DPM} | L_{CPM} |
| Embodiment F-27 | H_{PAE} | L_{OP} | L_{FR} | H_{COM} | L_{DPM} | H_{CPM} |
| Embodiment F-28 | H_{PAE} | L_{OP} | L_{FR} | H_{COM} | L_{DPM} | L_{CPM} |
| Embodiment F-29 | H_{PAE} | L_{OP} | L_{FR} | L_{COM} | H_{DPM} | H_{CPM} |
| Embodiment F-30 | H_{PAE} | L_{OP} | L_{FR} | L_{COM} | H_{DPM} | L_{CPM} |
| Embodiment F-31 | H_{PAE} | L_{OP} | L_{FR} | L_{COM} | L_{DPM} | H_{CPM} |
| Embodiment F-32 | H_{PAE} | L_{OP} | L_{FR} | L_{COM} | L_{DPM} | L_{CPM} |
| Embodiment F-33 | L_{PAE} | H_{OP} | H_{FR} | H_{COM} | H_{DPM} | H_{CPM} |
| Embodiment F-34 | L_{PAE} | H_{OP} | H_{FR} | H_{COM} | H_{DPM} | L_{CPM} |
| Embodiment F-35 | L_{PAE} | H_{OP} | H_{FR} | H_{COM} | L_{DPM} | H_{CPM} |
| Embodiment F-36 | L_{PAE} | H_{OP} | H_{FR} | H_{COM} | L_{DPM} | L_{CPM} |
| Embodiment F-37 | L_{PAE} | H_{OP} | H_{FR} | L_{COM} | H_{DPM} | H_{CPM} |
| Embodiment F-38 | L_{PAE} | H_{OP} | H_{FR} | L_{COM} | H_{DPM} | L_{CPM} |
| Embodiment F-39 | L_{PAE} | H_{OP} | H_{FR} | L_{COM} | L_{DPM} | H_{CPM} |
| Embodiment F-40 | L_{PAE} | H_{OP} | H_{FR} | L_{COM} | L_{DPM} | L_{CPM} |
| Embodiment F-41 | L_{PAE} | H_{OP} | L_{FR} | H_{COM} | H_{DPM} | H_{CPM} |
| Embodiment F-42 | L_{PAE} | H_{OP} | L_{FR} | H_{COM} | H_{DPM} | L_{CPM} |
| Embodiment F-43 | L_{PAE} | H_{OP} | L_{FR} | H_{COM} | L_{DPM} | H_{CPM} |
| Embodiment F-44 | L_{PAE} | H_{OP} | L_{FR} | H_{COM} | L_{DPM} | L_{CPM} |
| Embodiment F-45 | L_{PAE} | H_{OP} | L_{FR} | L_{COM} | H_{DPM} | H_{CPM} |
| Embodiment F-46 | L_{PAE} | H_{OP} | L_{FR} | L_{COM} | H_{DPM} | L_{CPM} |
| Embodiment F-47 | L_{PAE} | H_{OP} | L_{FR} | L_{COM} | L_{DPM} | H_{CPM} |
| Embodiment F-48 | L_{PAE} | H_{OP} | L_{FR} | L_{COM} | L_{DPM} | L_{CPM} |
| Embodiment F-49 | L_{PAE} | L_{OP} | H_{FR} | H_{COM} | H_{DPM} | H_{CPM} |
| Embodiment F-50 | L_{PAE} | L_{OP} | H_{FR} | H_{COM} | H_{DPM} | L_{CPM} |
| Embodiment F-51 | L_{PAE} | L_{OP} | H_{FR} | H_{COM} | L_{DPM} | H_{CPM} |
| Embodiment F-52 | L_{PAE} | L_{OP} | H_{FR} | H_{COM} | L_{DPM} | L_{CPM} |
| Embodiment F-53 | L_{PAE} | L_{OP} | H_{FR} | L_{COM} | H_{DPM} | H_{CPM} |
| Embodiment F-54 | L_{PAE} | L_{OP} | H_{FR} | L_{COM} | H_{DPM} | L_{CPM} |
| Embodiment F-55 | L_{PAE} | L_{OP} | H_{FR} | L_{COM} | L_{DPM} | H_{CPM} |
| Embodiment F-56 | L_{PAE} | L_{OP} | H_{FR} | L_{COM} | L_{DPM} | L_{CPM} |
| Embodiment F-57 | L_{PAE} | L_{OP} | L_{FR} | H_{COM} | H_{DPM} | H_{CPM} |
| Embodiment F-58 | L_{PAE} | L_{OP} | L_{FR} | H_{COM} | H_{DPM} | L_{CPM} |
| Embodiment F-59 | L_{PAE} | L_{OP} | L_{FR} | H_{COM} | L_{DPM} | H_{CPM} |
| Embodiment F-60 | L_{PAE} | L_{OP} | L_{FR} | H_{COM} | L_{DPM} | L_{CPM} |
| Embodiment F-61 | L_{PAE} | L_{OP} | L_{FR} | L_{COM} | H_{DPM} | H_{CPM} |
| Embodiment F-62 | L_{PAE} | L_{OP} | L_{FR} | L_{COM} | H_{DPM} | L_{CPM} |
| Embodiment F-63 | L_{PAE} | L_{OP} | L_{FR} | L_{COM} | L_{DPM} | H_{CPM} |
| Embodiment F-64 | L_{PAE} | L_{OP} | L_{FR} | L_{COM} | L_{DPM} | L_{CPM} |

### Embodiment G

A covered conductor comprising a conductor and a covering, wherein the covering is disposed over the conductor, wherein the conductor comprises aluminum or an alloy comprising aluminum, and wherein the covering comprises a poly(arylene ether) composition comprising: L_{PAE}-H_{PAE} weight percent of poly(arylene ether), L_{OP}-H_{OP} weight percent of the other polymer, L_{FR}-H_{FR} weight percent of the flame retardant, L_{COM}-H_{COM} weight percent of the compatibilizer, L_{DPM}-H_{DPM} weight percent of the dispersed phase modifier, L_{CPM}-H_{CPM} weight percent of the continuous phase modifier, and L_{OM}-H_{OM} weight percent of the other modifier. Table 7 contains some of the formulations of Embodiment G comprising poly(arylene ether), the other polymer, the flame retardant, the compatibilizer, the dispersed phase modifier, the continuous phase modifier, and the other modifier.

TABLE 7

| | | | | | Dispersed | Continuous | |
|---|---|---|---|---|---|---|---|
| | Poly(arylene | Other | Flame | | Phase | Phase | Other |
| Components | ether) | Polymer | Retardant | Compatibilizer | Modifier | Modifier | Modifier |
| Embodiment G-1 | H_{PAE} | H_{OP} | H_{FR} | H_{COM} | H_{DPM} | H_{CPM} | H_{OM} |
| Embodiment G-2 | H_{PAE} | H_{OP} | H_{FR} | H_{COM} | H_{DPM} | H_{CPM} | L_{OM} |
| Embodiment G-3 | H_{PAE} | H_{OP} | H_{FR} | H_{COM} | H_{DPM} | L_{CPM} | H_{OM} |
| Embodiment G-4 | H_{PAE} | H_{OP} | H_{FR} | H_{COM} | H_{DPM} | L_{CPM} | L_{OM} |
| Embodiment G-5 | H_{PAE} | H_{OP} | H_{FR} | H_{COM} | L_{DPM} | H_{CPM} | H_{OM} |
| Embodiment G-6 | H_{PAE} | H_{OP} | H_{FR} | H_{COM} | L_{DPM} | H_{CPM} | L_{OM} |
| Embodiment G-7 | H_{PAE} | H_{OP} | H_{FR} | H_{COM} | L_{DPM} | L_{CPM} | H_{OM} |
| Embodiment G-8 | H_{PAE} | H_{OP} | H_{FR} | H_{COM} | L_{DPM} | L_{CPM} | L_{OM} |
| Embodiment G-9 | H_{PAE} | H_{OP} | H_{FR} | L_{COM} | H_{DPM} | H_{CPM} | H_{OM} |
| Embodiment G-10 | H_{PAE} | H_{OP} | H_{FR} | L_{COM} | H_{DPM} | H_{CPM} | L_{OM} |
| Embodiment G-11 | H_{PAE} | H_{OP} | H_{FR} | L_{COM} | H_{DPM} | L_{CPM} | H_{OM} |
| Embodiment G-12 | H_{PAE} | H_{OP} | H_{FR} | L_{COM} | H_{DPM} | L_{CPM} | L_{OM} |
| Embodiment G-13 | H_{PAE} | H_{OP} | H_{FR} | L_{COM} | L_{DPM} | H_{CPM} | H_{OM} |
| Embodiment G-14 | H_{PAE} | H_{OP} | H_{FR} | L_{COM} | L_{DPM} | H_{CPM} | L_{OM} |
| Embodiment G-15 | H_{PAE} | H_{OP} | H_{FR} | L_{COM} | L_{DPM} | L_{CPM} | H_{OM} |
| Embodiment G-16 | H_{PAE} | H_{OP} | H_{FR} | L_{COM} | L_{DPM} | L_{CPM} | L_{OM} |
| Embodiment G-17 | H_{PAE} | H_{OP} | L_{FR} | H_{COM} | H_{DPM} | H_{CPM} | H_{OM} |
| Embodiment G-18 | H_{PAE} | H_{OP} | L_{FR} | H_{COM} | H_{DPM} | H_{CPM} | L_{OM} |
| Embodiment G-19 | H_{PAE} | H_{OP} | L_{FR} | H_{COM} | H_{DPM} | L_{CPM} | H_{OM} |
| Embodiment G-20 | H_{PAE} | H_{OP} | L_{FR} | H_{COM} | H_{DPM} | L_{CPM} | L_{OM} |
| Embodiment G-21 | H_{PAE} | H_{OP} | L_{FR} | H_{COM} | L_{DPM} | H_{CPM} | H_{OM} |
| Embodiment G-22 | H_{PAE} | H_{OP} | L_{FR} | H_{COM} | L_{DPM} | H_{CPM} | L_{OM} |
| Embodiment G-23 | H_{PAE} | H_{OP} | L_{FR} | H_{COM} | L_{DPM} | L_{CPM} | H_{OM} |
| Embodiment G-24 | H_{PAE} | H_{OP} | L_{FR} | H_{COM} | L_{DPM} | L_{CPM} | L_{OM} |
| Embodiment G-25 | H_{PAE} | H_{OP} | L_{FR} | L_{COM} | H_{DPM} | H_{CPM} | H_{OM} |
| Embodiment G-26 | H_{PAE} | H_{OP} | L_{FR} | L_{COM} | H_{DPM} | H_{CPM} | L_{OM} |
| Embodiment G-27 | H_{PAE} | H_{OP} | L_{FR} | L_{COM} | H_{DPM} | L_{CPM} | H_{OM} |
| Embodiment G-28 | H_{PAE} | H_{OP} | L_{FR} | L_{COM} | H_{DPM} | L_{CPM} | L_{OM} |
| Embodiment G-29 | H_{PAE} | H_{OP} | L_{FR} | L_{COM} | L_{DPM} | H_{CPM} | H_{OM} |
| Embodiment G-30 | H_{PAE} | H_{OP} | L_{FR} | L_{COM} | L_{DPM} | H_{CPM} | L_{OM} |
| Embodiment G-31 | H_{PAE} | H_{OP} | L_{FR} | L_{COM} | L_{DPM} | L_{CPM} | H_{OM} |
| Embodiment G-32 | H_{PAE} | H_{OP} | L_{FR} | L_{COM} | L_{DPM} | L_{CPM} | L_{OM} |
| Embodiment G-33 | H_{PAE} | L_{OP} | H_{FR} | H_{COM} | H_{DPM} | H_{CPM} | H_{OM} |
| Embodiment G-34 | H_{PAE} | L_{OP} | H_{FR} | H_{COM} | H_{DPM} | H_{CPM} | L_{OM} |
| Embodiment G-35 | H_{PAE} | L_{OP} | H_{FR} | H_{COM} | H_{DPM} | L_{CPM} | H_{OM} |
| Embodiment G-36 | H_{PAE} | L_{OP} | H_{FR} | H_{COM} | H_{DPM} | L_{CPM} | L_{OM} |
| Embodiment G-37 | H_{PAE} | L_{OP} | H_{FR} | H_{COM} | L_{DPM} | H_{CPM} | H_{OM} |
| Embodiment G-38 | H_{PAE} | L_{OP} | H_{FR} | H_{COM} | L_{DPM} | H_{CPM} | L_{OM} |
| Embodiment G-39 | H_{PAE} | L_{OP} | H_{FR} | H_{COM} | L_{DPM} | L_{CPM} | H_{OM} |
| Embodiment G-40 | H_{PAE} | L_{OP} | H_{FR} | H_{COM} | L_{DPM} | L_{CPM} | L_{OM} |
| Embodiment G-41 | H_{PAE} | L_{OP} | H_{FR} | L_{COM} | H_{DPM} | H_{CPM} | H_{OM} |
| Embodiment G-42 | H_{PAE} | L_{OP} | H_{FR} | L_{COM} | H_{DPM} | H_{CPM} | L_{OM} |
| Embodiment G-43 | H_{PAE} | L_{OP} | H_{FR} | L_{COM} | H_{DPM} | L_{CPM} | H_{OM} |
| Embodiment G-44 | H_{PAE} | L_{OP} | H_{FR} | L_{COM} | H_{DPM} | L_{CPM} | L_{OM} |
| Embodiment G-45 | H_{PAE} | L_{OP} | H_{FR} | L_{COM} | L_{DPM} | H_{CPM} | H_{OM} |
| Embodiment G-46 | H_{PAE} | L_{OP} | H_{FR} | L_{COM} | L_{DPM} | H_{CPM} | L_{OM} |
| Embodiment G-47 | H_{PAE} | L_{OP} | H_{FR} | L_{COM} | L_{DPM} | L_{CPM} | H_{OM} |
| Embodiment G-48 | H_{PAE} | L_{OP} | H_{FR} | L_{COM} | L_{DPM} | L_{CPM} | L_{OM} |
| Embodiment G-49 | H_{PAE} | L_{OP} | L_{FR} | H_{COM} | H_{DPM} | H_{CPM} | H_{OM} |
| Embodiment G-50 | H_{PAE} | L_{OP} | L_{FR} | H_{COM} | H_{DPM} | H_{CPM} | L_{OM} |
| Embodiment G-51 | H_{PAE} | L_{OP} | L_{FR} | H_{COM} | H_{DPM} | L_{CPM} | H_{OM} |
| Embodiment G-52 | H_{PAE} | L_{OP} | L_{FR} | H_{COM} | H_{DPM} | L_{CPM} | L_{OM} |
| Embodiment G-53 | H_{PAE} | L_{OP} | L_{FR} | H_{COM} | L_{DPM} | H_{CPM} | H_{OM} |
| Embodiment G-54 | H_{PAE} | L_{OP} | L_{FR} | H_{COM} | L_{DPM} | H_{CPM} | L_{OM} |
| Embodiment G-55 | H_{PAE} | L_{OP} | L_{FR} | H_{COM} | L_{DPM} | L_{CPM} | H_{OM} |
| Embodiment G-56 | H_{PAE} | L_{OP} | L_{FR} | H_{COM} | L_{DPM} | L_{CPM} | L_{OM} |
| Embodiment G-57 | H_{PAE} | L_{OP} | L_{FR} | L_{COM} | H_{DPM} | H_{CPM} | H_{OM} |
| Embodiment G-58 | H_{PAE} | L_{OP} | L_{FR} | L_{COM} | H_{DPM} | H_{CPM} | L_{OM} |
| Embodiment G-59 | H_{PAE} | L_{OP} | L_{FR} | L_{COM} | H_{DPM} | L_{CPM} | H_{OM} |
| Embodiment G-60 | H_{PAE} | L_{OP} | L_{FR} | L_{COM} | H_{DPM} | L_{CPM} | L_{OM} |
| Embodiment G-61 | H_{PAE} | L_{OP} | L_{FR} | L_{COM} | L_{DPM} | H_{CPM} | H_{OM} |
| Embodiment G-62 | H_{PAE} | L_{OP} | L_{FR} | L_{COM} | L_{DPM} | H_{CPM} | L_{OM} |
| Embodiment G-63 | H_{PAE} | L_{OP} | L_{FR} | L_{COM} | L_{DPM} | L_{CPM} | H_{OM} |
| Embodiment G-64 | H_{PAE} | L_{OP} | L_{FR} | L_{COM} | L_{DPM} | L_{CPM} | L_{OM} |
| Embodiment G-65 | L_{PAE} | H_{OP} | H_{FR} | H_{COM} | H_{DPM} | H_{CPM} | H_{OM} |
| Embodiment G-66 | L_{PAE} | H_{OP} | H_{FR} | H_{COM} | H_{DPM} | H_{CPM} | L_{OM} |
| Embodiment G-67 | L_{PAE} | H_{OP} | H_{FR} | H_{COM} | H_{DPM} | L_{CPM} | H_{OM} |
| Embodiment G-68 | L_{PAE} | H_{OP} | H_{FR} | H_{COM} | H_{DPM} | L_{CPM} | L_{OM} |
| Embodiment G-69 | L_{PAE} | H_{OP} | H_{FR} | H_{COM} | L_{DPM} | H_{CPM} | H_{OM} |
| Embodiment G-70 | L_{PAE} | H_{OP} | H_{FR} | H_{COM} | L_{DPM} | H_{CPM} | L_{OM} |
| Embodiment G-71 | L_{PAE} | H_{OP} | H_{FR} | H_{COM} | L_{DPM} | L_{CPM} | H_{OM} |
| Embodiment G-72 | L_{PAE} | H_{OP} | H_{FR} | H_{COM} | L_{DPM} | L_{CPM} | L_{OM} |
| Embodiment G-73 | L_{PAE} | H_{OP} | H_{FR} | L_{COM} | H_{DPM} | H_{CPM} | H_{OM} |
| Embodiment G-74 | L_{PAE} | H_{OP} | H_{FR} | L_{COM} | H_{DPM} | H_{CPM} | L_{OM} |
| Embodiment G-75 | L_{PAE} | H_{OP} | H_{FR} | L_{COM} | H_{DPM} | L_{CPM} | H_{OM} |
| Embodiment G-76 | L_{PAE} | H_{OP} | H_{FR} | L_{COM} | H_{DPM} | L_{CPM} | L_{OM} |
| Embodiment G-77 | L_{PAE} | H_{OP} | H_{FR} | L_{COM} | L_{DPM} | H_{CPM} | H_{OM} |
| Embodiment G-78 | L_{PAE} | H_{OP} | H_{FR} | L_{COM} | L_{DPM} | H_{CPM} | L_{OM} |
| Embodiment G-79 | L_{PAE} | H_{OP} | H_{FR} | L_{COM} | L_{DPM} | L_{CPM} | H_{OM} |
| Embodiment G-80 | L_{PAE} | H_{OP} | H_{FR} | L_{COM} | L_{DPM} | L_{CPM} | L_{OM} |
| Embodiment G-81 | L_{PAE} | H_{OP} | L_{FR} | H_{COM} | H_{DPM} | H_{CPM} | H_{OM} |
| Embodiment G-82 | L_{PAE} | H_{OP} | L_{FR} | H_{COM} | H_{DPM} | H_{CPM} | L_{OM} |
| Embodiment G-83 | L_{PAE} | H_{OP} | L_{FR} | H_{COM} | H_{DPM} | L_{CPM} | H_{OM} |
| Embodiment G-84 | L_{PAE} | H_{OP} | L_{FR} | H_{COM} | H_{DPM} | L_{CPM} | L_{OM} |
| Embodiment G-85 | L_{PAE} | H_{OP} | L_{FR} | H_{COM} | L_{DPM} | H_{CPM} | H_{OM} |
| Embodiment G-86 | L_{PAE} | H_{OP} | L_{FR} | H_{COM} | L_{DPM} | H_{CPM} | L_{OM} |
| Embodiment G-87 | L_{PAE} | H_{OP} | L_{FR} | H_{COM} | L_{DPM} | L_{CPM} | H_{OM} |
| Embodiment G-88 | L_{PAE} | H_{OP} | L_{FR} | H_{COM} | L_{DPM} | L_{CPM} | L_{OM} |
| Embodiment G-89 | L_{PAE} | H_{OP} | L_{FR} | L_{COM} | H_{DPM} | H_{CPM} | H_{OM} |
| Embodiment G-90 | L_{PAE} | H_{OP} | L_{FR} | L_{COM} | H_{DPM} | H_{CPM} | L_{OM} |
| Embodiment G-91 | L_{PAE} | H_{OP} | L_{FR} | L_{COM} | H_{DPM} | L_{CPM} | H_{OM} |
| Embodiment G-92 | L_{PAE} | H_{OP} | L_{FR} | L_{COM} | H_{DPM} | L_{CPM} | L_{OM} |
| Embodiment G-93 | L_{PAE} | H_{OP} | L_{FR} | L_{COM} | L_{DPM} | H_{CPM} | H_{OM} |
| Embodiment G-94 | L_{PAE} | H_{OP} | L_{FR} | L_{COM} | L_{DPM} | H_{CPM} | L_{OM} |
| Embodiment G-95 | L_{PAE} | H_{OP} | L_{FR} | L_{COM} | L_{DPM} | L_{CPM} | H_{OM} |
| Embodiment G-96 | L_{PAE} | H_{OP} | L_{FR} | L_{COM} | L_{DPM} | L_{CPM} | L_{OM} |
| Embodiment G-97 | L_{PAE} | L_{OP} | H_{FR} | H_{COM} | H_{DPM} | H_{CPM} | H_{OM} |
| Embodiment G-98 | L_{PAE} | L_{OP} | H_{FR} | H_{COM} | H_{DPM} | H_{CPM} | L_{OM} |
| Embodiment G-99 | L_{PAE} | L_{OP} | H_{FR} | H_{COM} | H_{DPM} | L_{CPM} | H_{OM} |
| Embodiment G-100 | L_{PAE} | L_{OP} | H_{FR} | H_{COM} | H_{DPM} | L_{CPM} | L_{OM} |
| Embodiment G-101 | L_{PAE} | L_{OP} | H_{FR} | H_{COM} | L_{DPM} | H_{CPM} | H_{OM} |
| Embodiment G-102 | L_{PAE} | L_{OP} | H_{FR} | H_{COM} | L_{DPM} | H_{CPM} | L_{OM} |
| Embodiment G-103 | L_{PAE} | L_{OP} | H_{FR} | H_{COM} | L_{DPM} | L_{CPM} | H_{OM} |
| Embodiment G-104 | L_{PAE} | L_{OP} | H_{FR} | H_{COM} | L_{DPM} | L_{CPM} | L_{OM} |
| Embodiment G-105 | L_{PAE} | L_{OP} | H_{FR} | L_{COM} | H_{DPM} | H_{CPM} | H_{OM} |
| Embodiment G-106 | L_{PAE} | L_{OP} | H_{FR} | L_{COM} | H_{DPM} | H_{CPM} | L_{OM} |
| Embodiment G-107 | L_{PAE} | L_{OP} | H_{FR} | L_{COM} | H_{DPM} | L_{CPM} | H_{OM} |
| Embodiment G-108 | L_{PAE} | L_{OP} | H_{FR} | L_{COM} | H_{DPM} | L_{CPM} | L_{OM} |
| Embodiment G-109 | L_{PAE} | L_{OP} | H_{FR} | L_{COM} | L_{DPM} | H_{CPM} | H_{OM} |
| Embodiment G-110 | L_{PAE} | L_{OP} | H_{FR} | L_{COM} | L_{DPM} | H_{CPM} | L_{OM} |
| Embodiment G-111 | L_{PAE} | L_{OP} | H_{FR} | L_{COM} | L_{DPM} | L_{CPM} | H_{OM} |
| Embodiment G-112 | L_{PAE} | L_{OP} | H_{FR} | L_{COM} | L_{DPM} | L_{CPM} | L_{OM} |
| Embodiment G-113 | L_{PAE} | L_{OP} | L_{FR} | H_{COM} | H_{DPM} | H_{CPM} | H_{OM} |
| Embodiment G-114 | L_{PAE} | L_{OP} | L_{FR} | H_{COM} | H_{DPM} | H_{CPM} | L_{OM} |
| Embodiment G-115 | L_{PAE} | L_{OP} | L_{FR} | H_{COM} | H_{DPM} | L_{CPM} | H_{OM} |
| Embodiment G-116 | L_{PAE} | L_{OP} | L_{FR} | H_{COM} | H_{DPM} | L_{CPM} | L_{OM} |
| Embodiment G-117 | L_{PAE} | L_{OP} | L_{FR} | H_{COM} | L_{DPM} | H_{CPM} | H_{OM} |
| Embodiment G-118 | L_{PAE} | L_{OP} | L_{FR} | H_{COM} | L_{DPM} | H_{CPM} | L_{OM} |
| Embodiment G-119 | L_{PAE} | L_{OP} | L_{FR} | H_{COM} | L_{DPM} | L_{CPM} | H_{OM} |
| Embodiment G-120 | L_{PAE} | L_{OP} | L_{FR} | H_{COM} | L_{DPM} | L_{CPM} | L_{OM} |
| Embodiment G-121 | L_{PAE} | L_{OP} | L_{FR} | L_{COM} | H_{DPM} | H_{CPM} | H_{OM} |
| Embodiment G-122 | L_{PAE} | L_{OP} | L_{FR} | L_{COM} | H_{DPM} | H_{CPM} | L_{OM} |
| Embodiment G-123 | L_{PAE} | L_{OP} | L_{FR} | L_{COM} | H_{DPM} | L_{CPM} | H_{OM} |
| Embodiment G-124 | L_{PAE} | L_{OP} | L_{FR} | L_{COM} | H_{DPM} | L_{CPM} | L_{OM} |
| Embodiment G-125 | L_{PAE} | L_{OP} | L_{FR} | L_{COM} | L_{DPM} | H_{CPM} | H_{OM} |
| Embodiment G-126 | L_{PAE} | L_{OP} | L_{FR} | L_{COM} | L_{DPM} | H_{CPM} | L_{OM} |
| Embodiment G-127 | L_{PAE} | L_{OP} | L_{FR} | L_{COM} | L_{DPM} | L_{CPM} | H_{OM} |
| Embodiment G-128 | L_{PAE} | L_{OP} | L_{FR} | L_{COM} | L_{DPM} | L_{CPM} | L_{OM} |

### Embodiment H

The compositions of any of the Examples A-G, wherein the poly(arylene ether) may form a dispersed phase with poly(arylene ether) particles having an average diameter of 0.1 to 5 micrometers, and the other polymer may form a continuous phase.

In some embodiments, the covered conductors can be made into an assembly, called, “wire harness assembly” (also called cable harness, cable wire harness, wire or cable harness assembly, harness assembly, wiring loom, wiring clip, board assembly, harness wiring system, etc.).

In some embodiments, the wire harness assembly comprises a covered conductor wherein the covered conductor comprises a conductor and a covering, wherein the covering is disposed over the conductor. In these embodiments, the conductor comprises aluminum or an alloy comprising aluminum and the covering comprises a poly(arylene ether) composition. In some other embodiments, the wire harness assembly comprises two or more covered conductors wherein each covered conductor comprises two or more conductors and a covering, wherein the covering is disposed over the conductor. In some embodiments, such covered conductors can have covering in the form of single layer or multiple layers. In these embodiments, the each conductor comprises aluminum or an alloy comprising aluminum and the each covering comprises a poly(arylene ether) composition.

As described earlier, the conductor of wire harness assembly comprises aluminum or an alloy comprising aluminum. In some embodiments, the conductor comprises a coated conductor comprising aluminum or alloy comprising aluminum, or a claded conductor comprising aluminum or an alloy comprising aluminum. In some other embodiments, the conductor comprises a metal selected from the group consisting of copper, lead, stainless steel, silver, gold, platinum, and alloys comprising one or more of the foregoing. In these embodiments, the conductor comprises a single conductor, a single strand, a plurality of conductors, or a plurality of strands.

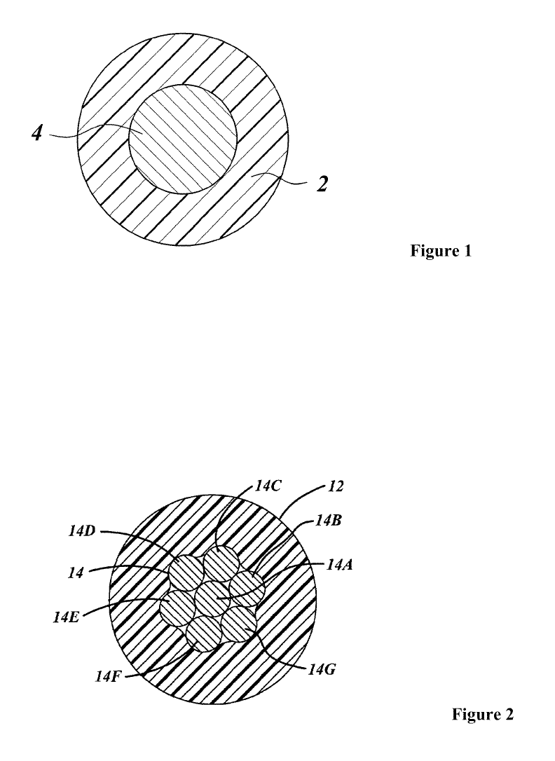

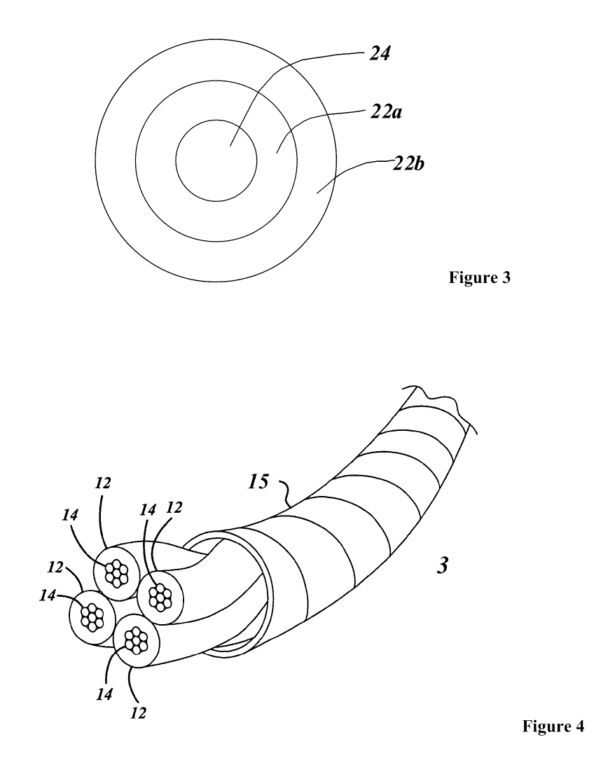

Exemplary covered conductor is shown in FIGS. 1 and 2. As seen from these figures, the covered conductor comprises one or more conductors (4 or 14) and coverings (2 or 12) disposed over the conductor. The conductor further may comprise either individual conductor 4 (FIG. 1) or bundle of conductors stranded together 14 (FIG. 2). According to one of the embodiment, strand of conductors is comprised of several conductors 14A to 14G with central conductor 14A, as shown in FIG. 2. The central conductor 14A is surrounded by the other conductors 14B to 14G. In these embodiments, the conductor can have a cross sectional area of 0.000122 square millimeters to 107.164 square millimeters.

As shown in FIG. 1 and FIG. 2, the covered conductors of the present invention have coverings 2 (FIG. 1), and 12 (FIG. 2), which are insulating in nature comprising poly(arylene ether) resin composition, extruded or dispersed over the conductor. In these embodiments, the covering can have thickness of 0.01 millimeters to 8.0 millimeters.

In some embodiments, the covering comprises a plurality of juxtaposed concentric layers of covering, wherein some of the layers comprises poly(arylene ether) resin and some other layers comprises a polymer that is different from the poly(arylene ether). As shown in FIG. 3, the conductor 24 of the present invention has covering 22a disposed over the conductor, and covering 22b disposed over the covering 22a. The covering 22a and covering 22b are juxtaposed to each other, and together form concentric layers of coverings disposed over the conductor 24. In some embodiments the covering 22a comprises poly(arylene ether) composition comprises at least one member selected from the group consisting of metal deactivators, anti-oxidants, and stabilizers, wherein the composition is essentially stabilized and can exhibit improved resistance against the degradation catalyzed by the metal conductor in contact with. The covering 22b comprises polymer different from poly(arylene ether) such as, for example, polyethylene, polypropylene, cross-linked polyethylene, polyamide, polybutylene terephthalate, polyethylene terephthalate, polyether-imide, polysulfone, polyethersulfone, composition comprises at least one member selected from the group consisting of UV absorbers, light stabilizers, antistatic agents, antioxidants, foaming agents, crosslinking agents, pigments, dyes, and colorants wherein the composition is essentially stabilized and can exhibit improved resistance against the external environment to which the covered conductor is exposed.

In some embodiments, an other layer comprising at least one member selected from the group consisting of tin, lead, silver, gold, zinc, nickel, poly(arylene ether), polyetherimide, polyimide, polybenzimidazole, epoxy resin, polyurethane resin, phenol formaldehyde resin, urea formaldehyde resin, melamine formaldehyde resin, or one or more of the foregoing materials, is disposed between the covering and the conductor comprising aluminum or an alloy comprising aluminum. In some embodiments, the other layer described herein is disposed over the conductor comprising aluminum or an alloy comprising aluminum, wherein the conductor is in the form of a single conductor, or the stranded conductor described herein. The thickness of the other layer may be in the range of 0.1 micron to 50 micron, wherein the coating of the material to form the other layer is done by dipping, by electro-deposition, or by co-deposition. In some embodiments, wherein the other layer comprises any one of the metals described herein, may be passivated from oxidation by treating the other layer with chromate, molybdate, or phosphate. In some embodiments, wherein the other layer comprises any one of the polymers described herein, may be passivated from oxidation by crosslinking the other layer.

In some embodiments, the covered conductor of the wire harness assembly comprises at least one member selected from the group consisting of beddings, armors, and wrapping tapes. The bedding may comprise a thermoplastic or thermosetting resin composition, preferably a poly(arylene ether) composition. In some embodiments, wherein the two or more covering layers are disposed over the conductor, the bedding can provide a protective boundary between inner and outer covering layers of the covered conductor. In some embodiments, the covered conductor is provided with the one or more armors for mechanical protection, which means the cable can withstand higher stresses, be buried directly and used in external or underground projects. While the armors can be used as an additional earth for the covered conductor, it should not be used as the only earth. The armor can be earthed at the supply end at all times, so that it cannot become live if the covered conductor is damaged. The armor may comprise aluminum or an alloy comprising aluminum. In some embodiments, the armor may comprises a metal selected from the group consisting of copper, lead, stainless steel, silver, gold, platinum, and alloys comprising one or more of the foregoing.

In some embodiments, the covered conductor of the wire harness assembly comprises one or more wrapping tape to hold the plurality of covered conductors together, and to provide additional protection from external stresses. In some of embodiments, several covered conductors can be bundled together using wrapping tape 15, as shown in FIG. 4. Conventionally, PVC was the material of choice for tape composition. However, given the potential for reducing coating thickness and specific gravity difference, a weight reduction up to 75% is possible with poly(arylene ether) based tape compared to PVC tape. Exemplary composition for tape comprise similar resins, which are used for covering, described in earlier sections. In some embodiments, the tape could be used with any desired pressure sensitive additive available today. This would include natural rubber, natural rubber/synthetic rubber blends, synthetic rubber, acrylics, or other adhesive systems.

Typical wire harness assembly may be constituted of different components, such as, for example, at least one member selected from the group consisting of terminals, terminal fittings, connectors, and connector housings.

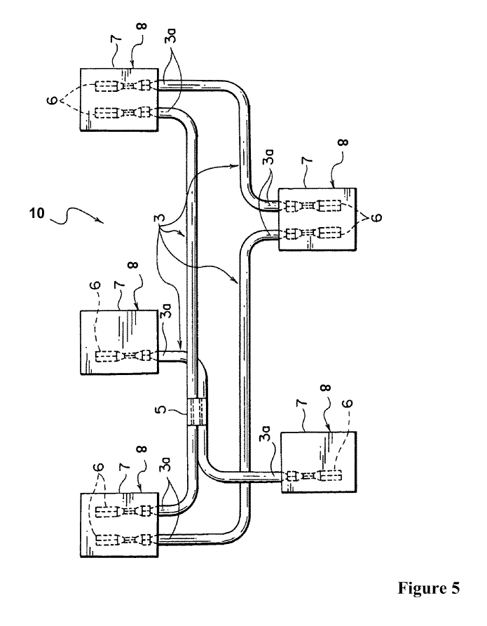

In some embodiments, the wire harness assembly can be in the form of an automotive wire harness assembly as shown in FIG. 5. The wire harness 10 has covered conductors 3, joint-terminals 5, connectors 8, and connector housing 7. Covered conductors 3 are metallic conductor coated with covering as described in earlier embodiments. The connector 8 has a conductive terminal fitting 6 and an insulating connector housing 7. The terminal fitting 6 is formed by bending a conductive sheet metal. The terminal fitting 6 is attached to an end portion (uncovered conductor) 3a of the covered conductor 3. The terminal fitting 6 is electrically connected with the core wire of the covered conductor 3. The connector housing 7 is formed in a box-shape. The connector housing 7 accommodates the terminal fitting 6. Like this, the terminal fitting 6 is attached to the connector housing 7.

The joint-terminal 5 is made of conductive sheet metal. The joint-terminal 5 electrically-connects core wires of the respective covered conductors 3. At the connecting portion of the covered conductors 3, the covering portions of the covered conductors 3 are removed, and the core wires are exposed. The joint-terminal 5 covers the exposed core wires. The joint-terminal 5 crimps the core wires of the electric wires 3, thereby electrically-connecting the covered conductors 3. In some embodiments, the covered conductors 3 can be of dissimilar metals attached together using joint terminal 5.

In the wiring harness 10 of the above structure, the covered conductors 3 have been cut off in desirable lengths, and the covering portions of the end portions 3a have been removed. The terminal fittings 6 are crimped to the core wires exposed from the end portions 3a. The covering portions of the connecting portion of the covered conductors 3a are removed. The core wires exposed from the connecting portion are crimped by the joint-terminal 5 so as to connect the covered conductors 3. The terminal fitting 6 is inserted into, and attached to, the connector housing 7.

Like this, the wiring harness 10 of the above structure is assembled. The wiring harness 10 connects a plurality of electronic equipment mounted on a motor vehicle by coupling the above connectors 8 with mating connectors of the electronic equipment. The wiring harness 10 supplies electric power or transmits control signals to the electronic equipment.

In some embodiments, the covered conductor of wire harness assembly can serve different purposes based on the application it is used for. More specifically, it is usable as signal wires for communication, power-supply electric wires for feeding electric power to apparatuses or earthling wire, etc.

The wire harness assembly described in above embodiments can be used in many forms based on the function it performs. In some embodiments, it can be used in the form of an, “automotive wire harness” (also called car harness, vehicle wire harness, vehicular harness, assembly for protecting automotive electronics, etc). In general, in an automotive wire harness the conductor is used for feeding electricity to electrical equipments within the vehicle, communication and sensing, etc. Wire harness assembly can be used inside a passenger cabinet (such as under the roof, under the carpet, behind the instrument panel, inside door frame) and inside the trunk.

As described earlier, aluminum can be material of choice in automotive wire harness, because of the weight saving and the cost advantage. However, because of its relatively inferior mechanical properties (such as flexural and tensile strength) compared to conventional materials of conductor (such as copper), the relatively thick insulation covering needs to be applied in order to give mechanical stability to the covered conductor. Due to change in conductor properties and hence the thickness of insulation covering, it is foreseeable that the other related components (in an automotive application) such as, for example, electric, electronic and mechanic parts or components (such as connectors, wrapping tapes) would also need to be modified. Exemplary electric, electronic and mechanic parts or components include anti-lock brake system, electronic control transmission, electronic controlled unit, electronic fuel injection, electronic spark advance, fusible link, HA integrated ignition assembly, load sensing timer, central door lock, distributor, digital clock, car audio, car burglar alarm, fuse seat, motor, horn, switch, buzzer, combination meter, lamp, ignition coil, relay, reverse sensor, alternator, flasher, energy saving unit, terminal, power seat unit, motor components, car CD, car LCD, regulator, rectifier, ignition module, rear view display, cruise controller, ballast complete set for headlights, lighting controller, ignition coil module, cigar lighter, carbon brush, solenoid valve, car hand-free mobile phone, car security system, car navigation system, car computer, wireless tire monitor, tire low pressure indicator, water temperature sensor, oil pressure sensor, charger, temperature recorder, battery capacity indicator, simmer switch, electronic fuel injection manifold, over heating protection system, over heating warning system, ignition and injection timing controller system, ignition timing controller system, deceleration spark advance controller, retarded injection timing controller system, retarded injection timing with speed, retarded injection timing with load, fuel controller system, feedback controller, air-fuel ratio feedback controller system, electronic controlled carburetor, electronic fuel injection system, electronic concentrated engine controller system, temperature sensor, pressure sensor, position sensor, speed sensor, knock sensor, intake flow sensor, temperature switch, photoelectric barrier, transmitter, receiver, sensor, oscillator, digital chronometer, electromagnetic beam barrier, analog/digital converter (A/D converter), supplemental inflatable restraint (SIR), supplemental restraint system (SRS), air cushion restraint system (ACRS), airbag, crash sensor, electronic crash sensor, primary sensor, safety sensor, secondary sensor, diagnostic module, readiness indicator, warning indicator, inflator assembly, squib, transfer cord, transverse electromagnetic (TEM) mode, amplifier, bidirectional coupler, directional coupler, injection probe, quasi-peak detector, solenoid regulator valve, converter bypass valve, electro anti-lock device, DC voltmeter, current probe, generator, DC generator, stator assembly (field frame assembly), field coil (excitation winding), armature assembly, armature winding, DC generator regulator, voltage regulator, current limiter, cutout relay, alternator regulator, field relay, charge indicator relay, electromagnetic regulator (vibrating type regulator), single stage voltage regulator, double stage voltage regulator, IC regulator (solid state regulator), built-in voltage regulator, battery (accumulator), starter, mechanically engaged drive starter, pre-engaged drive starter, sliding armature starter, sliding gear starter, coaxial drive starter, inertial drive starter, pick-up coil, distributor-less ignition system, ignition voltage reserve, voltage divider, ignition governor, ignition distributor, timer rotor, double-pole connector, internal cable, external cable, unscreened high-tension ignition cable, male tab, socket aperture, damping resistor, suppression filter, flat quick-connect termination, positive locking female connector, tab without shoulder, tab with shoulder, crimped termination, transformer, rectifier, over-current protection, miniature circuit breaker, fuse holder, blade terminal, electric horn, horn relay, back-up buzzer, multi-tone sound signaling device, wiper motor, heater motor, cooling fan motor, fuel pump motor, window lift motor, antenna motor (aerial motor), seat adjustment motor, washer pump, washer motor, lubricating motor, ignition switch, master lighting switch, direction indicator controller, hazard warning signal controller, interior light switch, audible warning (horn) controller, seat adjustment controller, power-take-off controller, tilt controller, front hood (bonnet) controller, real hood (boot) controller, radiator shutter controller, outside rear-view mirror adjustment controller, lighting switch, stop lamp switch, hand brake indicator switch, dimmer switch, turn signal switch, back-up lamp switch, parking lamp switch, instrument lamp switch, door lamp switch, reading lamp switch, wiper switch, washer switch, heater switch, fog lamp switch, black-out lamp switch, starting switch, engine start preheating switch, battery main switch, battery change-over switch, rocker switch, sliding roof controller, automatic antenna controller, radio receiver controller, diesel engine cut-off controller, headlight beam aiming controller, headlight wiper controller, headlight cleaner controller, battery isolating switch controller, optical warning controller, steering wheels adjustment controller, additional wheel drive controller, differential lock controller, radiator grill controller, range shift controller, centralized lubrication pressure indicator, automatic gearbox indicator, electronic speedometer, bimetallic oil pressure sensor, electromagnetic oil pressure indicator, moving magnet oil pressure indicator, variable resistance oil pressure sensor, oil level warning sensor, pressure warning sensor, air filter clog warning sensor, temperature warning sensor, electromagnetic fuel indicator, sealed beam unit, semi-sealed beam unit, signal system, combined lamps, reflex reflecting device, retro-reflecting device, discharge lamp, fog lamp, grouped lamps, hazard warning lamp, lower-beam (dipped beam) headlamp, upper-beam (main beam headlamp), headlamp leveling device, end outline marker lamp, license plate lamp, rear registration plate lamp, search lamp, side marker lamp, special warning lamp, stop lamp, reciprocally incorporated lamp, parking lamp, turn signal lamp, semi-sealed beam headlamp, signal lamp (indicator), tail lamp, door lock warning lamp, ceiling lamp, reading lamp, step lamp (courtesy light), instrument panel lamp, engine compartment lamp, bulb adaptor, and bayonet socket. That is also covered under the scope of the embodiments of the invention.

In some embodiments, the wire harness assembly may also be applied to aircraft, domestic building, industrial applications, household electric appliance, medical equipments and machines, rail-transportation, submarine-transportation, electrical or electronic instruments, or engineering equipment wire harness. In some other embodiments, the covered conductor is an optical cable, and can be used in interior applications (inside a building), exterior applications (outside a building) or both interior and exterior applications. Exemplary applications include data transmission networks and voice transmission networks such as telecommunication networks and local area networks (LAN).

In some embodiments, the wire harness assembly may also be applied to complex and small gauge application, flexible printed circuits with integrated electronics, solid state and electrical integration hybrid module which allows for quicker reaction to circuit changes, or battery disconnect device which helps to protect and provides disconnection for both 14 and 42 volts system. In some other embodiments, the wire harness assembly can be automated with zero resistance technology.

Standardization (ISO), or British Standards (BS), or International Electrotechnical Commission (IEC) for the conductor of corresponding applications described in above embodiments. The conductor may essentially meets or exceeds the performance requirements set forth by these standards, such as, for an automotive wire harness the conductor may essentially meets or exceeds the performance requirements set forth by ISO 6722 (as of second edition, 2006-08-01) or ISO 14572 (as of second edition, 2006-11-15); for an aircraft wire harness the conductor may essentially meets or exceeds the performance requirements set forth by ISO 1967 (as of version, 1974-02-01) or ISO 2155 (as of version, 1974-02-01) or ISO/NP 13822 (standard is perceived to be under development); for a building wire harness the conductor may essentially meets or exceeds the performance requirements set forth by BS 6004 (as of version, 2000-12-15) or BS 7211 (as of version, 1998-10-15); for industrial wire harness the conductor may essentially meets or exceeds the performance requirements set forth by BS 5467 (as of version, 1997-10-15); and for a data and telecommunication wire harness the conductor may essentially meets or exceeds the performance requirements set forth by ISO/IEC 11801 (as of version, 2002-10-23, amended 2008-04-23, corrected 2008-10-22) or ISO/IEC 15018 (as of version, 2004-07-16, amended 2009-04-30).

In some embodiments, the covered conductor of any of the wire harness assemblies, described in above embodiments, may essentially meet or exceed the performance requirements set forth by UL standards, such as, UL 83 (revised in 2008) or UL 44 (revised in 2004) or UL 854 (revised in 2007) or UL 1581 (revised in 2008).

The term “essentially meets or exceeds the performance requirements set forth by the standard” is used, as it can allow for modification in specification and principles of the test of the current version of standard to adjust the smaller change in conductor type or its dimension. For example, for an automotive wire harness, the current version of ISO 6722 (as of second edition, 2006-08-01) specifies a conductor size at least 0.13 mm² and a coating thickness at least 0.85 mm. Therefore, the term “essentially meets or exceeds the performance requirements set forth by ISO 6722” means that even though the conductor has a cross-section that meets as least one of following: (i) American Wire Gauge (AWG) from AWG 56 to AWG 26, (ii) a cross-section area from 0.000122 to 0.128 mm² (corresponding to AWG 56 to AWG 26 according to ASTM B256-02); (iii) a nominal diameter from 0.0124 to 0.404 mm (corresponding to AWG 56 to AWG 26 according to UL 1581 (revised in 2008), 4th edition, Table 20.1) and/or the covering has a thickness of 0.010 to 0.85 mm, both below current ISO 6722 (as of second edition, 2006-08-01) specification, the principles of ISO 6722 (as of second edition, 2006-08-01) test (including the test items) will be met, allowing for modifications made to adjust for the smaller conductor and smaller covering thickness. Such modification in standards for other mentioned applications is also covered under the scope of this invention.

In some embodiments, the wire harness assembly can be used in an end use equipment. In some embodiments, an end use equipment comprises a wire harness assembly comprising a covered conductor, wherein the covered conductor comprises a conductor and a covering, wherein the covering is disposed over the conductor. In these embodiments, the conductor comprises aluminum or an alloy comprising aluminum and the covering comprises a poly(arylene ether) composition.

In some other embodiments, an end use equipment comprises two or more wire harness assemblies, wherein each wire harness assembly comprises a covered conductor wherein the covered conductor comprises a conductor and a covering. The covering is disposed over the conductor. In some embodiments, such wire harness assemblies can have two or more covered conductors wherein the covered conductor comprises two or more conductor and a covering. In some other embodiments, each covered conductor of these wire harness assemblies can have covering in the form of single layer or multiple layers. In these embodiments the conductor comprises aluminum or an alloy comprising aluminum and the covering comprises a poly(arylene ether) composition.

In some embodiments, the end use equipment can be in the form of electronic devices, power management systems, signal processing systems, communication systems, optical fiber system, automotive vehicles, elevator assemblies, data communication systems, electric pumps, telephonic instruments, etc.

The invention includes following non-limiting embodiments:

### Embodiment 1

A covered conductor comprising a conductor and a covering,
wherein the covering is disposed over the conductor,
wherein the conductor comprises aluminum or an alloy comprising aluminum,
wherein the covering comprises a poly(arylene ether) composition,
wherein optionally, the poly(arylene ether) composition comprises a crystalline polymer, a semi-crystalline polymer, an amorphous polymer, or a mixture thereof,
wherein optionally, the poly(arylene ether) composition comprises at least one member selected from the group consisting of fibrous fillers, particulate fillers, reinforcing agents, mold release agents, plasticizers, lubricants, UV absorbers, light stabilizers, heat stabilizers, free-radical generating chemicals, curing agents, anti-dripping agents, smoke suppressants, flow promoters, silicon containing chemicals, fluorine containing chemicals, foaming agents, blowing agents, crosslinking agents, nucleating agents, acid scavengers, antimicrobial agents, fluorescent whitening agents, pigments, dyes, photo-bleachable dyes, colorants, anti-static agents, antioxidants, and metal deactivators,
wherein optionally, the covered conductor comprises an other layer, wherein the other layer is disposed between the covering and the conductor, and
wherein optionally, the covering comprises at least one polyarylene ether composition selected from the group consisting of Noryl resins from SABIC Innovative Plastics, Xyron resins from Asahi Kasei Chemicals Corporation, Iupiace resins from Mitsubishi, Lemalloy resins from Mitsubishi, Polyphenyl Ether resins from Bluestar, Acnor resins from Aquafil Technopolymers, Ashlene resins from Ashley Polymers, Vestoran resins from Evonik Degussa.

### Embodiment 2

The covered conductor of embodiment 1, wherein the conductor comprises a coated conductor comprising aluminum or alloy comprising aluminum, or a claded conductor comprising aluminum or an alloy comprising aluminum.

### Embodiment 3

The covered conductor of embodiment 1, wherein the conductor further comprises a metal selected from the group consisting of copper, lead, stainless steel, silver, gold, platinum, and alloys comprising one or more of the foregoing.

### Embodiment 4

The covered conductor of embodiment 1, wherein the conductor has a cross sectional area of 0.000122 square millimeters to 107.164 square millimeters.

### Embodiment 5

The covered conductor of embodiment 1, wherein the covering has a thickness of 0.01 millimeters to 8.0 millimeters.

### Embodiment 6

The covered conductor of embodiment 1, wherein the conductor comprises a single conductor, a single strand, a plurality of conductors, or a plurality of strands.

### Embodiment 7

The covered conductor of embodiment 1, wherein the conductor is bundled, twisted, braided, or a combination of the foregoing.

### Embodiment 8

The covered conductor of the embodiment 1, wherein the poly(arylene ether) composition comprises 5 to 70 weight percent of poly(arylene ether) having an initial intrinsic viscosity greater than 0.25 dl/g as measured in chloroform at 25° C., 1 to 60 weight percent of poly(alkenyl aromatic), 1 to 80 weight percent of polyolefin resin, 0 to 35 weight percent of flame retardant and 0 to 30 weight percent of compatibilizer, wherein the weight percents are based on the weight of the poly(arylene ether) composition.

### Embodiment 9

The covered conductor of the embodiment 1, wherein the covering comprises a product obtained on curing with 5 to 5,000 megarads of electronic beam radiation an uncured composition comprising 20 to 55 weight percent of poly(arylene ether) having an initial intrinsic viscosity greater than 0.25 dl/g as measured in chloroform at 25° C., 20 to 50 weight percent of polyolefin resin, 2 to 20 weight percent of compatibilizer, wherein all weight percents are based on the total weight of the uncured composition.

### Embodiment 10

The covered conductor of the embodiment 1, wherein the poly(arylene ether) composition comprises 5 to 70 weight percent of poly(arylene ether) having an initial intrinsic viscosity greater than 0.25 dl/g as measured in chloroform at 25° C., 1 to 80 weight percent of polyester resin, 0.2 to 3 weight percent of functionalizing agent, 5 to 35 weight percent of impact modifier, 0 to 35 weight percent of flame retardant, and 0 to 20 weight percent of compatibilizer, wherein all weight percents are based on the weight of the poly(arylene ether) composition.

### Embodiment 11

The covered conductor of the embodiment 1, wherein the poly(arylene ether) composition comprises 5 to 70 weight percent of poly(arylene ether) having an initial intrinsic viscosity greater than 0.25 dl/g as measured in chloroform at 25° C., 1 to 80 weight percent of polyamide resin, 0.1 to 3 weight percent of functionalizing agent, 5 to 35 weight percent of impact modifier, 0 to 35 weight percent of flame retardant, and 0 to 20 weight percent of compatibilizer, wherein all weight percents are based on the weight of the poly(arylene ether) composition.

Embodiment 12: The covered conductor of embodiment 1, wherein the covering comprises at least one Noryl resin selected from the group consisting of WCV072, WCV072L-111, WCV065, WCP700, WCP781, WCP821, WCP721, WCD891, WCD911, WCD931, WCD891A, WCD801, WCD801A, WCD861A, WCD891B, WCD761, WCD771, WCD825, WCD851, WCD910, WCA871, WCA901, WCA105, WCA105S, EXNL0166, EXNL0168, EXNL0175, EXNL0192, EXNL0226, EXNL1116, EXNL0218, and EXNL0266.

### Embodiment 13

The covered conductor of the embodiment 1, wherein the covering comprises a plurality of juxtaposed concentric layers of covering, wherein at least one of the juxtaposed concentric layers of covering comprises a composition that is different from the poly(arylene ether) composition.

### Embodiment 14

The covered conductor of embodiment 1, wherein the covered conductor comprises a covering in contact with the conductor, wherein the covering in contact with the conductor comprises at least one member selected from the group consisting of metal deactivators, anti-oxidants, and stabilizers.

### Embodiment 15

The covered conductor of the embodiment 1, wherein outer-most covering of the covered conductor comprises at least one member selected from the group consisting of UV absorbers, light stabilizers, antistatic agents, antioxidants, foaming agents, crosslinking agents, pigments, dyes, and colorants.

### Embodiment 16

A wire harness assembly comprising:
a covered conductor comprising a conductor and a covering,
wherein the covering is disposed over the conductor,
wherein the conductor comprises aluminum or an alloy comprising aluminum,
wherein the covering comprises a poly(arylene ether) composition,
wherein optionally, wire harness assembly comprises at least one member selected from the group consisting of terminals, terminal fittings, connectors, and connector housings,
wherein optionally, the covered conductor comprises an other layer, wherein the other layer is disposed between the covering and the conductor, and
wherein optionally, the covered conductor comprises at least one member selected from the group consisting of beddings, armors, and wrapping tapes,
wherein optionally, the covering comprises at least one polyarylene ether composition selected from the group consisting of Noryl resins from SABIC Innovative Plastics, Xyron resins from Asahi Kasei Chemicals Corporation, Iupiace resins from Mitsubishi, Lemalloy resins from Mitsubishi, Polyphenyl Ether resins from Bluestar, Acnor resins from Aquafil Technopolymers, Ashlene resins from Ashley Polymers, Vestoran resins from Evonik Degussa, and
wherein optionally, the wire harness assembly is at least one member selected from the group consisting of an automotive wire harness that satisfies the requirements of ISO 6722 or ISO 14572; an aircraft wire harness that satisfies the requirements of ISO 1967 or ISO 1974 or ISO 2155; a building wire harness that satisfies the requirements of BS 6004 or BS 7211; an industrial wire harness that satisfies the requirements of BS 5467; a data and telecommunication wire harness that satisfies the requirements of ISO 11801 or ISO 15018; a household electric appliance wire harness; a medical equipment wire harness; a machine wire harness; a rail-transportation wire harness; a submarine-transportation wire harness; an electronic instrument wire harness; and an engineering equipment wire harness.

### Embodiment 17

The covered conductor of embodiment 16, wherein the covering comprises a poly(arylene ether) composition that has no halogen or heavy metal added thereto, and wherein the poly(arylene ether) composition comprises a polyolefin and optionally, a block copolymer of an alkenyl aromatic compound and a conjugated diene.

### Embodiment 18

An end use equipment comprising the wire harness assembly of embodiment 16.

The invention is further illustrated by the following non-limiting examples.

### EXAMPLES

The following examples may be prepared using the materials listed in Table 8.

TABLE 8

| Component | Description |
|---|---|
| Poly(arylene | A poly(2,6-dimethylphenylene ether) having an intrinsic viscosity of |
| ether)-0.33 IV | 0.33 dl/g as measured in chloroform at 25° C. and commercially |
| | available from SABIC Innovative Plastics. |
| Poly(arylene | A poly(2,6-dimethylphenylene ether) with an intrinsic viscosity of |
| ether)-0.46 IV | 0.46 dl/g as measured in chloroform at 25° C. commercially available |
| | from SABIC Innovative Plastics. |
| KG1650 | A polyphenylethylene-poly(ethylene/butylene)-polyphenylethylene |
| | block copolymer having a phenylethylene content of 32 weight percent, |
| | based on the total weight of the block copolymer and commercially |
| | available from Kraton Polymers. |
| KG1701 | A polyphenylethylene-poly(ethylene/propylene)-polyphenylethylene |
| | block copolymer commercially available from Kraton Polymers. |
| PP | A polypropylene having a melt flow rate of 1.5 g/10 min determined |
| | according to ASTM D1238 as described above and commercially |
| | available from Sunoco Chemicals under the tradename D-015-C2. |
| Tuftec H1043 | A polyphenylethylene-poly(ethylene/butylene)-polyphenylethylene |
| | block copolymer having a phenylethylene content of 67 weight percent, |
| | based on the total weight of the block copolymer and commercially |
| | available from Asahi Chemical |
| Tuftec H1051 | A polyphenylethylene-poly(ethylene/butylene)-polyphenylethylene |
| | block copolymer having a S/phenylethylene to ethylene/butylene ratio of |
| | 30/70 weight percent, based on the total weight of the block copolymer |
| | and commercially available from Asahi Chemical |
| BPADP | Tetraphenyl bisphenol A Diphosphate (CAS 181028-79-5) available from |
| | Supresta with specific gravity of 1.26 |
| PD403 | Propylene homopolymer with melt flow rate 0f 1.3 g/10 min at 230° C./ |
| | 2.16 kg available from Sunoco under trade name D015-C2 |
| HDPE 5305E | Ethylene copolymer with 1-hexene with melt index 0.7 and specific |
| | gravity of 0.943 available from Equistar under trade name Petrothene |
| | LR590000 |
| Tafmer A-0585S | Polyalphaolefin copolymer material made by Mitsui Chemicals. |
| ENGAGE 8180 | A polyolefin Elastomer of ethylene-octene copolymer made by Dow |
| Kraton A | A polyphenylethylene-(ethylene/propylene-phenylethylene)- |
| | polyphenylethylene copolymer commercially available from Kraton |
| | Polymers under the grade name RP6936 having a styrene content of |
| | 39 weight percent, based on the total weight of the block copolymer. |
| Petrothene | Ethylene copolymer with 1-hexene available from Equistar |
| GA837091 | with melt index of 0.7 and specific gravity of 0.934 |
| Petrothene | Ethylene copolymer with 1-butene available from Equistar |
| GA818073 | with melt index of 0.75 and specific gravity of 0.9205 |

The poly(arylene ether) compositions of the following examples may be prepared by combining the components in a twin screw extruder. The poly(arylene ether) and styrenic block copolymers may be added at the feed-throat and the other polymer may be added downstream. The liquid flame retardants may be added by a liquid injector in the second half of the extruder.

Examples 1-6 may be prepared by combining the components in a twin screw extruder. The PPE and block copolymers may be added at the feed-throat, and the polyolefin may be added downstream. The BPADP may be added through a liquid injector in the second half of the extruder. The extruded material may be injection molded into test specimens for physical property testing. The physical properties and their test methods are listed in Table 9. Testing according to ASTM D638-03 employed Type I samples injection molded using the same conditions as flexural modulus samples. Tensile elongation may be measured at a speed of 50 millimeters per minute. Megapascals are abbreviated as MPa, Joules are abbreviated as J, Newtons are abbreviated as N, and meters are abbreviated as m. The deflection temperature and flexural modulus values may be an average of 3 samples. The deflection temperature data may be collected at 1.82 MPa. The remaining values may be an average of 5 samples. Table 9 contains formulations the examples 1-6, and table 10 contains the test results of the examples 1-6.

Covered conductors comprising a conductor and a covering, wherein the conductor comprises aluminum or an alloy comprising aluminum, wherein the covering may be made of the poly(arylene ether) compositions of examples 1-6. The conductor comprising aluminum or an alloy comprising aluminum may be of any size described herein. The poly(arylene ether) compositions of the examples 1-6 may be filtered through a 325 mesh and dried at 82° C. for 3-4 hours prior to extrusion with the conductor comprising aluminum or alloy comprising aluminum to form the covered conductor. The coverings may be of any thickness between 0.01 mm to 8.0 mm.

Covered conductors may be produced using the poly(arylene ether) compositions of the examples 1-6. The conductors may have sizes of 2.0 square millimeters (mm²). The poly(arylene ether) composition may be filtered through a 325 mesh, and dried at 82° C. for 3-4 hours prior to extrusion with the conductive core to form the covered conductors. The coverings may have the thicknesses of 0.4 millimeters. The covered conductors thus formed may have following physical properties as described in the table 11.

The covered conductors may be tested for tensile elongation, tensile strength, abrasion resistance (7 Newton load), flame retardance, resistance to gasoline, resistance to hot water, short term heat aging (class C), long term heat aging (class A & B), thermal overload (class B), pressure at high temperatures. Testing may be performed in accordance with the standards pertinent to various wire harness applications described herein such as ISO 6722 (as of second edition, 2006-08-01) or ISO 14572 (as of second edition, 2006-11-15) for an automotive wire harness; or ISO 1967 (as of version, 1974-02-01) or ISO 2155 (as of version, 1974-02-01) or ISO/NP 1382213822 (standard is perceived to be under development) for aerospace wire harness; or BS 6004 (as of version, 2000-12-15) or BS 7211 (as of version, 1998-10-15) for building wire harness; or BS 5467 (as of version, 1997-10-15) industrial wire harness; or ISO 11801 (as of version, 2002-10-23, amended 2008-04-23, corrected 2008-10-22) for data and telecommunication wire harness. Additionally, the covered conductors may be tested for bundle flexibility.

TABLE 9

Examples

| | 1 | 2 | 3 | 4 | 5 | 6 |
|---|---|---|---|---|---|---|
| Poly(arylene ether)- | 52 | 52 | 36 | 40 | 40 | 40 |
| 0.46 IV | | | | | | |
| PD403 | 29 | — | — | — | — | — |
| HDPE 5305E | — | 17 | 35 | 35 | — | 18 |
| Tafmer A-0585S | — | — | — | — | — | — |
| ENGAGE 8180 | — | 10 | — | — | — | — |
| KG1650 | 5 | — | — | — | — | — |
| Tuftec H1043 | 5 | — | — | — | — | — |
| Kraton A | — | 3 | — | — | — | — |
| Tuftec H1051 | — | 7 | 17 | 13 | 13 | 13 |
| BPADP | 9 | 11 | 10 | 10 | 10 | 10 |
| Petrothene | — | — | — | — | 35 | — |
| GA837091 | | | | | | |
| Petrothene | — | — | — | — | — | 18 |
| GA818073 | | | | | | |
| Total | 100 | 100 | 98 | 98 | 98 | 99 |

TABLE 10

| Tests performed on molded bars | 1 | 2 | 3 | 4 | 5 | 6 |
|---|---|---|---|---|---|---|
| MVR (5 kg/280° C.); cm³/10 min | 13.8 | 20 | 42 | 42 | 45 | 44 |
| Flexural Modulus; MPa | 1550 | 1150 | 750 | 730 | 630 | 520 |
| Flex Stress@5% Strain MPa | — | — | 26 | 26 | 23 | 29 |
| Shore Hardness (D scale); % | 72 | 65 | 62 | 63 | 61 | 60 |
| Deflection temp (1.82 Mpa); ° C. | 92 | 84 | 56.3 | 57 | 56 | 55 |
| Impact Strength (RT, notched); J/m | 310 | 550 | 680 | 650 | 550 | 550 |
| Modulus of Elasticity (50 mm/min); MPa | 1710 | 1450 | 990 | 1040 | 850 | 730 |
| Stress at Yield Avg; MPa | 43 | 39 | 27 | 28 | 27 | 26 |
| Stress at Break Avg; MPa | 41 | 37 | 27 | 27 | 27 | 24 |
| Elongation at Yield Avg; % | 15 | 37 | 75 | 61 | 74 | 62 |
| Elongation at Break Avg; % | 83 | 45 | 90 | 84 | 77 | 65 |

TABLE 11

| | | | | | | |
|---|---|---|---|---|---|---|
| Tensile Elongation; % | 118 | 72 | 150 | 126 | 117 | 115 |
| Tensile Strength; Mpa | 56.1 | 48.1 | 44 | 42.7 | 40.7 | 39.9 |
| 7N Abrasion; # of cycles | >5000 | >5000 | >5000 | >5000 | >5000 | >5000 |
| Flame-out time average; seconds | 9 | 6 | 6 | 6 | 6 | 6 |
| Gasoline exposure | pass | Pass | pass | pass | pass | pass |
| Thermal Overload (Class B) | pass | Pass | pass | — | pass | Pass |
| Short-term heat-aging Class C | pass | Pass | pass | — | pass | Pass |
| Long-term heat aging Class A&B | pass | Pass | pass | — | pass | Pass |
| Pressure Test at High Temperature; | C | C | — | — | B | B |
| highest passed class | | | | | | |
| Hot water exposure for 5 weeks | pass | Fail | pass | pass | pass | pass |
| Bundle Flexibility; kgf | 19 | 15.2 | 14 | 13.8 | 12.5 | 12.7 |

### Example 7

A covered conductor comprising a conductor comprising aluminum or an alloy comprising aluminum, and a covering disposed over the conductor, may be formed by extrusion coating, wherein the covering may be made of a poly(arylene ether) composition comprising 30-45 weight percent of poly(arylene ether), 20-30 weight percent of a polyolefin, 15-25 weight percent of styrenic block copolymers, and 5-20 weight percent of flame retardants. Weight percent is with regard to the total weight of the poly(arylene ether) composition. Five or eight covered conductors of uniform length may be arranged adjacent to each other in a fixture having a width equal to the sum of the diameters of the covered conductors. The covered conductors may then be brushed or felted with xylene, toluene or a combination thereof, and heated at a temperature of 130° C. to 175° C. for 1 to 12 minutes to form a multi-conductor assembly. The multi-conductor assembly may then be cooled at room temperature, and further wrapped with a tape comprising poly(arylene ether) composition to form a wire harness assembly. The wire harness assembly thus formed may demonstrate good adhesion strength and little fatigue after rigorous bending (bending through a 180 degree angle) for 70 cycles.

### Example 8

A covered conductor comprising a conductor comprising aluminum or an alloy comprising aluminum, and a covering disposed over the conductor, may be formed by extrusion coating, wherein the covering may be made of a poly(arylene ether) composition comprising, the product obtained on curing with 5 to 5,000 megarads of electron beam radiation an uncured composition comprising 20 to 55 weight percent of a poly(arylene ether), 20 to 50 weight percent of a thermoplastic polyolefin, and 2 to 20 weight percent of a compatibilizer for the poly(arylene ether) and the thermoplastic polyolefin; wherein all weight percents are based on the total weight of the uncured composition. The poly(arylene ether) composition this formed may pass the class A, B, or C short-term and long term heat ageing tests according to ISO 6722 (as of second edition, 2006-08-01), and the chemical resistance test according to LV112. An apparatus suitable for electron beam crosslinking is the Application Development Unit available from Advanced Electron Beam Inc. The electrons may be accelerated through about 80 to about 150 kilovolts (kV).

### Example 9

A covered conductor comprising a conductor comprising aluminum or an alloy comprising aluminum, and a covering disposed over the conductor, may be formed by extrusion coating, wherein the covering may be made of a poly(arylene ether) composition comprising 25-40 weight percent of poly(arylene ether), 20-40 weight percent of polyester, 0.2-1.5 weight percent of functionalizing agent, 5-15 weight percent of copolymers of glycidyl methacrylate, 10-25 weight percent of styrenic block copolymers, and 5-20 weight percent of flame retardants. Weight percent is with regard to the total weight of the poly(arylene ether) composition.

### Example 10

A covered conductor comprising a conductor comprising aluminum or an alloy comprising aluminum, and a covering disposed over the conductor, may be formed by extrusion coating, wherein the covering may be made of a thermoplastic composition comprising 25-40 weight percent of poly(arylene ether), 0.2-1.5 weight percent of functionalizing agent, 20-40 weight percent of aliphatic polyamide or mixture of aliphatic polyamides, 15-25 weight percent of styrenic block copolymers, and 5-20 weight percent of flame retardants. Weight percent is with regard to the total weight of the poly(arylene ether) composition.

### Example 11

A covered conductor comprising a conductor comprising aluminum or an alloy comprising aluminum, and a covering disposed over the conductor, may be formed by extrusion coating, wherein the covering may be made of a poly(arylene ether) composition comprising 25-40 weight percent of poly(arylene ether), 20-40 weight percent of aliphatic-aromatic polyamide, 0.2-1.5 weight percent of functionalizing agent, 5-15 weight percent of copolymers of glycidyl methacrylate, 15-25 weight percent of styrenic block copolymers, and 5-20 weight percent of flame retardants. Weight percent is with regard to the total weight of the poly(arylene ether) composition.

### Example 12

A covered conductor comprising a conductor comprising aluminum or an alloy comprising aluminum, and a covering disposed over the lateral surface of the conductor may be formed by extrusion coating, wherein the covering comprises a poly(arylene ether) composition available from SABIC Innovative Plastics, known as Noryl resin selected from the group consisting of WCV072, WCV072L-111, WCV065, WCP700, WCP781, WCP821, WCP721, WCD891, WCD911, WCD931, WCD891A, WCD801, WCD801A, WCD861A, WCD891B, WCD761, WCD771, WCD825, WCD851, WCD910, WCA871, WCA901, WCA105, WCA105S, EXNL0166, EXNL0168, EXNL0175, EXNL0192, EXNL0226, EXNL1116, EXNL0218, EXNL0266, and any of the variants of the foregoing. Noryl is a registered trademark of SABIC Innovative Plastics IP B.V.

### Examples 13

Covered conductors comprising a conductor comprising aluminum or an alloy comprising aluminum may be produced using the compositions of Examples 1 to 12. The conductor comprising aluminum or an alloy comprising aluminum may be of any size described herein. The poly(aryene ether) composition may be filtered through a 325 mesh, and dried at 82° C. for 3-4 hours prior to extrusion with the conductor comprising aluminum or an alloy comprising aluminum to form the covered conductor. The coverings may be of any thickness between 0.01 mm to 8.0 mm.

### Example 14

Conductors may be prepared with pure aluminum or an alloy comprising aluminum by wire drawing techniques into a wire having diameter of 0.9 mm, followed by heat treatment at 350° C. for 2 hours and quenching. Also, such wires may be further drawn to obtain conductors of pure aluminum or an alloy comprising aluminum having diameter of 0.32 mm. Since the tensile strength, bending resistance, and electrical conductivity of the covered conductor comprising aluminum or an alloy comprising aluminum prepared by coating a stranded conductor with a poly(arylene ether) composition according to the present invention may be affected by the properties of the conductors comprising aluminum or an alloy comprising aluminum used, the prepared conductors comprising aluminum or an alloy comprising aluminum with a diameter of 0.32 mm may be heat-treated at 350° C. by keeping the temperature for 2 hours and then slowly cooled. The tensile strength of each of the conductor comprising aluminum or an alloy comprising aluminum having a diameter of 0.32 mm may be measured according to JIS Z2241 (n=3). The electrical conductivity of each of the conductor comprising aluminum or an alloy comprising aluminum having a diameter of 0.32 mm may be also measured in a thermostatic tank controlled at 20° C. (±0.5° C.) using a four-terminal method, and electrical conductivity may be calculated from the resistivity obtained. The distance between the terminals may be set to 100 mm.

### Example 15

Stranded conductor 14 as shown in FIG. 2, with a cross sectional area of the conductor of 0.5 mm² may be prepared by stranding seven conductors of an alloy comprising aluminum or an alloy comprising aluminum (strand pitch 20 mm) having a diameter of 0.32 mm of the Examples 14. One conductor may be placed at the center and remaining 6 conductors may be disposed around the center. The covered conductors shown in FIG. 1 to FIG. 3 may be prepared by extrusion coating the stranded conductors comprising aluminum or an alloy comprising aluminum with the poly(arylene ether) composition of any of the Examples 1-12. The tensile strength of each covered conductor may be substantially enough for satisfying reliability of the joint part between the covered conductor and the terminals in the wire harness assembly of end use equipment.

### Example 16

Stranded conductors each having a cross sectional area of the conductor of 0.5 mm² may be prepared by stranding seven conductors comprising aluminum or an alloy comprising aluminum of Example 15 according to the present invention having a diameter of 0.32 mm, as shown in FIG. 2 (strand pitch 20 mm). Each stranded conductor may be extrusion coated with poly(arylene ether) composition, and four such covered stranded conductors may be bundled and wrapped with tape made of a poly(arylene ether) composition as shown in FIG. 4. The bundle of the covered stranded conductors may be further used for evaluation of flexibility. The flexibility test may be conducted with a sample of covered conductor having a length of 350 mm supported with reels having a support diameter of 19 mm of a two-point support flexibility test jig with a distance of support of 100 mm. Pull-out strength of the sample of covered conductor may be measured by pulling the middle portion between both reels to the downward direction with a tensile tester to evaluate flexibility.

While the invention has been described with reference to a several embodiments, it will be understood by those skilled in the art that various changes can be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiments disclosed as the best mode contemplated for carrying out this invention, but that the invention will include all embodiments falling within the scope of the appended claims.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

Having described our invention as related to the present embodiments, it is our intention that the invention not be limited by any of the details of the description, unless otherwise specified, but rather be construed broadly within its spirit and scope as set out in the accompanying claims.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

All ranges disclosed herein are inclusive of the endpoints, and the endpoints are independently combinable with each other. All the ranges disclosed herein comprise a series of discrete data points. Also, within the ranges disclosed herein, any two adjacent discrete data points may at least have a difference of 0.01 units. Values expressed as “greater than” or “less than” are inclusive of the stated endpoint, e.g., “greater than 3.5” encompasses the value of 3.5.

In the specification and the claims, reference is made to a number of terms, which shall be defined to have the following meanings. The terms “first,” “second,” and the like, “primary,” “secondary,” and the like, “(a),” “(b)” and the like, as used herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity). The endpoints of all ranges directed to the same component or property are inclusive of the endpoint and independently combinable. Reference throughout the specification to “one embodiment,” “another embodiment,” “an embodiment,” “some embodiments,” and so forth, means that a particular element (e.g., feature, structure, property, and/or characteristic) described in connection with the embodiment is included in at least one embodiment described herein, and may or may not be present in other embodiments. In addition, it is to be understood that the described element(s) may be combined in any suitable manner in the various embodiments. The singular forms “a”, “an” and “the” include plural referents unless the context clearly dictates otherwise. “Optional” or “optionally” means that the subsequently described event or circumstance may or may not occur, and that the description includes instances where the event occurs and instances where it does not.

1. A covered conductor comprising a conductor and a covering,
wherein the covering is disposed over the conductor,
wherein the conductor comprises aluminum or an alloy comprising aluminum,
wherein the covering comprises a poly(arylene ether) composition,
wherein optionally, the poly(arylene ether) composition comprises a crystalline polymer, a semi-crystalline polymer, an amorphous polymer, or a mixture thereof,
wherein optionally, the poly(arylene ether) composition comprises at least one member selected from the group consisting of fibrous fillers, particulate fillers, reinforcing agents, mold release agents, plasticizers, lubricants, UV absorbers, light stabilizers, heat stabilizers, free-radical generating chemicals, curing agents, anti-dripping agents, smoke suppressants, flow promoters, silicon containing chemicals, fluorine containing chemicals, foaming agents, blowing agents, crosslinking agents, nucleating agents, acid scavengers, antimicrobial agents, fluorescent whitening agents, pigments, dyes, photo-bleachable dyes, colorants, anti-static agents, antioxidants, and metal deactivators,
wherein optionally, the covered conductor comprises an other layer, wherein the other layer is disposed between the covering and the conductor, and
wherein optionally, the covering comprises at least one polyarylene ether composition selected from the group consisting of Noryl resins from SABIC Innovative Plastics, Xyron resins from Asahi Kasei Chemicals Corporation, Iupiace resins from Mitsubishi, Lemalloy resins from Mitsubishi, Polyphenyl Ether resins from Bluestar, Acnor resins from Aquafil Technopolymers, Ashlene resins from Ashley Polymers, Vestoran resins from Evonik Degussa.

2. The covered conductor of claim 1, wherein the conductor comprises a coated conductor comprising aluminum or alloy comprising aluminum, or a claded conductor comprising aluminum or an alloy comprising aluminum.

3. The covered conductor of claim 1, wherein the conductor further comprises a metal selected from the group consisting of copper, lead, stainless steel, silver, gold, platinum, and alloys comprising one or more of the foregoing.

4. The covered conductor of claim 1, wherein the conductor has a cross sectional area of 0.000122 square millimeters to 107.164 square millimeters.

5. The covered conductor of claim 1, wherein the covering has a thickness of 0.01 millimeters to 8.0 millimeters.

6. The covered conductor of claim 1, wherein the conductor comprises a single conductor, a single strand, a plurality of conductors, or a plurality of strands.

7. The covered conductor of claim 1, wherein the conductor is bundled, twisted, braided, or a combination of the foregoing.

8. The covered conductor of the claim 1, wherein the poly(arylene ether) composition comprises 5 to 70 weight percent of poly(arylene ether) having an initial intrinsic viscosity greater than 0.25 dl/g as measured in chloroform at 25° C., 1 to 60 weight percent of poly(alkenyl aromatic), 1 to 80 weight percent of polyolefin resin, 0 to 35 weight percent of flame retardant and 0 to 30 weight percent of compatibilizer, wherein the weight percents are based on the weight of the poly(arylene ether) composition.

9. The covered conductor of the claim 1, wherein the covering comprises a product obtained on curing with 5 to 5,000 megarads of electronic beam radiation an uncured composition comprising 20 to 55 weight percent of poly(arylene ether) having an initial intrinsic viscosity greater than 0.25 dl/g as measured in chloroform at 25° C., 20 to 50 weight percent of polyolefin resin, 2 to 20 weight percent of compatibilizer, wherein all weight percents are based on the total weight of the uncured composition.

10. The covered conductor of the claim 1, wherein the poly(arylene ether) composition comprises 5 to 70 weight percent of poly(arylene ether) having an initial intrinsic viscosity greater than 0.25 dl/g as measured in chloroform at 25° C., 1 to 80 weight percent of polyester resin, 0.2 to 3 weight percent of functionalizing agent, 5 to 35 weight percent of impact modifier, 0 to 35 weight percent of flame retardant, and 0 to 20 weight percent of compatibilizer, wherein all weight percents are based on the weight of the poly(arylene ether) composition.

11. The covered conductor of the claim 1, wherein the poly(arylene ether) composition comprises 5 to 70 weight percent of poly(arylene ether) having an initial intrinsic viscosity greater than 0.25 dl/g as measured in chloroform at 25° C., 1 to 80 weight percent of polyamide resin, 0.1 to 3 weight percent of functionalizing agent, 5 to 35 weight percent of impact modifier, 0 to 35 weight percent of flame retardant, and 0 to 20 weight percent of compatibilizer, wherein all weight percents are based on the weight of the poly(arylene ether) composition.

12. The covered conductor of claim 1, wherein the covering comprises at least one Noryl resin selected from the group consisting of WCV072, WCV072L-111, WCV065, WCP700, WCP781, WCP821, WCP721, WCD891, WCD911, WCD931, WCD891A, WCD801, WCD801A, WCD861A, WCD891B, WCD761, WCD771, WCD825, WCD851, WCD910, WCA871, WCA901, WCA105, WCA105S, EXNL0166, EXNL0168, EXNL0175, EXNL0192, EXNL0226, EXNL1116, EXNL0218, and EXNL0266.

13. The covered conductor of the claim 1, wherein the covering comprises a plurality of juxtaposed concentric layers of covering, wherein at least one of the juxtaposed concentric layers of covering comprises a composition that is different from the poly(arylene ether) composition.

14. The covered conductor of claim 1, wherein the covered conductor comprises a covering in contact with the conductor, wherein the covering in contact with the conductor comprises at least one member selected from the group consisting of metal deactivators, anti-oxidants, and stabilizers.

15. The covered conductor of claim 1, wherein outer-most covering of the covered conductor comprises at least one member selected from the group consisting of UV absorbers, light stabilizers, antistatic agents, antioxidants, foaming agents, crosslinking agents, pigments, dyes, and colorants.

16. A wire harness assembly comprising:
a covered conductor comprising a conductor and a covering,
wherein the covering is disposed over the conductor,
wherein the conductor comprises aluminum or an alloy comprising aluminum,
wherein the covering comprises a poly(arylene ether) composition,
wherein optionally, wire harness assembly comprises at least one member selected from the group consisting of terminals, terminal fittings, connectors, and connector housings,
wherein optionally, the covered conductor comprises an other layer, wherein the other layer is disposed between the covering and the conductor, and
wherein optionally, the covered conductor comprises at least one member selected from the group consisting of beddings, armors, and wrapping tapes,
wherein optionally, the covering comprises at least one polyarylene ether composition selected from the group consisting of Noryl resins from SABIC Innovative Plastics, Xyron resins from Asahi Kasei Chemicals Corporation, Iupiace resins from Mitsubishi, Lemalloy resins from Mitsubishi, Polyphenyl Ether resins from Bluestar, Acnor resins from Aquafil Technopolymers, Ashlene resins from Ashley Polymers, Vestoran resins from Evonik Degussa, and
wherein optionally, the wire harness assembly is at least one member selected from the group consisting of an automotive wire harness that satisfies the requirements of ISO 6722 or ISO 14572; an aircraft wire harness that satisfies the requirements of ISO 1967 or ISO 1974 or ISO 2155; a building wire harness that satisfies the requirements of BS 6004 or BS 7211; an industrial wire harness that satisfies the requirements of BS 5467; a data and telecommunication wire harness that satisfies the requirements of ISO 11801 or ISO 15018; a household electric appliance wire harness; a medical equipment wire harness; a machine wire harness; a rail-transportation wire harness; a submarine-transportation wire harness; an electronic instrument wire harness; and an engineering equipment wire harness.

17. The wire harness assembly of claim 16, wherein the covering comprises a poly(arylene ether) composition that has no halogen or heavy metal added thereto, and wherein the poly(arylene ether) composition comprises a polyolefin and optionally, a block copolymer of an alkenyl aromatic compound and a conjugated diene.

18. An end use equipment comprising the wire harness assembly of claim 16.
